(19) United States
(12) Patent Application Publication
(10) Pub. No.: US 2014/0006279 A1
(43) Pub. Date: Jan. 2, 2014

(54) Consistent Interface for Business Transaction Authorisation Request and Rejected Direct Debits Post Processing Initiation Run

(71) Applicants: Andrea Nemes Salgueiro, Heidelberg (DE); Robert Reiner, Waghaeusel (DE); Sanjog Tiwari, Bad Schoenborn (DE); Peter Latocha, Malsch (DE); Aalbert De Niet, Bammental (DE); Prasoon Anand, Patna (IN); Moorthy V N, Bangalore (IN); Adhithya Bharadwaj, Bangalore (IN); Chandana Lakku, Bangalore (IN); Sandeep N, Bangalore (IN); Nikhil Lalchandani, Bangalore (IN); Swapnil Kumar Shrivastava, Bangalore (IN); Jitendra Singh Bisht, Bangalore (IN); Prashant C P, Bangalore (IN); Suresh Kumar P, Bangalore (IN); Rupesh Raghavan, Mumbai (IN)

(72) Inventors: Andrea Nemes Salgueiro, Heidelberg (DE); Robert Reiner, Waghaeusel (DE); Sanjog Tiwari, Bad Schoenborn (DE); Peter Latocha, Malsch (DE); Aalbert De Niet, Bammental (DE); Prasoon Anand, Patna (IN); Moorthy V N, Bangalore (IN); Adhithya Bharadwaj, Bangalore (IN); Chandana Lakku, Bangalore (IN); Sandeep N, Bangalore (IN); Nikhil Lalchandani, Bangalore (IN); Swapnil Kumar Shrivastava, Bangalore (IN); Jitendra Singh Bisht, Bangalore (IN); Prashant C P, Bangalore (IN); Suresh Kumar P, Bangalore (IN); Rupesh Raghavan, Mumbai (IN)

(73) Assignee: SAP AG

(21) Appl. No.: 13/535,521

(22) Filed: Jun. 28, 2012

(51) Int. Cl. G06Q 20/40

(52) U.S. Cl. 705/44

(57) ABSTRACT

A business object model, which reflects data that is used during a given business transaction, is utilized to generate interfaces. This business object model facilitates commercial transactions by providing consistent interfaces that are suitable for use across industries, across businesses, and across different departments within a business during a business transaction. In some operations, software creates, updates, or otherwise processes information related to a business transaction authorisation request and a rejected direct debits post processing initiation run business object.

### CROSS-REFERENCE TO RELATED APPLICATIONS

Some details of the subject matter of this specification are described in previously-filed U.S. patent application Ser. No. 11/803,178, entitled “Consistent Set of Interfaces Derived From a Business Object Model”, filed on May 11, 2007, which is hereby incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The subject matter described herein relates generally to the generation and use of consistent interfaces (or services) derived from a business object model. More particularly, the present disclosure relates to the generation and use of consistent interfaces or services that are suitable for use across industries, across businesses, and across different departments within a business.

### BACKGROUND

Transactions are common among businesses and between business departments within a particular business. During any given transaction, these business entities exchange information. For example, during a sales transaction, numerous business entities may be involved, such as a sales entity that sells merchandise to a customer, a financial institution that handles the financial transaction, and a warehouse that sends the merchandise to the customer. The end-to-end business transaction may require a significant amount of information to be exchanged between the various business entities involved. For example, the customer may send a request for the merchandise as well as some form of payment authorization for the merchandise to the sales entity, and the sales entity may send the financial institution a request for a transfer of funds from the customer's account to the sales entity's account.

Exchanging information between different business entities is not a simple task. This is particularly true because the information used by different business entities is usually tightly tied to the business entity itself. Each business entity may have its own program for handling its part of the transaction. These programs differ from each other because they typically are created for different purposes and because each business entity may use semantics that differ from the other business entities. For example, one program may relate to accounting, another program may relate to manufacturing, and a third program may relate to inventory control. Similarly, one program may identify merchandise using the name of the product while another program may identify the same merchandise using its model number. Further, one business entity may use U.S. dollars to represent its currency while another business entity may use Japanese Yen. A simple difference in formatting, e.g., the use of upper-case lettering rather than lower-case or title-case, makes the exchange of information between businesses a difficult task. Unless the individual businesses agree upon particular semantics, human interaction typically is required to facilitate transactions between these businesses. Because these “heterogeneous” programs are used by different companies or by different business areas within a given company, a need exists for a consistent way to exchange information and perform a business transaction between the different business entities.

Currently, many standards exist that offer a variety of interfaces used to exchange business information. Most of these interfaces, however, apply to only one specific industry and are not consistent between the different standards. Moreover, a number of these interfaces are not consistent within an individual standard.

### SUMMARY

In a first aspect, a computer-readable medium includes program code for providing a message-based interface for exchanging information about business transaction authorisation requests. The medium comprises program code for receiving, via a message-based interface exposing at least one service as defined in a service registry and from a heterogeneous application executing in an environment of computer systems providing message-based services, a first message for requesting to trigger a process to obtain legal authorization of a business transaction by legal authorities. The first message includes a message package hierarchically organized as a business transaction authorisation internal request message entity; and a business transaction authorisation internal request package including a business transaction authorisation internal request entity, wherein the business transaction authorisation internal request entity includes a base business transaction document identifier and a creation date, wherein the business transaction authorisation internal request entity further includes a buyer party entity and a seller party entity from a party package, and at least one business transaction authorisation internal request item entity from an item package, and wherein each business transaction authorisation internal request item entity includes an identifier and a type code. The medium further comprises program code for sending a second message to the heterogeneous application responsive to the first message.

Implementations can include the following. The business transaction authorisation internal request entity further includes a cash discount terms entity from a cash discount terms package. The business transaction authorisation internal request entity further includes at least one of the following: a base business transaction document universally unique identifier (UUID), a base business transaction document type code, a processing type code, a creation date time, a cancellation document indicator, a total gross amount, a total net amount, a total tax amount, a total discount amount, and a seller registration country code.

In another aspect, a distributed system operates in a landscape of computer systems providing message-based services defined in a service registry. The system comprises a graphical user interface comprising computer readable instructions, embedded on tangible media, for requesting to trigger a process to obtain legal authorization of a business transaction by legal authorities, the instructions using a request. The system further comprises a first memory storing a user interface controller for processing the request and involving a message including a message package hierarchically organized as a business transaction authorisation internal request message entity; and a business transaction authorisation internal request package including a business transaction authorisation internal request entity, wherein the business transaction authorisation internal request entity includes a base business transaction document identifier and a creation date, wherein the business transaction authorisation internal request entity further includes a buyer party entity and a seller party entity from a party package, and at least one business transaction authorisation internal request item entity from an item package, and wherein each business transaction authorisation internal request item entity includes an identifier and a type code. The system further comprises a second memory, remote from the graphical user interface, storing a plurality of service interfaces, wherein one of the service interfaces is operable to process the message via the service interface.

Implementations can include the following. The first memory is remote from the graphical user interface. The first memory is remote from the second memory.

In another aspect, a computer-readable medium includes program code for providing a message-based interface for exchanging information about rejected direct debits post processing initiation runs. The medium comprises program code for receiving, via a message-based interface exposing at least one service as defined in a service registry and from a heterogeneous application executing in an environment of computer systems providing message-based services, a first message for querying information about rejected direct debits post-processing initiation runs, including unrealized direct debit receivables. The first message includes a message package hierarchically organized as a rejected direct debits post-processing initiation run query by elements message entity; and a rejected direct debits post-processing initiation run package including a rejected direct debits post-processing initiation run entity, wherein the rejected direct debits post-processing initiation run entity includes a company universally unique identifier (UUID), an identifier (ID), system administrative data, and a status. The medium further comprises program code for sending a second message to the heterogeneous application responsive to the first message.

Implementations can include the following. The rejected direct debits post-processing initiation run entity further includes at least one of the following: at least one execution entity, at least one selection by company entity, at least one selection by house bank account entity, at least one selection by payment execution date entity, at least one selection by currency entity, at least one selection by business partner entity, at least one description entity, and at least one selection by house bank entity. The rejected direct debits post-processing initiation run entity further includes at least one of the following: a UUID and a mass data run object type code.

In another aspect, a distributed system operates in a landscape of computer systems providing message-based services defined in a service registry. The system comprises a graphical user interface comprising computer readable instructions, embedded on tangible media, for querying information about rejected direct debits post-processing initiation runs, including unrealized direct debit receivables, the instructions using a request. The system further comprises a first memory storing a user interface controller for processing the request and involving a message including a message package hierarchically organized as a rejected direct debits post-processing initiation run query by elements message entity; and a rejected direct debits post-processing initiation run package including a rejected direct debits post-processing initiation run entity, wherein the rejected direct debits post-processing initiation run entity includes a company universally unique identifier (UUID), an identifier (ID), system administrative data, and a status. The system further comprises a second memory, remote from the graphical user interface, storing a plurality of service interfaces, wherein one of the service interfaces is operable to process the message via the service interface.

Implementations can include the following. The first memory is remote from the graphical user interface. The first memory is remote from the second memory.

### BRIEF DESCRIPTION OF THE DRAWINGS

FIG. 1 depicts a flow diagram of the overall steps performed by methods and systems consistent with the subject matter described herein.

FIG. 2 depicts a business document flow for an invoice request in accordance with methods and systems consistent with the subject matter described herein.

FIGS. 3A-B illustrate example environments implementing the transmission, receipt, and processing of data between heterogeneous applications in accordance with certain embodiments included in the present disclosure.

FIG. 4 illustrates an example application implementing certain techniques and components in accordance with one embodiment of the system of FIG. 1.

FIG. 5A depicts an example development environment in accordance with one embodiment of FIG. 1.

FIG. 5B depicts a simplified process for mapping a model representation to a runtime representation using the example development environment of FIG. 5A or some other development environment.

FIG. 6 depicts message categories in accordance with methods and systems consistent with the subject matter described herein.

FIG. 7 depicts an example of a package in accordance with methods and systems consistent with the subject matter described herein.

FIG. 8 depicts another example of a package in accordance with methods and systems consistent with the subject matter described herein.

FIG. 9 depicts a third example of a package in accordance with methods and systems consistent with the subject matter described herein.

FIG. 10 depicts a fourth example of a package in accordance with methods and systems consistent with the subject matter described herein.

FIG. 11 depicts the representation of a package in the XML schema in accordance with methods and systems consistent with the subject matter described herein.

FIG. 12 depicts a graphical representation of cardinalities between two entities in accordance with methods and systems consistent with the subject matter described herein.

FIG. 13 depicts an example of a composition in accordance with methods and systems consistent with the subject matter described herein.

FIG. 14 depicts an example of a hierarchical relationship in accordance with methods and systems consistent with the subject matter described herein.

FIG. 15 depicts an example of an aggregating relationship in accordance with methods and systems consistent with the subject matter described herein.

FIG. 16 depicts an example of an association in accordance with methods and systems consistent with the subject matter described herein.

FIG. 17 depicts an example of a specialization in accordance with methods and systems consistent with the subject matter described herein.

FIG. 18 depicts the categories of specializations in accordance with methods and systems consistent with the subject matter described herein.

FIG. 19 depicts an example of a hierarchy in accordance with methods and systems consistent with the subject matter described herein.

FIG. 20 depicts a graphical representation of a hierarchy in accordance with methods and systems consistent with the subject matter described herein.

FIGS. 21A-B depict a flow diagram of the steps performed to create a business object model in accordance with methods and systems consistent with the subject matter described herein.

FIGS. 22A-F depict a flow diagram of the steps performed to generate an interface from the business object model in accordance with methods and systems consistent with the subject matter described herein.

FIG. 23 depicts an example illustrating the transmittal of a business document in accordance with methods and systems consistent with the subject matter described herein.

FIG. 24 depicts an interface proxy in accordance with methods and systems consistent with the subject matter described herein.

FIG. 25 depicts an example illustrating the transmittal of a message using proxies in accordance with methods and systems consistent with the subject matter described herein.

FIG. 26A depicts components of a message in accordance with methods and systems consistent with the subject matter described herein.

FIG. 26B depicts IDs used in a message in accordance with methods and systems consistent with the subject matter described herein.

FIGS. 27A-E depict a hierarchization process in accordance with methods and systems consistent with the subject matter described herein.

FIG. 28 illustrates an example method for service enabling in accordance with one embodiment of the present disclosure.

FIG. 29 is a graphical illustration of an example business object and associated components as may be used in the enterprise service infrastructure system of the present disclosure.

FIG. 30 illustrates an example method for managing a process agent framework in accordance with one embodiment of the present disclosure.

FIG. 31 illustrates an example method for status and action management in accordance with one embodiment of the present disclosure.

FIG. 32 depicts an example BusinessTransactionAuthorisationRequest object model.

FIGS. 33-1 through 33-2 depict an example BusinessTransactionAuthorisationInternalRequest message data type.

FIG. 34 depicts an example BusinessTransactionAuthorisationConfirmation message data type.

FIGS. 35-1 through 35-14 depict an example BusinessTransactionAuthorisationInternalRequest element structure.

FIGS. 36-1 through 36-2 depict an example BusinessTransactionAuthorisationConfirmation element structure.

FIG. 37 depicts an example RejectedDirectDebitsPostProcessingInitiationRun object model.

### DETAILED DESCRIPTION

A. Overview

Methods and systems consistent with the subject matter described herein facilitate e-commerce by providing consistent interfaces that are suitable for use across industries, across businesses, and across different departments within a business during a business transaction. To generate consistent interfaces, methods and systems consistent with the subject matter described herein utilize a business object model, which reflects the data that will be used during a given business transaction. An example of a business transaction is the exchange of purchase orders and order confirmations between a buyer and a seller. The business object model is generated in a hierarchical manner to ensure that the same type of data is represented the same way throughout the business object model. This ensures the consistency of the information in the business object model. Consistency is also reflected in the semantic meaning of the various structural elements. That is, each structural element has a consistent business meaning. For example, the location entity, regardless of in which package it is located, refers to a location.

From this business object model, various interfaces are derived to accomplish the functionality of the business transaction. Interfaces provide an entry point for components to access the functionality of an application. For example, the interface for a Purchase Order Request provides an entry point for components to access the functionality of a Purchase Order, in particular, to transmit and/or receive a Purchase Order Request. One skilled in the art will recognize that each of these interfaces may be provided, sold, distributed, utilized, or marketed as a separate product or as a major component of a separate product. Alternatively, a group of related interfaces may be provided, sold, distributed, utilized, or marketed as a product or as a major component of a separate product. Because the interfaces are generated from the business object model, the information in the interfaces is consistent, and the interfaces are consistent among the business entities. Such consistency facilitates heterogeneous business entities in cooperating to accomplish the business transaction.

Generally, the business object is a representation of a type of a uniquely identifiable business entity (an object instance) described by a structural model. In the architecture, processes may typically operate on business objects. Business objects represent a specific view on some well-defined business content. In other words, business objects represent content, which a typical business user would expect and understand with little explanation. Business objects are further categorized as business process objects and master data objects. A master data object is an object that encapsulates master data (i.e., data that is valid for a period of time). A business process object, which is the kind of business object generally found in a process component, is an object that encapsulates transactional data (i.e., data that is valid for a point in time). The term business object will be used generically to refer to a business process object and a master data object, unless the context requires otherwise. Properly implemented, business objects are implemented free of redundancies.

The architectural elements also include the process component. The process component is a software package that realizes a business process and generally exposes its functionality as services. The functionality contains business transactions. In general, the process component contains one or more semantically related business objects. Often, a particular business object belongs to no more than one process component. Interactions between process component pairs involving their respective business objects, process agents, operations, interfaces, and messages are described as process component interactions, which generally determine the interactions of a pair of process components across a deployment unit boundary. Interactions between process components within a deployment unit are typically not constrained by the architectural design and can be implemented in any convenient fashion. Process components may be modular and context-independent. In other words, process components may not be specific to any particular application and as such, may be reusable. In some implementations, the process component is the smallest (most granular) element of reuse in the architecture. An external process component is generally used to represent the external system in describing interactions with the external system; however, this should be understood to require no more of the external system than that able to produce and receive messages as required by the process component that interacts with the external system. For example, process components may include multiple operations that may provide interaction with the external system. Each operation generally belongs to one type of process component in the architecture. Operations can be synchronous or asynchronous, corresponding to synchronous or asynchronous process agents, which will be described below. The operation is often the smallest, separately-callable function, described by a set of data types used as input, output, and fault parameters serving as a signature.

The architectural elements may also include the service interface, referred to simply as the interface. The interface is a named group of operations. The interface often belongs to one process component and process component might contain multiple interfaces. In one implementation, the service interface contains only inbound or outbound operations, but not a mixture of both. One interface can contain both synchronous and asynchronous operations. Normally, operations of the same type (either inbound or outbound) which belong to the same message choreography will belong to the same interface. Thus, generally, all outbound operations to the same other process component are in one interface.

The architectural elements also include the message. Operations transmit and receive messages. Any convenient messaging infrastructure can be used. A message is information conveyed from one process component instance to another, with the expectation that activity will ensue. Operation can use multiple message types for inbound, outbound, or error messages. When two process components are in different deployment units, invocation of an operation of one process component by the other process component is accomplished by the operation on the other process component sending a message to the first process component.

The architectural elements may also include the process agent. Process agents do business processing that involves the sending or receiving of messages. Each operation normally has at least one associated process agent. Each process agent can be associated with one or more operations. Process agents can be either inbound or outbound and either synchronous or asynchronous. Asynchronous outbound process agents are called after a business object changes such as after a “create”, “update”, or “delete” of a business object instance. Synchronous outbound process agents are generally triggered directly by business object. An outbound process agent will generally perform some processing of the data of the business object instance whose change triggered the event. The outbound agent triggers subsequent business process steps by sending messages using well-defined outbound services to another process component, which generally will be in another deployment unit, or to an external system. The outbound process agent is linked to the one business object that triggers the agent, but it is sent not to another business object but rather to another process component. Thus, the outbound process agent can be implemented without knowledge of the exact business object design of the recipient process component. Alternatively, the process agent may be inbound. For example, inbound process agents may be used for the inbound part of a message-based communication. Inbound process agents are called after a message has been received. The inbound process agent starts the execution of the business process step requested in a message by creating or updating one or multiple business object instances. Inbound process agent is not generally the agent of business object but of its process component. Inbound process agent can act on multiple business objects in a process component. Regardless of whether the process agent is inbound or outbound, an agent may be synchronous if used when a process component requires a more or less immediate response from another process component, and is waiting for that response to continue its work.

The architectural elements also include the deployment unit. Each deployment unit may include one or more process components that are generally deployed together on a single computer system platform. Conversely, separate deployment units can be deployed on separate physical computing systems. The process components of one deployment unit can interact with those of another deployment unit using messages passed through one or more data communication networks or other suitable communication channels. Thus, a deployment unit deployed on a platform belonging to one business can interact with a deployment unit software entity deployed on a separate platform belonging to a different and unrelated business, allowing for business-to-business communication. More than one instance of a given deployment unit can execute at the same time, on the same computing system or on separate physical computing systems. This arrangement allows the functionality offered by the deployment unit to be scaled to meet demand by creating as many instances as needed.

Since interaction between deployment units is through process component operations, one deployment unit can be replaced by other another deployment unit as long as the new deployment unit supports the operations depended upon by other deployment units as appropriate. Thus, while deployment units can depend on the external interfaces of process components in other deployment units, deployment units are not dependent on process component interaction within other deployment units. Similarly, process components that interact with other process components or external systems only through messages, e.g., as sent and received by operations, can also be replaced as long as the replacement generally supports the operations of the original.

Services (or interfaces) may be provided in a flexible architecture to support varying criteria between services and systems. The flexible architecture may generally be provided by a service delivery business object. The system may be able to schedule a service asynchronously as necessary, or on a regular basis. Services may be planned according to a schedule manually or automatically. For example, a follow-up service may be scheduled automatically upon completing an initial service. In addition, flexible execution periods may be possible (e.g. hourly, daily, every three months, etc.). Each customer may plan the services on demand or reschedule service execution upon request.

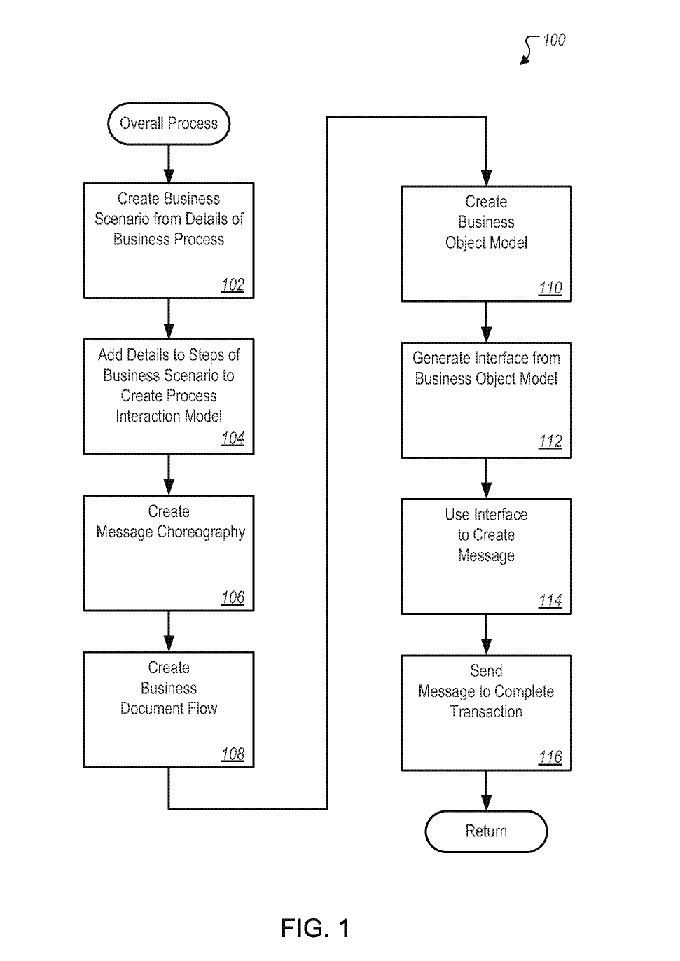

FIG. 1 depicts a flow diagram 100 showing an example technique, perhaps implemented by systems similar to those disclosed herein. Initially, to generate the business object model, design engineers study the details of a business process, and model the business process using a “business scenario” (step 102). The business scenario identifies the steps performed by the different business entities during a business process. Thus, the business scenario is a complete representation of a clearly defined business process.

After creating the business scenario, the developers add details to each step of the business scenario (step 104). In particular, for each step of the business scenario, the developers identify the complete process steps performed by each business entity. A discrete portion of the business scenario reflects a “business transaction,” and each business entity is referred to as a “component” of the business transaction. The developers also identify the messages that are transmitted between the components. A “process interaction model” represents the complete process steps between two components.

After creating the process interaction model, the developers create a “message choreography” (step 106), which depicts the messages transmitted between the two components in the process interaction model. The developers then represent the transmission of the messages between the components during a business process in a “business document flow” (step 108). Thus, the business document flow illustrates the flow of information between the business entities during a business process.

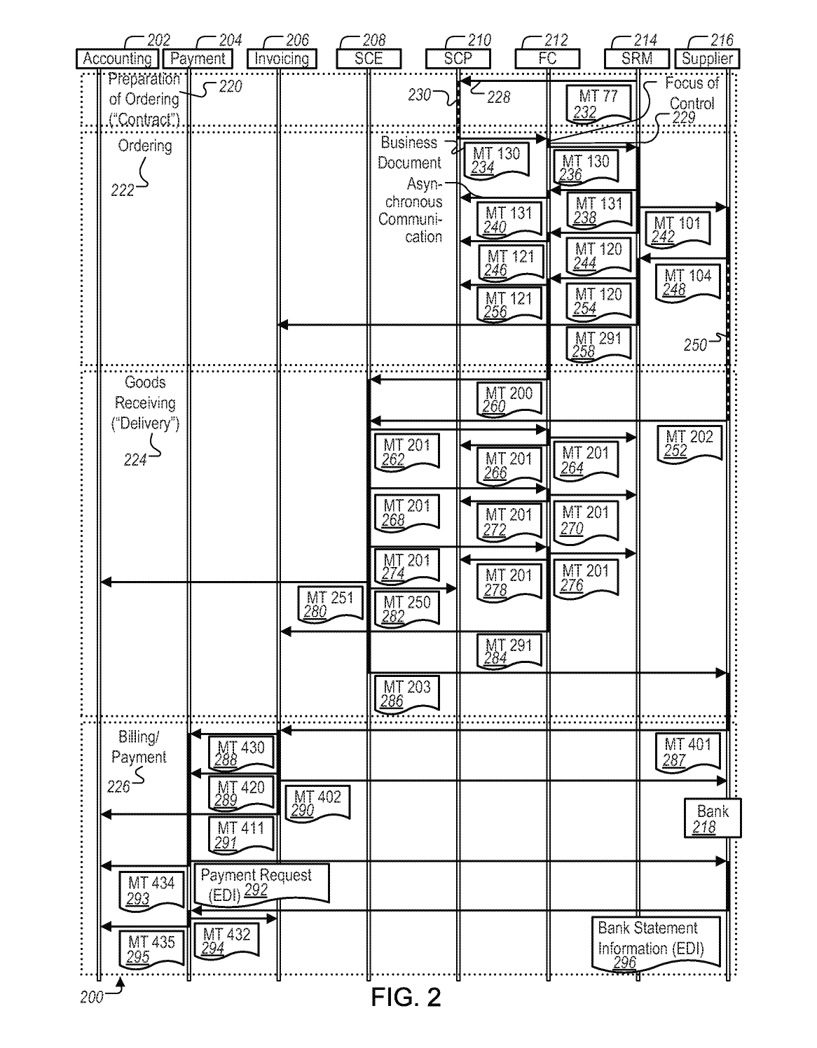

FIG. 2 depicts an example business document flow 200 for the process of purchasing a product or service. The business entities involved with the illustrative purchase process include Accounting 202, Payment 204, Invoicing 206, Supply Chain Execution (“SCE”) 208, Supply Chain Planning (“SCP”) 210, Fulfillment Coordination (“FC”) 212, Supply Relationship Management (“SRM”) 214, Supplier 216, and Bank 218. The business document flow 200 is divided into four different transactions: Preparation of Ordering (“Contract”) 220, Ordering 222, Goods Receiving (“Delivery”) 224, and Billing/Payment 226. In the business document flow, arrows 228 represent the transmittal of documents. Each document reflects a message transmitted between entities. One of ordinary skill in the art will appreciate that the messages transferred may be considered to be a communications protocol. The process flow follows the focus of control, which is depicted as a solid vertical line (e.g., 229) when the step is required, and a dotted vertical line (e.g., 230) when the step is optional.

During the Contract transaction 220, the SRM 214 sends a Source of Supply Notification 232 to the SCP 210. This step is optional, as illustrated by the optional control line 230 coupling this step to the remainder of the business document flow 200. During the Ordering transaction 222, the SCP 210 sends a Purchase Requirement Request 234 to the FC 212, which forwards a Purchase Requirement Request 236 to the SRM 214. The SRM 214 then sends a Purchase Requirement Confirmation 238 to the FC 212, and the FC 212 sends a Purchase Requirement Confirmation 240 to the SCP 210. The SRM 214 also sends a Purchase Order Request 242 to the Supplier 216, and sends Purchase Order Information 244 to the FC 212. The FC 212 then sends a Purchase Order Planning Notification 246 to the SCP 210. The Supplier 216, after receiving the Purchase Order Request 242, sends a Purchase Order Confirmation 248 to the SRM 214, which sends a Purchase Order Information confirmation message 254 to the FC 212, which sends a message 256 confirming the Purchase Order Planning Notification to the SCP 210. The SRM 214 then sends an Invoice Due Notification 258 to Invoicing 206.

During the Delivery transaction 224, the FC 212 sends a Delivery Execution Request 260 to the SCE 208. The Supplier 216 could optionally (illustrated at control line 250) send a Dispatched Delivery Notification 252 to the SCE 208. The SCE 208 then sends a message 262 to the FC 212 notifying the FC 212 that the request for the Delivery Information was created. The FC 212 then sends a message 264 notifying the SRM 214 that the request for the Delivery Information was created. The FC 212 also sends a message 266 notifying the SCP 210 that the request for the Delivery Information was created. The SCE 208 sends a message 268 to the FC 212 when the goods have been set aside for delivery. The FC 212 sends a message 270 to the SRM 214 when the goods have been set aside for delivery. The FC 212 also sends a message 272 to the SCP 210 when the goods have been set aside for delivery.

The SCE 208 sends a message 274 to the FC 212 when the goods have been delivered. The FC 212 then sends a message 276 to the SRM 214 indicating that the goods have been delivered, and sends a message 278 to the SCP 210 indicating that the goods have been delivered. The SCE 208 then sends an Inventory Change Accounting Notification 280 to Accounting 202, and an Inventory Change Notification 282 to the SCP 210. The FC 212 sends an Invoice Due Notification 284 to Invoicing 206, and SCE 208 sends a Received Delivery Notification 286 to the Supplier 216.

During the Billing/Payment transaction 226, the Supplier 216 sends an Invoice Request 287 to Invoicing 206. Invoicing 206 then sends a Payment Due Notification 288 to Payment 204, a Tax Due Notification 289 to Payment 204, an Invoice Confirmation 290 to the Supplier 216, and an Invoice Accounting Notification 291 to Accounting 202. Payment 204 sends a Payment Request 292 to the Bank 218, and a Payment Requested Accounting Notification 293 to Accounting 202. Bank 218 sends a Bank Statement Information 296 to Payment 204. Payment 204 then sends a Payment Done Information 294 to Invoicing 206 and a Payment Done Accounting Notification 295 to Accounting 202.

Within a business document flow, business documents having the same or similar structures are marked. For example, in the business document flow 200 depicted in FIG. 2, Purchase Requirement Requests 234, 236 and Purchase Requirement Confirmations 238, 240 have the same structures. Thus, each of these business documents is marked with an “O6.” Similarly, Purchase Order Request 242 and Purchase Order Confirmation 248 have the same structures. Thus, both documents are marked with an “O1.” Each business document or message is based on a message type.

From the business document flow, the developers identify the business documents having identical or similar structures, and use these business documents to create the business object model (step 110). The business object model includes the objects contained within the business documents. These objects are reflected as packages containing related information, and are arranged in a hierarchical structure within the business object model, as discussed below.

Methods and systems consistent with the subject matter described herein then generate interfaces from the business object model (step 112). The heterogeneous programs use instantiations of these interfaces (called “business document objects” below) to create messages (step 114), which are sent to complete the business transaction (step 116). Business entities use these messages to exchange information with other business entities during an end-to-end business transaction. Since the business object model is shared by heterogeneous programs, the interfaces are consistent among these programs. The heterogeneous programs use these consistent interfaces to communicate in a consistent manner, thus facilitating the business transactions.

Standardized Business-to-Business (“B2B”) messages are compliant with at least one of the e-business standards (i.e., they include the business-relevant fields of the standard). The e-business standards include, for example, RosettaNet for the high-tech industry, Chemical Industry Data Exchange (“CIDX”), Petroleum Industry Data Exchange (“PIDX”) for the oil industry, UCCnet for trade, PapiNet for the paper industry, Odette for the automotive industry, HR-XML for human resources, and XML Common Business Library (“xCBL”). Thus, B2B messages enable simple integration of components in heterogeneous system landscapes. Application-to-Application (“A2A”) messages often exceed the standards and thus may provide the benefit of the full functionality of application components. Although various steps of FIG. 1 were described as being performed manually, one skilled in the art will appreciate that such steps could be computer-assisted or performed entirely by a computer, including being performed by either hardware, software, or any other combination thereof.

B. Implementation Details

As discussed above, methods and systems consistent with the subject matter described herein create consistent interfaces by generating the interfaces from a business object model. Details regarding the creation of the business object model, the generation of an interface from the business object model, and the use of an interface generated from the business object model are provided below.

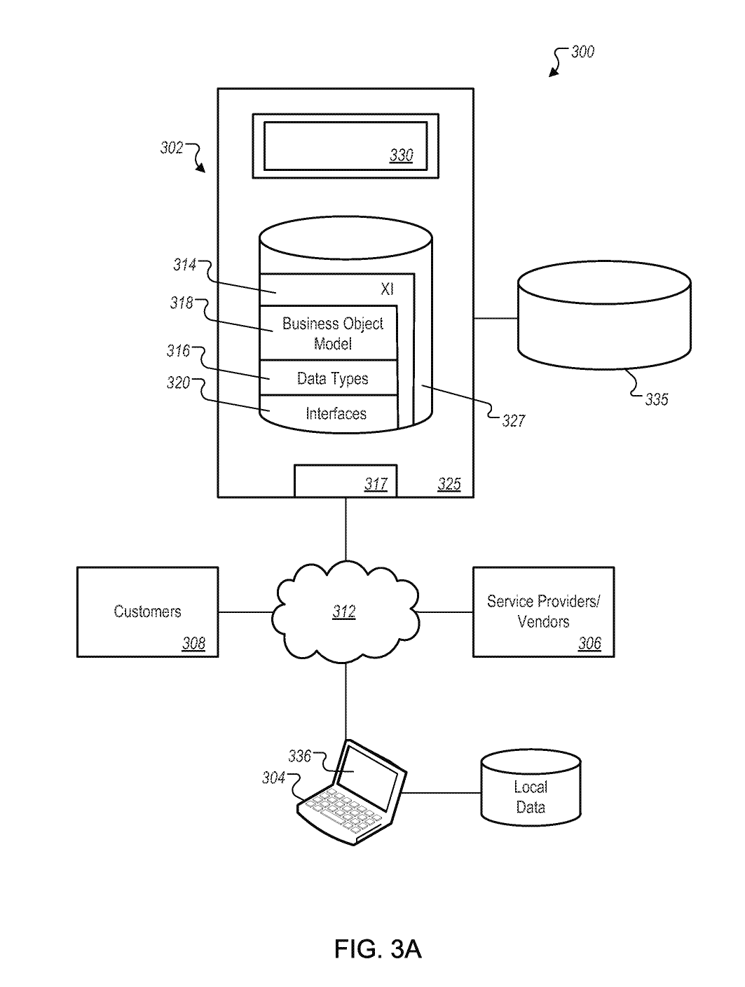

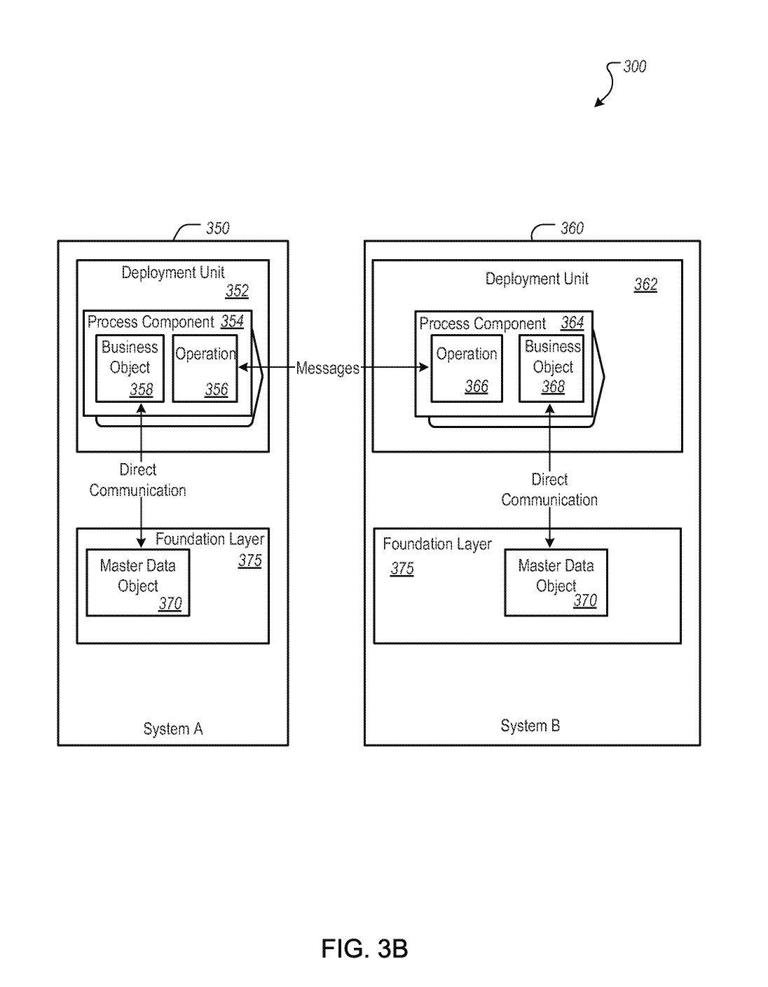

Turning to the illustrated embodiment in FIG. 3A, environment 300 includes or is communicably coupled (such as via a one-, bi- or multi-directional link or network) with server 302, one or more clients 304, one or more or vendors 306, one or more customers 308, at least some of which communicate across network 312. But, of course, this illustration is for example purposes only, and any distributed system or environment implementing one or more of the techniques described herein may be within the scope of this disclosure. Server 302 comprises an electronic computing device operable to receive, transmit, process and store data associated with environment 300. Generally, FIG. 3A provides merely one example of computers that may be used with the disclosure. Each computer is generally intended to encompass any suitable processing device. For example, although FIG. 3A illustrates one server 302 that may be used with the disclosure, environment 300 can be implemented using computers other than servers, as well as a server pool. Indeed, server 302 may be any computer or processing device such as, for example, a blade server, general-purpose personal computer (PC), Macintosh, workstation, Unix-based computer, or any other suitable device. In other words, the present disclosure contemplates computers other than general purpose computers as well as computers without conventional operating systems. Server 302 may be adapted to execute any operating system including Linux, UNIX, Windows Server, or any other suitable operating system. According to one embodiment, server 302 may also include or be communicably coupled with a web server and/or a mail server.

As illustrated (but not required), the server 302 is communicably coupled with a relatively remote repository 335 over a portion of the network 312. The repository 335 is any electronic storage facility, data processing center, or archive that may supplement or replace local memory (such as 327). The repository 335 may be a central database communicably coupled with the one or more servers 302 and the clients 304 via a virtual private network (VPN), SSH (Secure Shell) tunnel, or other secure network connection. The repository 335 may be physically or logically located at any appropriate location including in one of the example enterprises or off-shore, so long as it remains operable to store information associated with the environment 300 and communicate such data to the server 302 or at least a subset of plurality of the clients 304.

Illustrated server 302 includes local memory 327. Memory 327 may include any memory or database module and may take the form of volatile or non-volatile memory including, without limitation, magnetic media, optical media, random access memory (RAM), read-only memory (ROM), removable media, or any other suitable local or remote memory component. Illustrated memory 327 includes an exchange infrastructure (“XI”) 314, which is an infrastructure that supports the technical interaction of business processes across heterogeneous system environments. XI 314 centralizes the communication between components within a business entity and between different business entities. When appropriate, XI 314 carries out the mapping between the messages. XI 314 integrates different versions of systems implemented on different platforms (e.g., Java and ABAP). XI 314 is based on an open architecture, and makes use of open standards, such as eXtensible Markup Language (XML)™ and Java environments. XI 314 offers services that are useful in a heterogeneous and complex system landscape. In particular, XI 314 offers a runtime infrastructure for message exchange, configuration options for managing business processes and message flow, and options for transforming message contents between sender and receiver systems.

XI 314 stores data types 316, a business object model 318, and interfaces 320. The details regarding the business object model are described below. Data types 316 are the building blocks for the business object model 318. The business object model 318 is used to derive consistent interfaces 320. XI 314 allows for the exchange of information from a first company having one computer system to a second company having a second computer system over network 312 by using the standardized interfaces 320.

While not illustrated, memory 327 may also include business objects and any other appropriate data such as services, interfaces, VPN applications or services, firewall policies, a security or access log, print or other reporting files, HTML files or templates, data classes or object interfaces, child software applications or sub-systems, and others. This stored data may be stored in one or more logical or physical repositories. In some embodiments, the stored data (or pointers thereto) may be stored in one or more tables in a relational database described in terms of SQL statements or scripts. In the same or other embodiments, the stored data may also be formatted, stored, or defined as various data structures in text files, XML documents, Virtual Storage Access Method (VSAM) files, flat files, Btrieve files, comma-separated-value (CSV) files, internal variables, or one or more libraries. For example, a particular data service record may merely be a pointer to a particular piece of third party software stored remotely. In another example, a particular data service may be an internally stored software object usable by authenticated customers or internal development. In short, the stored data may comprise one table or file or a plurality of tables or files stored on one computer or across a plurality of computers in any appropriate format. Indeed, some or all of the stored data may be local or remote without departing from the scope of this disclosure and store any type of appropriate data.

Server 302 also includes processor 325. Processor 325 executes instructions and manipulates data to perform the operations of server 302 such as, for example, a central processing unit (CPU), a blade, an application specific integrated circuit (ASIC), or a field-programmable gate array (FPGA). Although FIG. 3A illustrates a single processor 325 in server 302, multiple processors 325 may be used according to particular needs and reference to processor 325 is meant to include multiple processors 325 where applicable. In the illustrated embodiment, processor 325 executes at least business application 330.

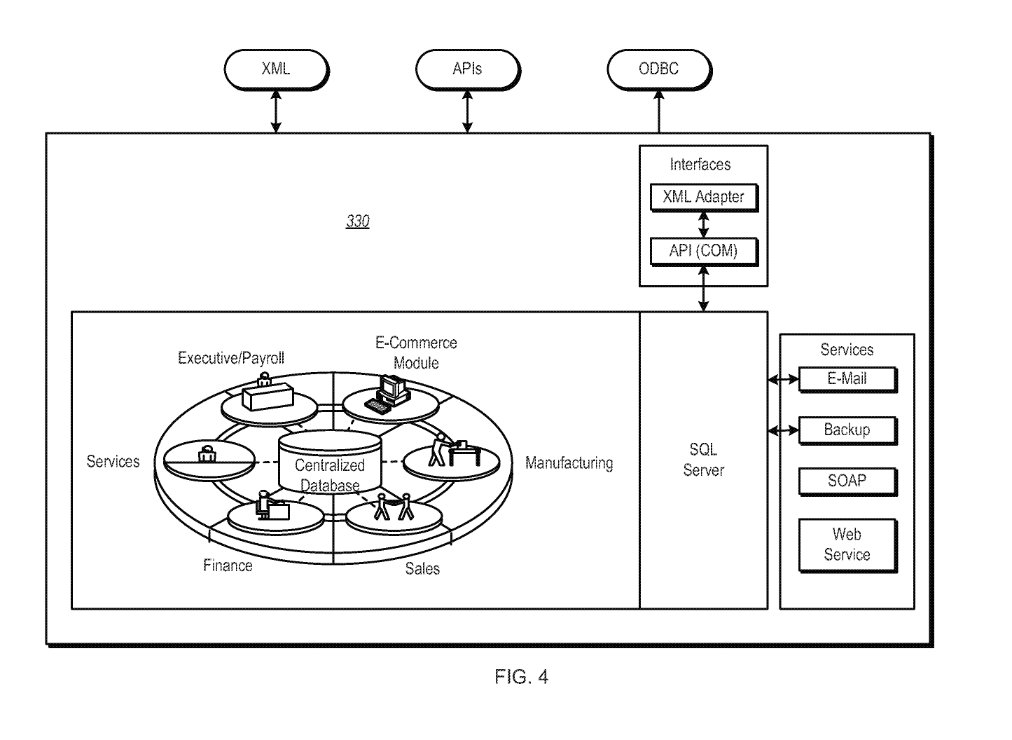

At a high level, business application 330 is any application, program, module, process, or other software that utilizes or facilitates the exchange of information via messages (or services) or the use of business objects. For example, application 330 may implement, utilize or otherwise leverage an enterprise service-oriented architecture (enterprise SOA), which may be considered a blueprint for an adaptable, flexible, and open IT architecture for developing services-based, enterprise-scale business solutions. This example enterprise service may be a series of web services combined with business logic that can be accessed and used repeatedly to support a particular business process. Aggregating web services into business-level enterprise services helps provide a more meaningful foundation for the task of automating enterprise-scale business scenarios Put simply, enterprise services help provide a holistic combination of actions that are semantically linked to complete the specific task, no matter how many cross-applications are involved. In certain cases, environment 300 may implement a composite application 330, as described below in FIG. 4. Regardless of the particular implementation, “software” may include software, firmware, wired or programmed hardware, or any combination thereof as appropriate. Indeed, application 330 may be written or described in any appropriate computer language including C, C++, Java, Visual Basic, assembler, Perl, any suitable version of 4GL, as well as others. For example, returning to the above mentioned composite application, the composite application portions may be implemented as Enterprise Java Beans (EJBs) or the design-time components may have the ability to generate run-time implementations into different platforms, such as J2EE (Java 2 Platform, Enterprise Edition), ABAP (Advanced Business Application Programming) objects, or Microsoft's .NET. It will be understood that while application 330 is illustrated in FIG. 4 as including various sub-modules, application 330 may include numerous other sub-modules or may instead be a single multi-tasked module that implements the various features and functionality through various objects, methods, or other processes. Further, while illustrated as internal to server 302, one or more processes associated with application 330 may be stored, referenced, or executed remotely. For example, a portion of application 330 may be a web service that is remotely called, while another portion of application 330 may be an interface object bundled for processing at remote client 304. Moreover, application 330 may be a child or sub-module of another software module or enterprise application (not illustrated) without departing from the scope of this disclosure. Indeed, application 330 may be a hosted solution that allows multiple related or third parties in different portions of the process to perform the respective processing.

More specifically, as illustrated in FIG. 4, application 330 may be a composite application, or an application built on other applications, that includes an object access layer (OAL) and a service layer. In this example, application 330 may execute or provide a number of application services, such as customer relationship management (CRM) systems, human resources management (HRM) systems, financial management (FM) systems, project management (PM) systems, knowledge management (KM) systems, and electronic file and mail systems. Such an object access layer is operable to exchange data with a plurality of enterprise base systems and to present the data to a composite application through a uniform interface. The example service layer is operable to provide services to the composite application. These layers may help the composite application to orchestrate a business process in synchronization with other existing processes (e.g., native processes of enterprise base systems) and leverage existing investments in the IT platform. Further, composite application 330 may run on a heterogeneous IT platform. In doing so, composite application may be cross-functional in that it may drive business processes across different applications, technologies, and organizations. Accordingly, composite application 330 may drive end-to-end business processes across heterogeneous systems or sub-systems. Application 330 may also include or be coupled with a persistence layer and one or more application system connectors. Such application system connectors enable data exchange and integration with enterprise sub-systems and may include an Enterprise Connector (EC) interface, an Internet Communication Manager/Internet Communication Framework (ICM/ICF) interface, an Encapsulated PostScript (EPS) interface, and/or other interfaces that provide Remote Function Call (RFC) capability. It will be understood that while this example describes a composite application 330, it may instead be a standalone or (relatively) simple software program. Regardless, application 330 may also perform processing automatically, which may indicate that the appropriate processing is substantially performed by at least one component of environment 300. It should be understood that automatically further contemplates any suitable administrator or other user interaction with application 330 or other components of environment 300 without departing from the scope of this disclosure.

Returning to FIG. 3A, illustrated server 302 may also include interface 317 for communicating with other computer systems, such as clients 304, over network 312 in a client-server or other distributed environment. In certain embodiments, server 302 receives data from internal or external senders through interface 317 for storage in memory 327, for storage in DB 335, and/or processing by processor 325. Generally, interface 317 comprises logic encoded in software and/or hardware in a suitable combination and operable to communicate with network 312. More specifically, interface 317 may comprise software supporting one or more communications protocols associated with communications network 312 or hardware operable to communicate physical signals.

Network 312 facilitates wireless or wireline communication between computer server 302 and any other local or remote computer, such as clients 304. Network 312 may be all or a portion of an enterprise or secured network. In another example, network 312 may be a VPN merely between server 302 and client 304 across wireline or wireless link. Such an example wireless link may be via 802.11a, 802.11b, 802.11g, 802.20, WiMax, and many others. While illustrated as a single or continuous network, network 312 may be logically divided into various sub-nets or virtual networks without departing from the scope of this disclosure, so long as at least portion of network 312 may facilitate communications between server 302 and at least one client 304. For example, server 302 may be communicably coupled to one or more “local” repositories through one sub-net while communicably coupled to a particular client 304 or “remote” repositories through another. In other words, network 312 encompasses any internal or external network, networks, sub-network, or combination thereof operable to facilitate communications between various computing components in environment 300. Network 312 may communicate, for example, Internet Protocol (IP) packets, Frame Relay frames, Asynchronous Transfer Mode (ATM) cells, voice, video, data, and other suitable information between network addresses. Network 312 may include one or more local area networks (LANs), radio access networks (RANs), metropolitan area networks (MANs), wide area networks (WANs), all or a portion of the global computer network known as the Internet, and/or any other communication system or systems at one or more locations. In certain embodiments, network 312 may be a secure network associated with the enterprise and certain local or remote vendors 306 and customers 308. As used in this disclosure, customer 308 is any person, department, organization, small business, enterprise, or any other entity that may use or request others to use environment 300. As described above, vendors m 306 also may be local or remote to customer 308. Indeed, a particular vendor 306 may provide some content to business application 330, while receiving or purchasing other content (at the same or different times) as customer 308. As illustrated, customer 308 and vendor 06 each typically perform some processing (such as uploading or purchasing content) using a computer, such as client 304.

Client 304 is any computing device operable to connect or communicate with server 302 or network 312 using any communication link. For example, client 304 is intended to encompass a personal computer, touch screen terminal, workstation, network computer, kiosk, wireless data port, smart phone, personal data assistant (PDA), one or more processors within these or other devices, or any other suitable processing device used by or for the benefit of business 308, vendor 306, or some other user or entity. At a high level, each client 304 includes or executes at least GUI 336 and comprises an electronic computing device operable to receive, transmit, process and store any appropriate data associated with environment 300. It will be understood that there may be any number of clients 304 communicably coupled to server 302. Further, “client 304,” “business,” “business analyst,” “end user,” and “user” may be used interchangeably as appropriate without departing from the scope of this disclosure. Moreover, for ease of illustration, each client 304 is described in terms of being used by one user. But this disclosure contemplates that many users may use one computer or that one user may use multiple computers. For example, client 304 may be a PDA operable to wirelessly connect with external or unsecured network. In another example, client 304 may comprise a laptop that includes an input device, such as a keypad, touch screen, mouse, or other device that can accept information, and an output device that conveys information associated with the operation of server 302 or clients 304, including digital data, visual information, or GUI 336. Both the input device and output device may include fixed or removable storage media such as a magnetic computer disk, CD-ROM, or other suitable media to both receive input from and provide output to users of clients 304 through the display, namely the client portion of GUI or application interface 336.

GUI 336 comprises a graphical user interface operable to allow the user of client 304 to interface with at least a portion of environment 300 for any suitable purpose, such as viewing application or other transaction data. Generally, GUI 336 provides the particular user with an efficient and user-friendly presentation of data provided by or communicated within environment 300. For example, GUI 336 may present the user with the components and information that is relevant to their task, increase reuse of such components, and facilitate a sizable developer community around those components. GUI 336 may comprise a plurality of customizable frames or views having interactive fields, pull-down lists, and buttons operated by the user. For example, GUI 336 is operable to display data involving business objects and interfaces in a user-friendly form based on the user context and the displayed data. In another example, GUI 336 is operable to display different levels and types of information involving business objects and interfaces based on the identified or supplied user role. GUI 336 may also present a plurality of portals or dashboards. For example, GUI 336 may display a portal that allows users to view, create, and manage historical and real-time reports including role-based reporting and such. Of course, such reports may be in any appropriate output format including PDF, HTML, and printable text. Real-time dashboards often provide table and graph information on the current state of the data, which may be supplemented by business objects and interfaces. It should be understood that the term graphical user interface may be used in the singular or in the plural to describe one or more graphical user interfaces and each of the displays of a particular graphical user interface. Indeed, reference to GUI 336 may indicate a reference to the front-end or a component of business application 330, as well as the particular interface accessible via client 304, as appropriate, without departing from the scope of this disclosure. Therefore, GUI 336 contemplates any graphical user interface, such as a generic web browser or touchscreen, that processes information in environment 300 and efficiently presents the results to the user. Server 302 can accept data from client 304 via the web browser (e.g., Microsoft Internet Explorer or Netscape Navigator) and return the appropriate HTML or XML responses to the browser using network 312.

More generally in environment 300 as depicted in FIG. 3B, a Foundation Layer 375 can be deployed on multiple separate and distinct hardware platforms, e.g., System A 350 and System B 360, to support application software deployed as two or more deployment units distributed on the platforms, including deployment unit 352 deployed on System A and deployment unit 362 deployed on System B. In this example, the foundation layer can be used to support application software deployed in an application layer. In particular, the foundation layer can be used in connection with application software implemented in accordance with a software architecture that provides a suite of enterprise service operations having various application functionality. In some implementations, the application software is implemented to be deployed on an application platform that includes a foundation layer that contains all fundamental entities that can used from multiple deployment units. These entities can be process components, business objects, and reuse service components. A reuse service component is a piece of software that is reused in different transactions. A reuse service component is used by its defined interfaces, which can be, e.g., local APIs or service interfaces. As explained above, process components in separate deployment units interact through service operations, as illustrated by messages passing between service operations 356 and 366, which are implemented in process components 354 and 364, respectively, which are included in deployment units 352 and 362, respectively. As also explained above, some form of direct communication is generally the form of interaction used between a business object, e.g., business object 358 and 368, of an application deployment unit and a business object, such as master data object 370, of the Foundation Layer 375.

Various components of the present disclosure may be modeled using a model-driven environment. For example, the model-driven framework or environment may allow the developer to use simple drag-and-drop techniques to develop pattern-based or freestyle user interfaces and define the flow of data between them. The result could be an efficient, customized, visually rich online experience. In some cases, this model-driven development may accelerate the application development process and foster business-user self-service. It further enables business analysts or IT developers to compose visually rich applications that use analytic services, enterprise services, remote function calls (RFCs), APIs, and stored procedures. In addition, it may allow them to reuse existing applications and create content using a modeling process and a visual user interface instead of manual coding.

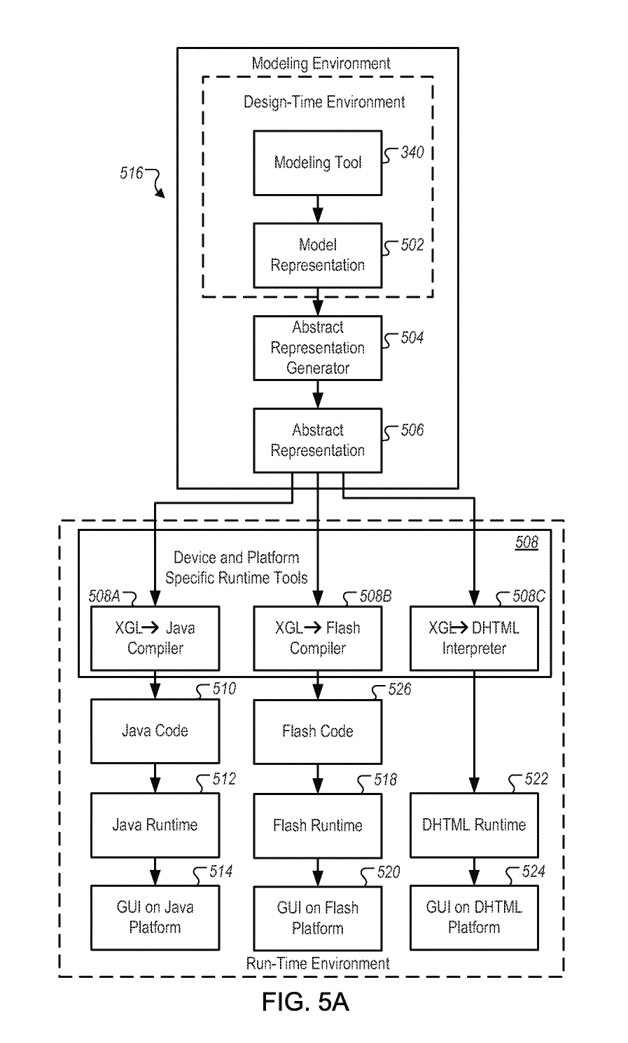

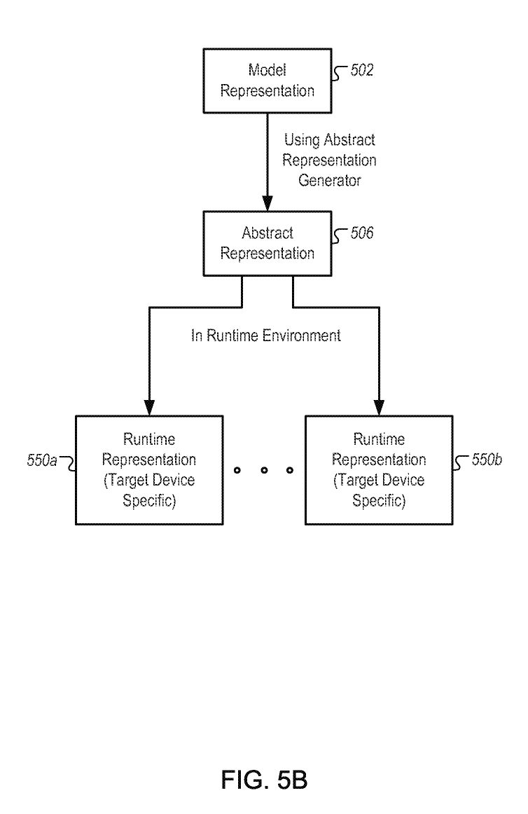

FIG. 5A depicts an example modeling environment 516, namely a modeling environment, in accordance with one embodiment of the present disclosure. Thus, as illustrated in FIG. 5A, such a modeling environment 516 may implement techniques for decoupling models created during design-time from the runtime environment. In other words, model representations for GUIs created in a design time environment are decoupled from the runtime environment in which the GUIs are executed. Often in these environments, a declarative and executable representation for GUIs for applications is provided that is independent of any particular runtime platform, GUI framework, device, or programming language.

According to some embodiments, a modeler (or other analyst) may use the model-driven modeling environment 516 to create pattern-based or freestyle user interfaces using simple drag-and-drop services. Because this development may be model-driven, the modeler can typically compose an application using models of business objects without having to write much, if any, code. In some cases, this example modeling environment 516 may provide a personalized, secure interface that helps unify enterprise applications, information, and processes into a coherent, role-based portal experience. Further, the modeling environment 516 may allow the developer to access and share information and applications in a collaborative environment. In this way, virtual collaboration rooms allow developers to work together efficiently, regardless of where they are located, and may enable powerful and immediate communication that crosses organizational boundaries while enforcing security requirements. Indeed, the modeling environment 516 may provide a shared set of services for finding, organizing, and accessing unstructured content stored in third-party repositories and content management systems across various networks 312. Classification tools may automate the organization of information, while subject-matter experts and content managers can publish information to distinct user audiences. Regardless of the particular implementation or architecture, this modeling environment 516 may allow the developer to easily model hosted business objects 140 using this model-driven approach.

In certain embodiments, the modeling environment 516 may implement or utilize a generic, declarative, and executable GUI language (generally described as XGL). This example XGL is generally independent of any particular GUI framework or runtime platform. Further, XGL is normally not dependent on characteristics of a target device on which the graphic user interface is to be displayed and may also be independent of any programming language. XGL is used to generate a generic representation (occasionally referred to as the XGL representation or XGL-compliant representation) for a design-time model representation. The XGL representation is thus typically a device-independent representation of a GUI. The XGL representation is declarative in that the representation does not depend on any particular GUI framework, runtime platform, device, or programming language. The XGL representation can be executable and therefore can unambiguously encapsulate execution semantics for the GUI described by a model representation. In short, models of different types can be transformed to XGL representations.

The XGL representation may be used for generating representations of various different GUIs and supports various GUI features including full windowing and componentization support, rich data visualizations and animations, rich modes of data entry and user interactions, and flexible connectivity to any complex application data services. While a specific embodiment of XGL is discussed, various other types of XGLs may also be used in alternative embodiments. In other words, it will be understood that XGL is used for example description only and may be read to include any abstract or modeling language that can be generic, declarative, and executable.

Turning to the illustrated embodiment in FIG. 5A, modeling tool 340 may be used by a GUI designer or business analyst during the application design phase to create a model representation 502 for a GUI application. It will be understood that modeling environment 516 may include or be compatible with various different modeling tools 340 used to generate model representation 502. This model representation 502 may be a machine-readable representation of an application or a domain specific model. Model representation 502 generally encapsulates various design parameters related to the GUI such as GUI components, dependencies between the GUI components, inputs and outputs, and the like. Put another way, model representation 502 provides a form in which the one or more models can be persisted and transported, and possibly handled by various tools such as code generators, runtime interpreters, analysis and validation tools, merge tools, and the like. In one embodiment, model representation 502 maybe a collection of XML documents with a well-formed syntax.

Illustrated modeling environment 516 also includes an abstract representation generator (or XGL generator) 504 operable to generate an abstract representation (for example, XGL representation or XGL-compliant representation) 506 based upon model representation 502. Abstract representation generator 504 takes model representation 502 as input and outputs abstract representation 506 for the model representation. Model representation 502 may include multiple instances of various forms or types depending on the tool/language used for the modeling. In certain cases, these various different model representations may each be mapped to one or more abstract representations 506. Different types of model representations may be transformed or mapped to XGL representations. For each type of model representation, mapping rules may be provided for mapping the model representation to the XGL representation 506. Different mapping rules may be provided for mapping a model representation to an XGL representation.

This XGL representation 506 that is created from a model representation may then be used for processing in the runtime environment. For example, the XGL representation 506 may be used to generate a machine-executable runtime GUI (or some other runtime representation) that may be executed by a target device. As part of the runtime processing, the XGL representation 506 may be transformed into one or more runtime representations, which may indicate source code in a particular programming language, machine-executable code for a specific runtime environment, executable GUI, and so forth, which may be generated for specific runtime environments and devices. Since the XGL representation 506, rather than the design-time model representation, is used by the runtime environment, the design-time model representation is decoupled from the runtime environment. The XGL representation 506 can thus serve as the common ground or interface between design-time user interface modeling tools and a plurality of user interface runtime frameworks. It provides a self-contained, closed, and deterministic definition of all aspects of a graphical user interface in a device-independent and programming-language independent manner. Accordingly, abstract representation 506 generated for a model representation 502 is generally declarative and executable in that it provides a representation of the GUI of model representation 502 that is not dependent on any device or runtime platform, is not dependent on any programming language, and unambiguously encapsulates execution semantics for the GUI. The execution semantics may include, for example, identification of various components of the GUI, interpretation of connections between the various GUI components, information identifying the order of sequencing of events, rules governing dynamic behavior of the GUI, rules governing handling of values by the GUI, and the like. The abstract representation 506 is also not GUI runtime-platform specific. The abstract representation 506 provides a self-contained, closed, and deterministic definition of all aspects of a graphical user interface that is device independent and language independent.

Abstract representation 506 is such that the appearance and execution semantics of a GUI generated from the XGL representation work consistently on different target devices irrespective of the GUI capabilities of the target device and the target device platform. For example, the same XGL representation may be mapped to appropriate GUIs on devices of differing levels of GUI complexity (i.e., the same abstract representation may be used to generate a GUI for devices that support simple GUIs and for devices that can support complex GUIs), the GUI generated by the devices are consistent with each other in their appearance and behavior.

Abstract representation generator 504 may be configured to generate abstract representation 506 for models of different types, which may be created using different modeling tools 340. It will be understood that modeling environment 516 may include some, none, or other sub-modules or components as those shown in this example illustration. In other words, modeling environment 516 encompasses the design-time environment (with or without the abstract generator or the various representations), a modeling toolkit (such as 340) linked with a developer's space, or any other appropriate software operable to decouple models created during design-time from the runtime environment. Abstract representation 506 provides an interface between the design time environment and the runtime environment. As shown, this abstract representation 506 may then be used by runtime processing.

As part of runtime processing, modeling environment 516 may include various runtime tools 508 and may generate different types of runtime representations based upon the abstract representation 506. Examples of runtime representations include device or language-dependent (or specific) source code, runtime platform-specific machine-readable code, GUIs for a particular target device, and the like. The runtime tools 508 may include compilers, interpreters, source code generators, and other such tools that are configured to generate runtime platform-specific or target device-specific runtime representations of abstract representation 506. The runtime tool 508 may generate the runtime representation from abstract representation 506 using specific rules that map abstract representation 506 to a particular type of runtime representation. These mapping rules may be dependent on the type of runtime tool, characteristics of the target device to be used for displaying the GUI, runtime platform, and/or other factors. Accordingly, mapping rules may be provided for transforming the abstract representation 506 to any number of target runtime representations directed to one or more target GUI runtime platforms. For example, XGL-compliant code generators may conform to semantics of XGL, as described below. XGL-compliant code generators may ensure that the appearance and behavior of the generated user interfaces is preserved across a plurality of target GUI frameworks, while accommodating the differences in the intrinsic characteristics of each and also accommodating the different levels of capability of target devices.

For example, as depicted in example FIG. 5A, an XGL-to-Java compiler 508A may take abstract representation 506 as input and generate Java code 510 for execution by a target device comprising a Java runtime 512. Java runtime 512 may execute Java code 510 to generate or display a GUI 514 on a Java-platform target device. As another example, an XGL-to-Flash compiler 508B may take abstract representation 506 as input and generate Flash code 526 for execution by a target device comprising a Flash runtime 518. Flash runtime 518 may execute Flash code 516 to generate or display a GUI 520 on a target device comprising a Flash platform. As another example, an XGL-to-DHTML (dynamic HTML) interpreter 508C may take abstract representation 506 as input and generate DHTML statements (instructions) on the fly which are then interpreted by a DHTML runtime 522 to generate or display a GUI 524 on a target device comprising a DHTML platform.

It should be apparent that abstract representation 506 may be used to generate GUIs for Extensible Application Markup Language (XAML) or various other runtime platforms and devices. The same abstract representation 506 may be mapped to various runtime representations and device-specific and runtime platform-specific GUIs. In general, in the runtime environment, machine executable instructions specific to a runtime environment may be generated based upon the abstract representation 506 and executed to generate a GUI in the runtime environment. The same XGL representation may be used to generate machine executable instructions specific to different runtime environments and target devices.

According to certain embodiments, the process of mapping a model representation 502 to an abstract representation 506 and mapping an abstract representation 506 to some runtime representation may be automated. For example, design tools may automatically generate an abstract representation for the model representation using XGL and then use the XGL abstract representation to generate GUIs that are customized for specific runtime environments and devices. As previously indicated, mapping rules may be provided for mapping model representations to an XGL representation. Mapping rules may also be provided for mapping an XGL representation to a runtime platform-specific representation.

Since the runtime environment uses abstract representation 506 rather than model representation 502 for runtime processing, the model representation 502 that is created during design-time is decoupled from the runtime environment. Abstract representation 506 thus provides an interface between the modeling environment and the runtime environment. As a result, changes may be made to the design time environment, including changes to model representation 502 or changes that affect model representation 502, generally to not substantially affect or impact the runtime environment or tools used by the runtime environment. Likewise, changes may be made to the runtime environment generally to not substantially affect or impact the design time environment. A designer or other developer can thus concentrate on the design aspects and make changes to the design without having to worry about the runtime dependencies such as the target device platform or programming language dependencies.

FIG. 5B depicts an example process for mapping a model representation 502 to a runtime representation using the example modeling environment 516 of FIG. 5A or some other modeling environment. Model representation 502 may comprise one or more model components and associated properties that describe a data object, such as hosted business objects and interfaces. As described above, at least one of these model components is based on or otherwise associated with these hosted business objects and interfaces. The abstract representation 506 is generated based upon model representation 502. Abstract representation 506 may be generated by the abstract representation generator 504. Abstract representation 506 comprises one or more abstract GUI components and properties associated with the abstract GUI components. As part of generation of abstract representation 506, the model GUI components and their associated properties from the model representation are mapped to abstract GUI components and properties associated with the abstract GUI components. Various mapping rules may be provided to facilitate the mapping. The abstract representation encapsulates both appearance and behavior of a GUI. Therefore, by mapping model components to abstract components, the abstract representation not only specifies the visual appearance of the GUI but also the behavior of the GUI, such as in response to events whether clicking/dragging or scrolling, interactions between GUI components and such.

One or more runtime representations 550a, including GUIs for specific runtime environment platforms, may be generated from abstract representation 506. A device-dependent runtime representation may be generated for a particular type of target device platform to be used for executing and displaying the GUI encapsulated by the abstract representation. The GUIs generated from abstract representation 506 may comprise various types of GUI elements such as buttons, windows, scrollbars, input boxes, etc. Rules may be provided for mapping an abstract representation to a particular runtime representation. Various mapping rules may be provided for different runtime environment platforms.

Methods and systems consistent with the subject matter described herein provide and use interfaces 320 derived from the business object model 318 suitable for use with more than one business area, for example different departments within a company such as finance, or marketing. Also, they are suitable across industries and across businesses. Interfaces 320 are used during an end-to-end business transaction to transfer business process information in an application-independent manner. For example the interfaces can be used for fulfilling a sales order.

1. Message Overview

To perform an end-to-end business transaction, consistent interfaces are used to create business documents that are sent within messages between heterogeneous programs or modules.

a) Message Categories

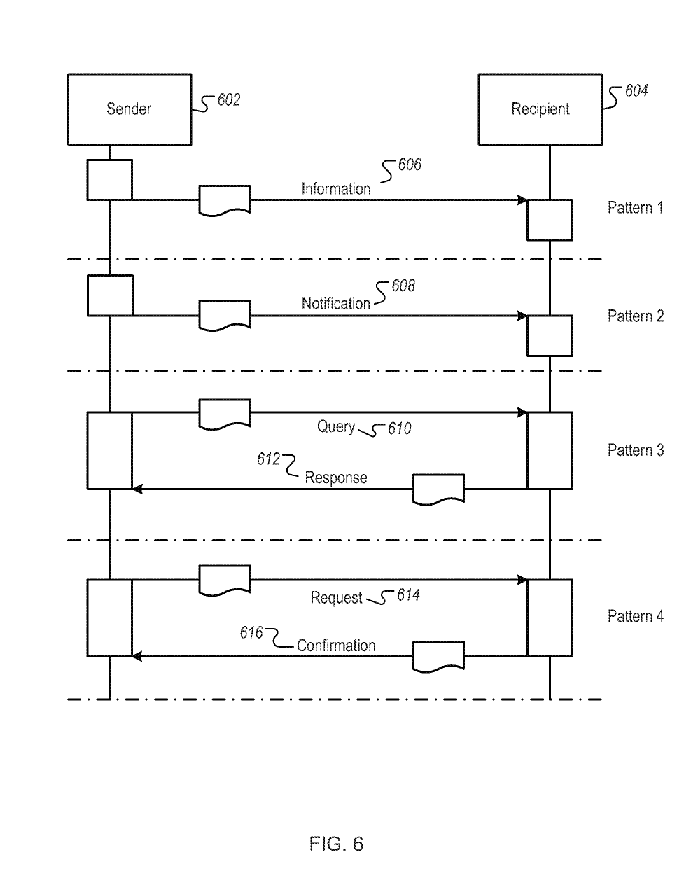

As depicted in FIG. 6, the communication between a sender 602 and a recipient 604 can be broken down into basic categories that describe the type of the information exchanged and simultaneously suggest the anticipated reaction of the recipient 604. A message category is a general business classification for the messages. Communication is sender-driven. In other words, the meaning of the message categories is established or formulated from the perspective of the sender 602. The message categories include information 606, notification 608, query 610, response 612, request 614, and confirmation 616.

(1) Information

Information 606 is a message sent from a sender 602 to a recipient 604 concerning a condition or a statement of affairs. No reply to information is expected. Information 606 is sent to make business partners or business applications aware of a situation. Information 606 is not compiled to be application-specific. Examples of “information” are an announcement, advertising, a report, planning information, and a message to the business warehouse.

(2) Notification

A notification 608 is a notice or message that is geared to a service. A sender 602 sends the notification 608 to a recipient 604. No reply is expected for a notification. For example, a billing notification relates to the preparation of an invoice while a dispatched delivery notification relates to preparation for receipt of goods.

(3) Query

A query 610 is a question from a sender 602 to a recipient 604 to which a response 612 is expected. A query 610 implies no assurance or obligation on the part of the sender 602. Examples of a query 610 are whether space is available on a specific flight or whether a specific product is available. These queries do not express the desire for reserving the flight or purchasing the product.

(4) Response

A response 612 is a reply to a query 610. The recipient 604 sends the response 612 to the sender 602. A response 612 generally implies no assurance or obligation on the part of the recipient 604. The sender 602 is not expected to reply. Instead, the process is concluded with the response 612. Depending on the business scenario, a response 612 also may include a commitment, i.e., an assurance or obligation on the part of the recipient 604. Examples of responses 612 are a response stating that space is available on a specific flight or that a specific product is available. With these responses, no reservation was made.

(5) Request

A request 614 is a binding requisition or requirement from a sender 602 to a recipient 604. Depending on the business scenario, the recipient 604 can respond to a request 614 with a confirmation 616. The request 614 is binding on the sender 602. In making the request 614, the sender 602 assumes, for example, an obligation to accept the services rendered in the request 614 under the reported conditions. Examples of a request 614 are a parking ticket, a purchase order, an order for delivery and a job application.

(6) Confirmation

A confirmation 616 is a binding reply that is generally made to a request 614. The recipient 604 sends the confirmation 616 to the sender 602. The information indicated in a confirmation 616, such as deadlines, products, quantities and prices, can deviate from the information of the preceding request 614. A request 614 and confirmation 616 may be used in negotiating processes. A negotiating process can consist of a series of several request 614 and confirmation 616 messages. The confirmation 616 is binding on the recipient 604. For example, 100 units of X may be ordered in a purchase order request; however, only the delivery of 80 units is confirmed in the associated purchase order confirmation.

b) Message Choreography

A message choreography is a template that specifies the sequence of messages between business entities during a given transaction. The sequence with the messages contained in it describes in general the message “lifecycle” as it proceeds between the business entities. If messages from a choreography are used in a business transaction, they appear in the transaction in the sequence determined by the choreography. This illustrates the template character of a choreography, i.e., during an actual transaction, it is not necessary for all messages of the choreography to appear. Those messages that are contained in the transaction, however, follow the sequence within the choreography. A business transaction is thus a derivation of a message choreography. The choreography makes it possible to determine the structure of the individual message types more precisely and distinguish them from one another.

2. Components of the Business Object Model

The overall structure of the business object model ensures the consistency of the interfaces that are derived from the business object model. The derivation ensures that the same business-related subject matter or concept is represented and structured in the same way in all interfaces.

The business object model defines the business-related concepts at a central location for a number of business transactions. In other words, it reflects the decisions made about modeling the business entities of the real world acting in business transactions across industries and business areas. The business object model is defined by the business objects and their relationship to each other (the overall net structure).

Each business object is generally a capsule with an internal hierarchical structure, behavior offered by its operations, and integrity constraints. Business objects are semantically disjoint, i.e., the same business information is represented once. In the business object model, the business objects are arranged in an ordering framework. From left to right, they are arranged according to their existence dependency to each other. For example, the customizing elements may be arranged on the left side of the business object model, the strategic elements may be arranged in the center of the business object model, and the operative elements may be arranged on the right side of the business object model. Similarly, the business objects are arranged from the top to the bottom based on defined order of the business areas, e.g., finance could be arranged at the top of the business object model with CRM below finance and SRM below CRM.

To ensure the consistency of interfaces, the business object model may be built using standardized data types as well as packages to group related elements together, and package templates and entity templates to specify the arrangement of packages and entities within the structure.

a) Data Types

Data types are used to type object entities and interfaces with a structure. This typing can include business semantic. Such data types may include those generally described at pages 96 through 1642 (which are incorporated by reference herein) of U.S. patent application Ser. No. 11/803,178, filed on May 11, 2007 and entitled “Consistent Set Of Interfaces Derived From A Business Object Model”. For example, the data type BusinessTransactionDocumentID is a unique identifier for a document in a business transaction. Also, as an example, Data type BusinessTransactionDocumentParty contains the information that is exchanged in business documents about a party involved in a business transaction, and includes the party's identity, the party's address, the party's contact person and the contact person's address. BusinessTransactionDocumentParty also includes the role of the party, e.g., a buyer, seller, product recipient, or vendor.

The data types are based on Core Component Types (“CCTs”), which themselves are based on the World Wide Web Consortium (“W3C”) data types. “Global” data types represent a business situation that is described by a fixed structure. Global data types include both context-neutral generic data types (“GDTs”) and context-based context data types (“CDTs”). GDTs contain business semantics, but are application-neutral, i.e., without context. CDTs, on the other hand, are based on GDTs and form either a use-specific view of the GDTs, or a context-specific assembly of GDTs or CDTs. A message is typically constructed with reference to a use and is thus a use-specific assembly of GDTs and CDTs. The data types can be aggregated to complex data types.

To achieve a harmonization across business objects and interfaces, the same subject matter is typed with the same data type. For example, the data type “GeoCoordinates” is built using the data type “Measure” so that the measures in a GeoCoordinate (i.e., the latitude measure and the longitude measure) are represented the same as other “Measures” that appear in the business object model.

b) Entities

Entities are discrete business elements that are used during a business transaction. Entities are not to be confused with business entities or the components that interact to perform a transaction. Rather, “entities” are one of the layers of the business object model and the interfaces. For example, a Catalogue entity is used in a Catalogue Publication Request and a Purchase Order is used in a Purchase Order Request. These entities are created using the data types defined above to ensure the consistent representation of data throughout the entities.

c) Packages

Packages group the entities in the business object model and the resulting interfaces into groups of semantically associated information. Packages also may include “sub”-packages, i.e., the packages may be nested.

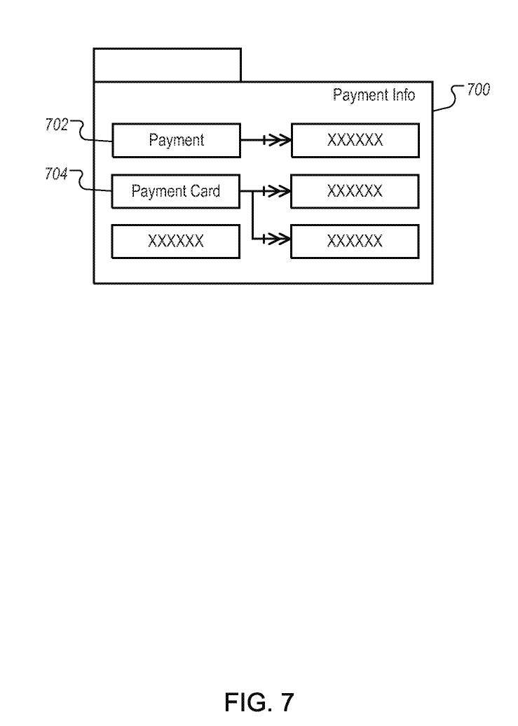

Packages may group elements together based on different factors, such as elements that occur together as a rule with regard to a business-related aspect. For example, as depicted in FIG. 7, in a Purchase Order, different information regarding the purchase order, such as the type of payment 702, and payment card 704, are grouped together via the PaymentInformation package 700.

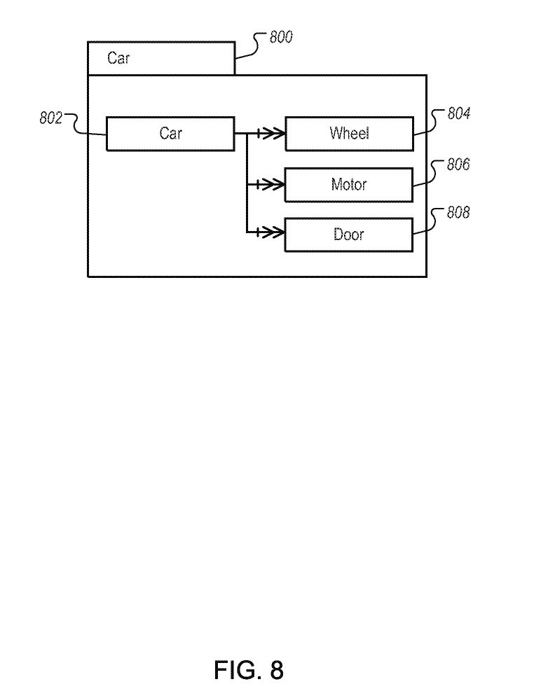

Packages also may combine different components that result in a new object. For example, as depicted in FIG. 8, the components wheels 804, motor 806, and doors 808 are combined to form a composition “Car” 802. The “Car” package 800 includes the wheels, motor and doors as well as the composition “Car.”

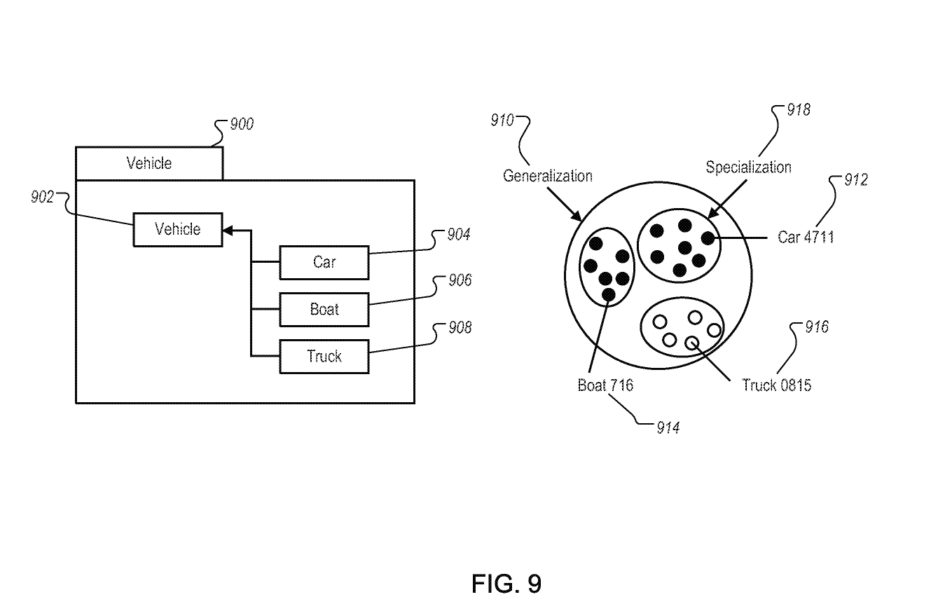

Another grouping within a package may be subtypes within a type. In these packages, the components are specialized forms of a generic package. For example, as depicted in FIG. 9, the components Car 904, Boat 906, and Truck 908 can be generalized by the generic term Vehicle 902 in Vehicle package 900. Vehicle in this case is the generic package 910, while Car 912, Boat 914, and Truck 916 are the specializations 918 of the generalized vehicle 910.

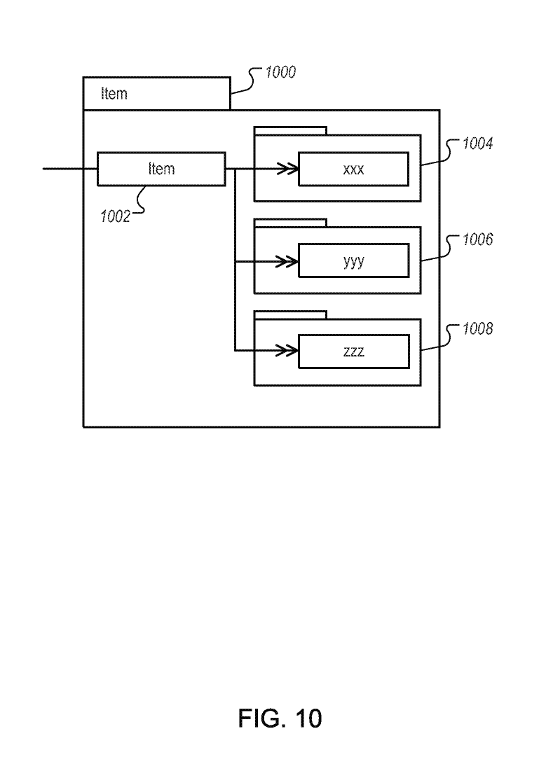

Packages also may be used to represent hierarchy levels. For example, as depicted in FIG. 10, the Item Package 1000 includes Item 1002 with subitem xxx 1004, subitem yyy 1006, and subitem zzz 1008.

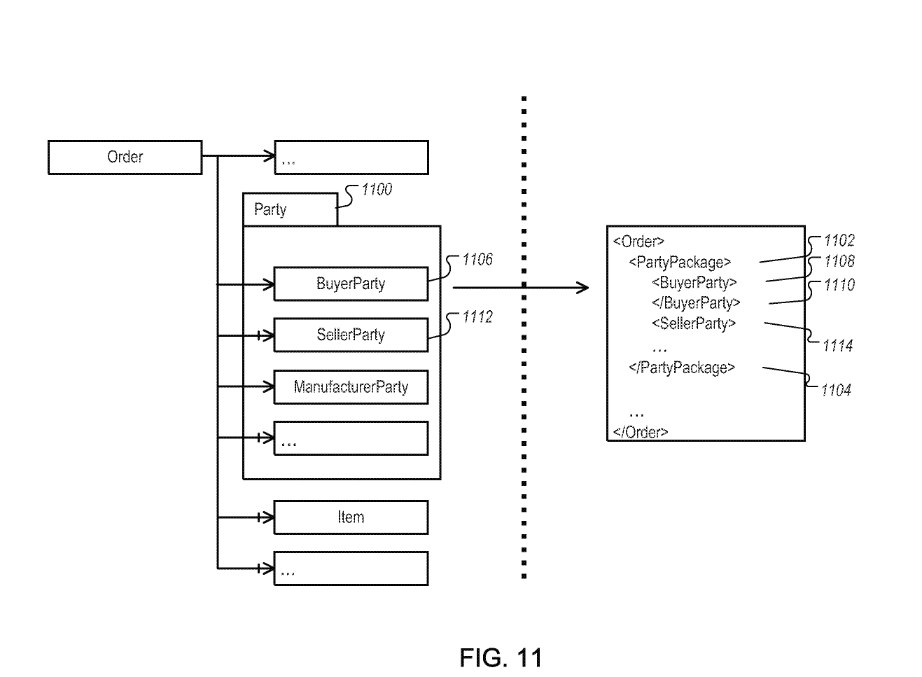

Packages can be represented in the XML schema as a comment. One advantage of this grouping is that the document structure is easier to read and is more understandable. The names of these packages are assigned by including the object name in brackets with the suffix “Package.” For example, as depicted in FIG. 11, Party package 1100 is enclosed by <PartyPackage> 1102 and </PartyPackage> 1104. Party package 1100 illustratively includes a Buyer Party 1106, identified by <BuyerParty> 1108 and </BuyerParty> 1110, and a Seller Party 1112, identified by <SellerParty> 1114 and </SellerParty>, etc.

d) Relationships

Relationships describe the interdependencies of the entities in the business object model, and are thus an integral part of the business object model.

(1) Cardinality of Relationships

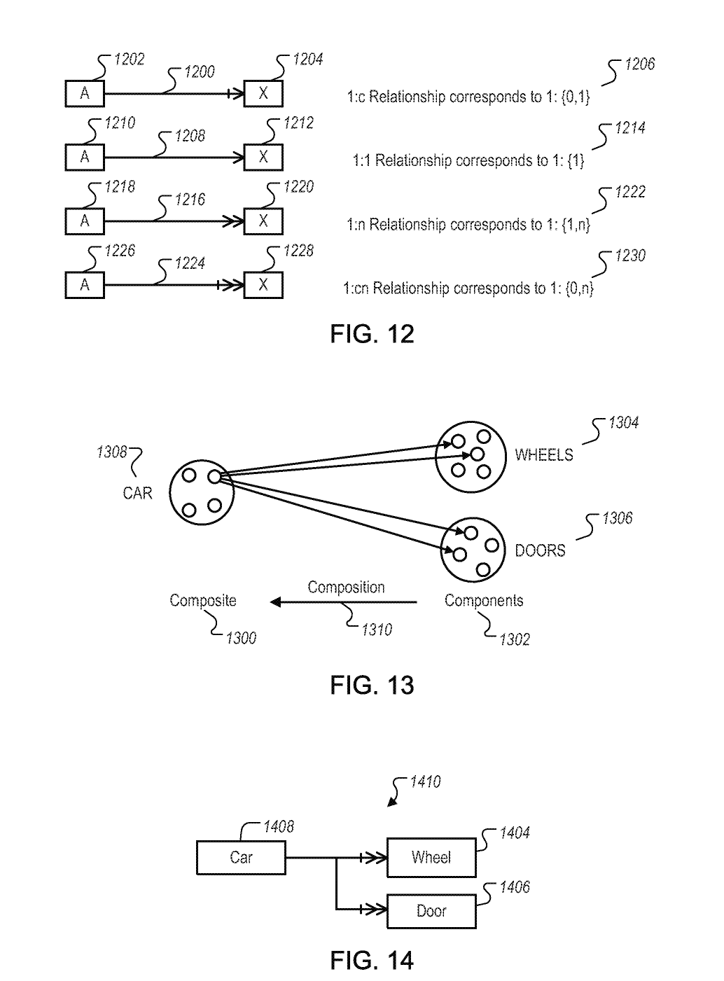

FIG. 12 depicts a graphical representation of the cardinalities between two entities. The cardinality between a first entity and a second entity identifies the number of second entities that could possibly exist for each first entity. Thus, a 1:c cardinality 1200 between entities A 1202 and X 1204 indicates that for each entity A 1202, there is either one or zero 1206 entity X 1204. A 1:1 cardinality 1208 between entities A 1210 and X 1212 indicates that for each entity A 1210, there is exactly one 1214 entity X 1212. A 1:n cardinality 1216 between entities A 1218 and X 1220 indicates that for each entity A 1218, there are one or more 1222 entity Xs 1220. A 1:cn cardinality 1224 between entities A 1226 and X 1228 indicates that for each entity A 1226, there are any number 1230 of entity Xs 1228 (i.e., 0 through n Xs for each A).

(2) Types of Relationships

(a) Composition

A composition or hierarchical relationship type is a strong whole-part relationship which is used to describe the structure within an object. The parts, or dependent entities, represent a semantic refinement or partition of the whole, or less dependent entity. For example, as depicted in FIG. 13, the components 1302, wheels 1304, and doors 1306 may be combined to form the composite 1300 “Car” 1308 using the composition 1310. FIG. 14 depicts a graphical representation of the composition 1410 between composite Car 1408 and components wheel 1404 and door 1406.

(b) Aggregation

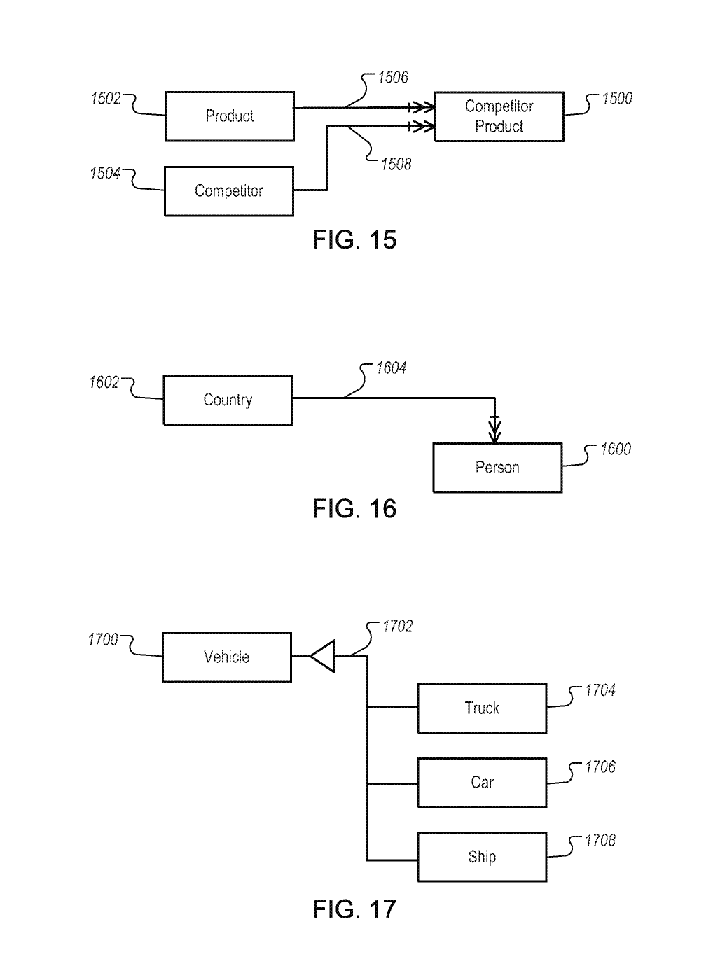

An aggregation or an aggregating relationship type is a weak whole-part relationship between two objects. The dependent object is created by the combination of one or several less dependent objects. For example, as depicted in FIG. 15, the properties of a competitor product 1500 are determined by a product 1502 and a competitor 1504. A hierarchical relationship 1506 exists between the product 1502 and the competitor product 1500 because the competitor product 1500 is a component of the product 1502. Therefore, the values of the attributes of the competitor product 1500 are determined by the product 1502. An aggregating relationship 1508 exists between the competitor 1504 and the competitor product 1500 because the competitor product 1500 is differentiated by the competitor 1504. Therefore the values of the attributes of the competitor product 1500 are determined by the competitor 1504.

(c) Association

An association or a referential relationship type describes a relationship between two objects in which the dependent object refers to the less dependent object. For example, as depicted in FIG. 16, a person 1600 has a nationality, and thus, has a reference to its country 1602 of origin. There is an association 1604 between the country 1602 and the person 1600. The values of the attributes of the person 1600 are not determined by the country 1602.

(3) Specialization

Entity types may be divided into subtypes based on characteristics of the entity types. For example, FIG. 17 depicts an entity type “vehicle” 1700 specialized 1702 into subtypes “truck” 1704, “car” 1706, and “ship” 1708. These subtypes represent different aspects or the diversity of the entity type.

Subtypes may be defined based on related attributes. For example, although ships and cars are both vehicles, ships have an attribute, “draft,” that is not found in cars. Subtypes also may be defined based on certain methods that can be applied to entities of this subtype and that modify such entities. For example, “drop anchor” can be applied to ships. If outgoing relationships to a specific object are restricted to a subset, then a subtype can be defined which reflects this subset.

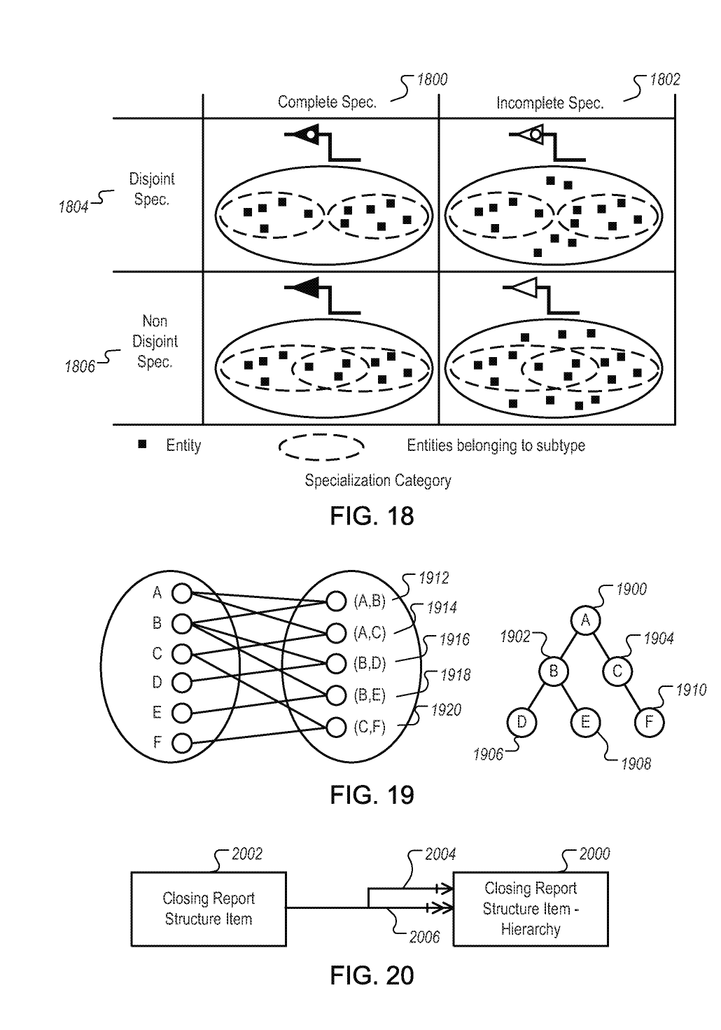

As depicted in FIG. 18, specializations may further be characterized as complete specializations 1800 or incomplete specializations 1802. There is a complete specialization 1800 where each entity of the generalized type belongs to at least one subtype. With an incomplete specialization 1802, there is at least one entity that does not belong to a subtype. Specializations also may be disjoint 1804 or nondisjoint 1806. In a disjoint specialization 1804, each entity of the generalized type belongs to a maximum of one subtype. With a nondisjoint specialization 1806, one entity may belong to more than one subtype. As depicted in FIG. 18, four specialization categories result from the combination of the specialization characteristics.

e) Structural Patterns

(1) Item

An item is an entity type which groups together features of another entity type. Thus, the features for the entity type chart of accounts are grouped together to form the entity type chart of accounts item. For example, a chart of accounts item is a category of values or value flows that can be recorded or represented in amounts of money in accounting, while a chart of accounts is a superordinate list of categories of values or value flows that is defined in accounting.

The cardinality between an entity type and its item is often either 1:n or 1:cn. For example, in the case of the entity type chart of accounts, there is a hierarchical relationship of the cardinality 1:n with the entity type chart of accounts item since a chart of accounts has at least one item in all cases.

(2) Hierarchy

A hierarchy describes the assignment of subordinate entities to superordinate entities and vice versa, where several entities of the same type are subordinate entities that have, at most, one directly superordinate entity. For example, in the hierarchy depicted in FIG. 19, entity B 1902 is subordinate to entity A 1900, resulting in the relationship (A,B) 1912. Similarly, entity C 1904 is subordinate to entity A 1900, resulting in the relationship (A,C) 1914. Entity D 1906 and entity E 1908 are subordinate to entity B 1902, resulting in the relationships (B,D) 1916 and (B,E) 1918, respectively. Entity F 1910 is subordinate to entity C 1904, resulting in the relationship (C,F) 1920.

Because each entity has at most one superordinate entity, the cardinality between a subordinate entity and its superordinate entity is 1:c. Similarly, each entity may have 0, 1 or many subordinate entities. Thus, the cardinality between a superordinate entity and its subordinate entity is 1:cn. FIG. 20 depicts a graphical representation of a Closing Report Structure Item hierarchy 2000 for a Closing Report Structure Item 2002. The hierarchy illustrates the 1:c cardinality 2004 between a subordinate entity and its superordinate entity, and the 1:cn cardinality 2006 between a superordinate entity and its subordinate entity.

3. Creation of the Business Object Model

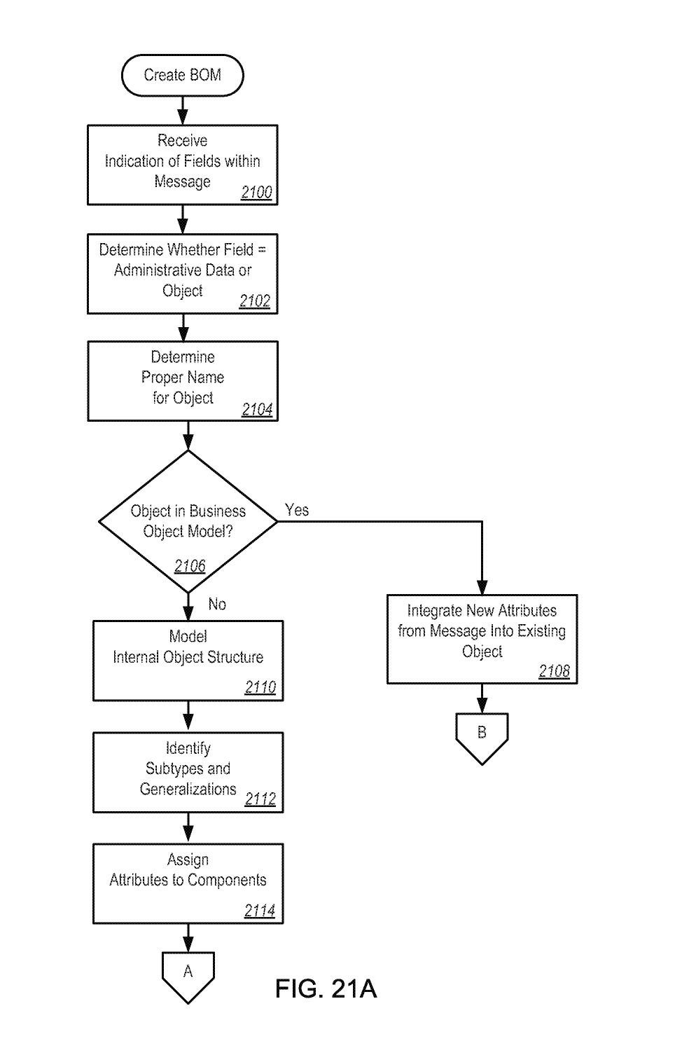

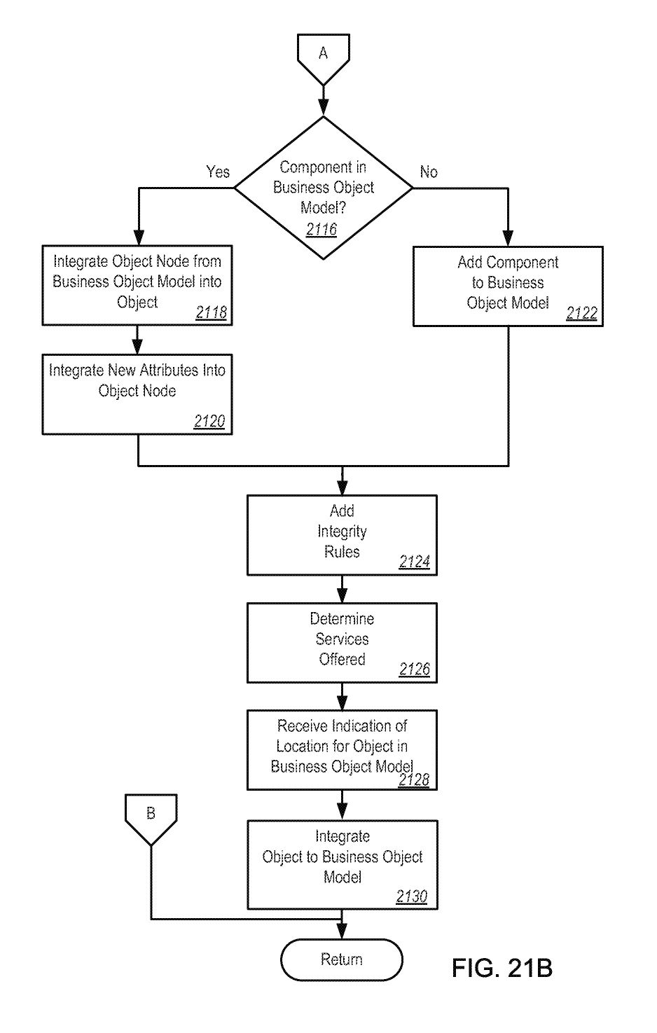

FIGS. 21A-B depict the steps performed using methods and systems consistent with the subject matter described herein to create a business object model. Although some steps are described as being performed by a computer, these steps may alternatively be performed manually, or computer-assisted, or any combination thereof. Likewise, although some steps are described as being performed by a computer, these steps may also be computer-assisted, or performed manually, or any combination thereof.

As discussed above, the designers create message choreographies that specify the sequence of messages between business entities during a transaction. After identifying the messages, the developers identify the fields contained in one of the messages (step 2100, FIG. 21A). The designers then determine whether each field relates to administrative data or is part of the object (step 2102). Thus, the first eleven fields identified below in the left column are related to administrative data, while the remaining fields are part of the object.

| | |
|---|---|
| MessageID | Admin |
| ReferenceID | |
| CreationDate | |
| SenderID | |
| AdditionalSenderID | |
| ContactPersonID | |
| SenderAddress | |
| RecipientID | |
| AdditionalRecipientID | |
| ContactPersonID | |
| RecipientAddress | |
| ID | Main Object |
| AdditionalID | |
| PostingDate | |
| LastChangeDate | |
| AcceptanceStatus | |
| Note | |
| CompleteTransmission Indicator | |
| Buyer | |
| BuyerOrganisationName | |
| Person Name | |
| FunctionalTitle | |
| DepartmentName | |
| CountryCode | |
| StreetPostalCode | |
| POBox Postal Code | |
| Company Postal Code | |
| City Name | |
| DistrictName | |
| PO Box ID | |
| PO Box Indicator | |
| PO Box Country Code | |
| PO Box Region Code | |
| PO Box City Name | |
| Street Name | |
| House ID | |
| Building ID | |
| Floor ID | |
| Room ID | |
| Care Of Name | |
| AddressDescription | |
| Telefonnumber | |
| MobileNumber | |
| Facsimile | |
| Email | |
| Seller | |
| SellerAddress | |
| Location | |
| LocationType | |
| DeliveryItemGroupID | |
| DeliveryPriority | |
| DeliveryCondition | |
| TransferLocation | |
| NumberofPartialDelivery | |
| QuantityTolerance | |
| MaximumLeadTime | |
| TransportServiceLevel | |
| TranportCondition | |
| TransportDescription | |
| CashDiscountTerms | |
| PaymentForm | |
| PaymentCardID | |
| PaymentCardReferenceID | |
| SequenceID | |
| Holder | |
| ExpirationDate | |
| AttachmentID | |
| AttachmentFilename | |
| DescriptionofMessage | |
| ConfirmationDescriptionof Message | |
| FollowUpActivity | |
| ItemID | |
| ParentItemID | |
| HierarchyType | |
| ProductID | |
| ProductType | |
| ProductNote | |
| ProductCategoryID | |
| Amount | |
| BaseQuantity | |
| ConfirmedAmount | |
| ConfirmedBaseQuantity | |
| ItemBuyer | |
| ItemBuyerOrganisationName | |
| Person Name | |
| FunctionalTitle | |
| DepartmentName | |
| CountryCode | |
| StreetPostalCode | |
| POBox Postal Code | |
| Company Postal Code | |
| City Name | |
| DistrictName | |
| PO Box ID | |
| PO Box Indicator | |
| PO Box Country Code | |
| PO Box Region Code | |
| PO Box City Name | |
| Street Name | |
| House ID | |
| Building ID | |
| Floor ID | |
| Room ID | |
| Care Of Name | |
| AddressDescription | |
| Telefonnumber | |
| MobilNumber | |
| Facsimile | |
| Email | |
| ItemSeller | |
| ItemSellerAddress | |
| ItemLocation | |
| ItemLocationType | |
| ItemDeliveryItemGroupID | |
| ItemDeliveryPriority | |
| ItemDeliveryCondition | |
| ItemTransferLocation | |
| ItemNumberofPartialDelivery | |
| ItemQuantityTolerance | |
| ItemMaximumLeadTime | |
| ItemTransportServiceLevel | |
| ItemTranportCondition | |
| ItemTransportDescription | |
| ContractReference | |
| QuoteReference | |
| CatalogueReference | |
| ItemAttachmentID | |
| ItemAttachmentFilename | |
| ItemDescription | |
| ScheduleLineID | |
| DeliveryPeriod | |
| Quantity | |
| ConfirmedScheduleLineID | |
| ConfirmedDeliveryPeriod | |
| ConfirmedQuantity | |

Next, the designers determine the proper name for the object according to the ISO 11179 naming standards (step 2104). In the example above, the proper name for the “Main Object” is “Purchase Order.” After naming the object, the system that is creating the business object model determines whether the object already exists in the business object model (step 2106). If the object already exists, the system integrates new attributes from the message into the existing object (step 2108), and the process is complete.

If at step 2106 the system determines that the object does not exist in the business object model, the designers model the internal object structure (step 2110). To model the internal structure, the designers define the components. For the above example, the designers may define the components identified below.

| | | | |
|---|---|---|---|
| ID | Purchase | | |
| AdditionalID | Order | | |
| PostingDate | | | |
| LastChangeDate | | | |
| AcceptanceStatus | | | |
| Note | | | |
| CompleteTransmission | | | |
| Indicator | | | |
| Buyer | | Buyer | |
| BuyerOrganisationName | | | |
| Person Name | | | |
| FunctionalTitle | | | |
| DepartmentName | | | |
| CountryCode | | | |
| StreetPostalCode | | | |
| POBox Postal Code | | | |
| Company Postal Code | | | |
| City Name | | | |
| DistrictName | | | |
| PO Box ID | | | |
| PO Box Indicator | | | |
| PO Box Country Code | | | |
| PO Box Region Code | | | |
| PO Box City Name | | | |
| Street Name | | | |
| House ID | | | |
| Building ID | | | |
| Floor ID | | | |
| Room ID | | | |
| Care Of Name | | | |
| AddressDescription | | | |
| Telefonnumber | | | |
| MobileNumber | | | |
| Facsimile | | | |
| Email | | | |
| Seller | | Seller | |
| SellerAddress | | | |
| Location | | Location | |
| LocationType | | | |
| DeliveryItemGroupID | | Delivery- | |
| DeliveryPriority | | Terms | |
| DeliveryCondition | | | |
| TransferLocation | | | |
| NumberofPartialDelivery | | | |
| QuantityTolerance | | | |
| MaximumLeadTime | | | |
| TransportServiceLevel | | | |
| TranportCondition | | | |
| TransportDescription | | | |
| CashDiscountTerms | | | |
| PaymentForm | | Payment | |
| PaymentCardID | | | |
| PaymentCardReferenceID | | | |
| SequenceID | | | |
| Holder | | | |
| ExpirationDate | | | |
| AttachmentID | | | |
| AttachmentFilename | | | |
| DescriptionofMessage | | | |
| ConfirmationDescriptionof | | | |
| Message | | | |
| FollowUpActivity | | | |
| ItemID | | Purchase | |
| ParentItemID | | Order | |
| HierarchyType | | Item | |
| ProductID | | | Product |
| ProductType | | | |
| ProductNote | | | |
| ProductCategoryID | | | ProductCategory |
| Amount | | | |
| BaseQuantity | | | |
| ConfirmedAmount | | | |
| ConfirmedBaseQuantity | | | |
| ItemBuyer | | | Buyer |
| ItemBuyerOrganisation | | | |
| Name | | | |
| Person Name | | | |
| FunctionalTitle | | | |
| DepartmentName | | | |
| CountryCode | | | |
| StreetPostalCode | | | |
| POBox Postal Code | | | |
| Company Postal Code | | | |
| City Name | | | |
| DistrictName | | | |
| PO Box ID | | | |
| PO Box Indicator | | | |
| PO Box Country Code | | | |
| PO Box Region Code | | | |
| PO Box City Name | | | |
| Street Name | | | |
| House ID | | | |
| Building ID | | | |
| Floor ID | | | |
| Room ID | | | |
| Care Of Name | | | |
| AddressDescription | | | |
| Telefonnumber | | | |
| MobilNumber | | | |
| Facsimile | | | |
| Email | | | |
| ItemSeller | | | Seller |
| ItemSellerAddress | | | |
| ItemLocation | | | Location |
| ItemLocationType | | | |
| ItemDeliveryItemGroupID | | | |
| ItemDeliveryPriority | | | |
| ItemDeliveryCondition | | | |
| ItemTransferLocation | | | |
| ItemNumberofPartial | | | |
| Delivery | | | |
| ItemQuantityTolerance | | | |
| ItemMaximumLeadTime | | | |
| ItemTransportServiceLevel | | | |
| ItemTranportCondition | | | |
| ItemTransportDescription | | | |
| ContractReference | | | Contract |
| QuoteReference | | | Quote |
| CatalogueReference | | | Catalogue |
| ItemAttachmentID | | | |
| ItemAttachmentFilename | | | |
| ItemDescription | | | |
| ScheduleLineID | | | |
| DeliveryPeriod | | | |
| Quantity | | | |
| ConfirmedScheduleLineID | | | |
| ConfirmedDeliveryPeriod | | | |
| ConfirmedQuantity | | | |

During the step of modeling the internal structure, the designers also model the complete internal structure by identifying the compositions of the components and the corresponding cardinalities, as shown below.

| | | | | |
|---|---|---|---|---|
| PurchaseOrder | | | | 1 |
| | Buyer | | | 0 . . . 1 |
| | | Address | | 0 . . . 1 |
| | | ContactPerson | | 0 . . . 1 |
| | | | Address | 0 . . . 1 |
| | Seller | | | 0 . . . 1 |
| | Location | | | 0 . . . 1 |
| | | Address | | 0 . . . 1 |
| | DeliveryTerms | | | 0 . . . 1 |
| | | Incoterms | | 0 . . . 1 |
| | | PartialDelivery | | 0 . . . 1 |
| | | QuantityTolerance | | 0 . . . 1 |
| | | Transport | | 0 . . . 1 |
| | CashDiscount | | | 0 . . . 1 |
| | Terms | | | |
| | | MaximumCashDiscount | | 0 . . . 1 |
| | | NormalCashDiscount | | 0 . . . 1 |
| | PaymentForm | | | 0 . . . 1 |
| | | PaymentCard | | 0 . . . 1 |
| | Attachment | | | 0 . . . n |
| | Description | | | 0 . . . 1 |
| | Confirmation | | | 0 . . . 1 |
| | Description | | | |
| | Item | | | 0 . . . n |
| | | HierarchyRelationship | | 0 . . . 1 |
| | | Product | | 0 . . . 1 |
| | | ProductCategory | | 0 . . . 1 |
| | | Price | | 0 . . . 1 |
| | | | NetunitPrice | 0 . . . 1 |
| | | ConfirmedPrice | | 0 . . . 1 |
| | | | NetunitPrice | 0 . . . 1 |
| | | Buyer | | 0 . . . 1 |
| | | Seller | | 0 . . . 1 |
| | | Location | | 0 . . . 1 |
| | | DeliveryTerms | | 0 . . . 1 |
| | | Attachment | | 0 . . . n |
| | | Description | | 0 . . . 1 |
| | | ConfirmationDescription | | 0 . . . 1 |
| | | ScheduleLine | | 0 . . . n |
| | | | DeliveryPeriod | 1 |
| | | ConfirmedScheduleLine | | 0 . . . n |

After modeling the internal object structure, the developers identify the subtypes and generalizations for all objects and components (step 2112). For example, the Purchase Order may have subtypes Purchase Order Update, Purchase Order Cancellation and Purchase Order Information. Purchase Order Update may include Purchase Order Request, Purchase Order Change, and Purchase Order Confirmation. Moreover, Party may be identified as the generalization of Buyer and Seller. The subtypes and generalizations for the above example are shown below.

| | | | | | |
|---|---|---|---|---|---|
| Purchase | | | | | 1 |
| Order | | | | | |
| | PurchaseOrder | | | | |
| | Update | | | | |
| | | PurchaseOrder Request | | | |
| | | PurchaseOrder Change | | | |
| | | PurchaseOrder | | | |
| | | Confirmation | | | |
| | PurchaseOrder | | | | |
| | Cancellation | | | | |
| | PurchaseOrder | | | | |
| | Information | | | | |
| | Party | | | | |
| | | BuyerParty | | | 0 . . . 1 |
| | | | Address | | 0 . . . 1 |
| | | | ContactPerson | | 0 . . . 1 |
| | | | | Address | 0 . . . 1 |
| | | SellerParty | | | 0 . . . 1 |
| | Location | | | | |
| | | ShipToLocation | | | 0 . . . 1 |
| | | | Address | | 0 . . . 1 |
| | | ShipFromLocation | | | 0 . . . 1 |
| | | | Address | | 0 . . . 1 |
| | DeliveryTerms | | | | 0 . . . 1 |
| | | Incoterms | | | 0 . . . 1 |
| | | PartialDelivery | | | 0 . . . 1 |
| | | QuantityTolerance | | | 0 . . . 1 |
| | | Transport | | | 0 . . . 1 |
| | CashDiscount | | | | 0 . . . 1 |
| | Terms | | | | |
| | | MaximumCash Discount | | | 0 . . . 1 |
| | | NormalCashDiscount | | | 0 . . . 1 |
| | PaymentForm | | | | 0 . . . 1 |
| | | PaymentCard | | | 0 . . . 1 |
| | Attachment | | | | 0 . . . n |
| | Description | | | | 0 . . . 1 |
| | Confirmation | | | | 0 . . . 1 |
| | Description | | | | |
| | Item | | | | 0 . . . n |
| | | HierarchyRelationship | | | 0 . . . 1 |
| | | Product | | | 0 . . . 1 |
| | | ProductCategory | | | 0 . . . 1 |
| | | Price | | | 0 . . . 1 |
| | | | NetunitPrice | | 0 . . . 1 |
| | | ConfirmedPrice | | | 0 . . . 1 |
| | | | NetunitPrice | | 0 . . . 1 |
| | | Party | | | |
| | | | BuyerParty | | 0 . . . 1 |
| | | | SellerParty | | 0 . . . 1 |
| | | Location | | | |
| | | | ShipTo | | 0 . . . 1 |
| | | | Location | | |
| | | | ShipFrom | | 0 . . . 1 |
| | | | Location | | |
| | | DeliveryTerms | | | 0 . . . 1 |
| | | Attachment | | | 0 . . . n |
| | | Description | | | 0 . . . 1 |
| | | Confirmation | | | 0 . . . 1 |
| | | Description | | | |
| | | ScheduleLine | | | 0 . . . n |
| | | | Delivery | | 1 |
| | | | Period | | |
| | | ConfirmedScheduleLine | | | 0 . . . n |

After identifying the subtypes and generalizations, the developers assign the attributes to these components (step 2114). The attributes for a portion of the components are shown below.

| | | | | |
|---|---|---|---|---|
| Purchase- | | | | 1 |
| Order | | | | |
| | ID | | | 1 |
| | SellerID | | | 0 . . . 1 |
| | BuyerPosting- | | | 0 . . . 1 |
| | DateTime | | | |
| | BuyerLast- | | | 0 . . . 1 |
| | ChangeDate- | | | |
| | Time | | | |
| | SellerPosting- | | | 0 . . . 1 |
| | DateTime | | | |
| | SellerLast- | | | 0 . . . 1 |
| | ChangeDate- | | | |
| | Time | | | |
| | Acceptance- | | | 0 . . . 1 |
| | StatusCode | | | |
| | Note | | | 0 . . . 1 |
| | ItemList- | | | 0 . . . 1 |
| | Complete- | | | |
| | Transmission- | | | |
| | Indicator | | | |
| | BuyerParty | | | 0 . . . 1 |
| | | StandardID | | 0 . . . n |
| | | BuyerID | | 0 . . . 1 |
| | | SellerID | | 0 . . . 1 |
| | | Address | | 0 . . . 1 |
| | | ContactPerson | | 0 . . . 1 |
| | | | BuyerID | 0 . . . 1 |
| | | | SellerID | 0 . . . 1 |
| | | | Address | 0 . . . 1 |
| | SellerParty | | | 0 . . . 1 |
| | Product- | | | 0 . . . 1 |
| | RecipientParty | | | |
| | VendorParty | | | 0 . . . 1 |
| | Manufacturer- | | | 0 . . . 1 |
| | Party | | | |
| | BillToParty | | | 0 . . . 1 |
| | PayerParty | | | 0 . . . 1 |
| | CarrierParty | | | 0 . . . 1 |
| | ShipTo- | | | 0 . . . 1 |
| | Location | | | |
| | | StandardID | | 0 . . . n |
| | | BuyerID | | 0 . . . 1 |
| | | SellerID | | 0 . . . 1 |
| | | Address | | 0 . . . 1 |
| | ShipFrom- | | | 0 . . . 1 |
| | Location | | | |

The system then determines whether the component is one of the object nodes in the business object model (step 2116, FIG. 21B). If the system determines that the component is one of the object nodes in the business object model, the system integrates a reference to the corresponding object node from the business object model into the object (step 2118). In the above example, the system integrates the reference to the Buyer party represented by an ID and the reference to the ShipToLocation represented by an into the object, as shown below. The attributes that were formerly located in the PurchaseOrder object are now assigned to the new found object party. Thus, the attributes are removed from the PurchaseOrder object.

| | | |
|---|---|---|
| PurchaseOrder | | |
| | ID | |
| | SellerID | |
| | BuyerPostingDateTime | |
| | BuyerLastChangeDateTime | |
| | SellerPostingDateTime | |
| | SellerLastChangeDateTime | |
| | AcceptanceStatusCode | |
| | Note | |
| | ItemListComplete | |
| | TransmissionIndicator | |
| | BuyerParty | |
| | | ID |
| | SellerParty | |
| | ProductRecipientParty | |
| | VendorParty | |
| | ManufacturerParty | |
| | BillToParty | |
| | PayerParty | |
| | CarrierParty | |
| | ShipToLocation | |
| | | ID |
| | ShipFromLocation | |

During the integration step, the designers classify the relationship (i.e., aggregation or association) between the object node and the object being integrated into the business object model. The system also integrates the new attributes into the object node (step 2120). If at step 2116, the system determines that the component is not in the business object model, the system adds the component to the business object model (step 2122).

Regardless of whether the component was in the business object model at step 2116, the next step in creating the business object model is to add the integrity rules (step 2124). There are several levels of integrity rules and constraints which should be described. These levels include consistency rules between attributes, consistency rules between components, and consistency rules to other objects. Next, the designers determine the services offered, which can be accessed via interfaces (step 2126). The services offered in the example above include PurchaseOrderCreateRequest, PurchaseOrderCancellationRequest, and PurchaseOrderReleaseRequest. The system then receives an indication of the location for the object in the business object model (step 2128). After receiving the indication of the location, the system integrates the object into the business object model (step 2130).

4. Structure of the Business Object Model

The business object model, which serves as the basis for the process of generating consistent interfaces, includes the elements contained within the interfaces. These elements are arranged in a hierarchical structure within the business object model.

5. Interfaces Derived from Business Object Model

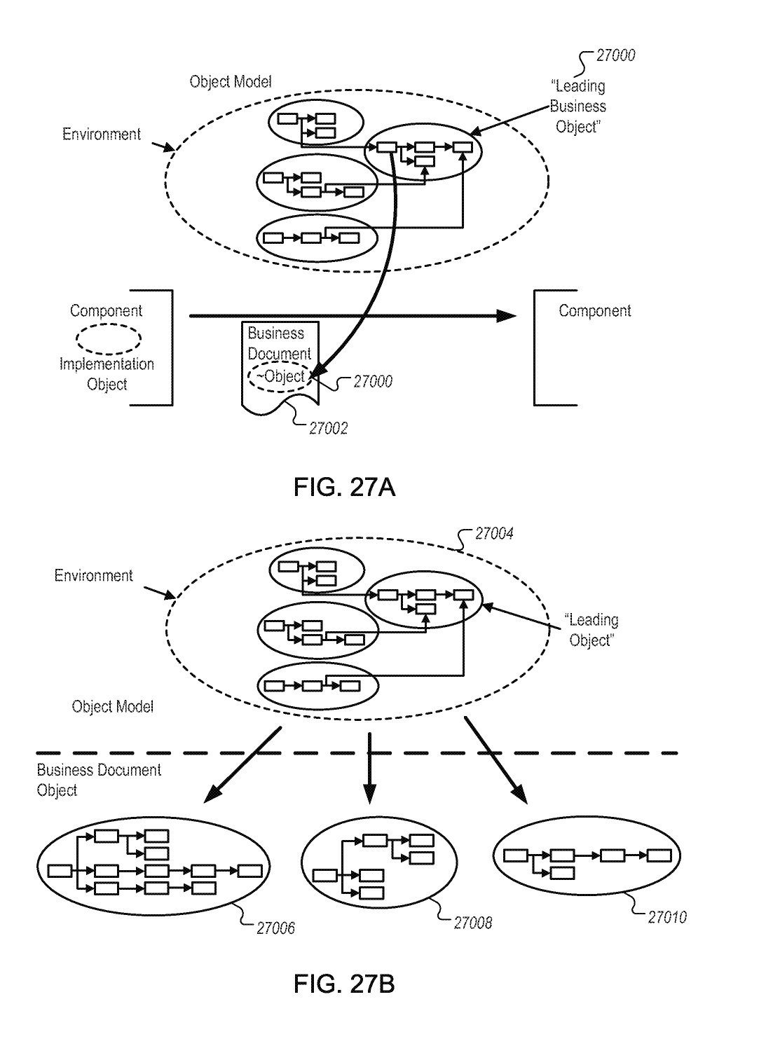

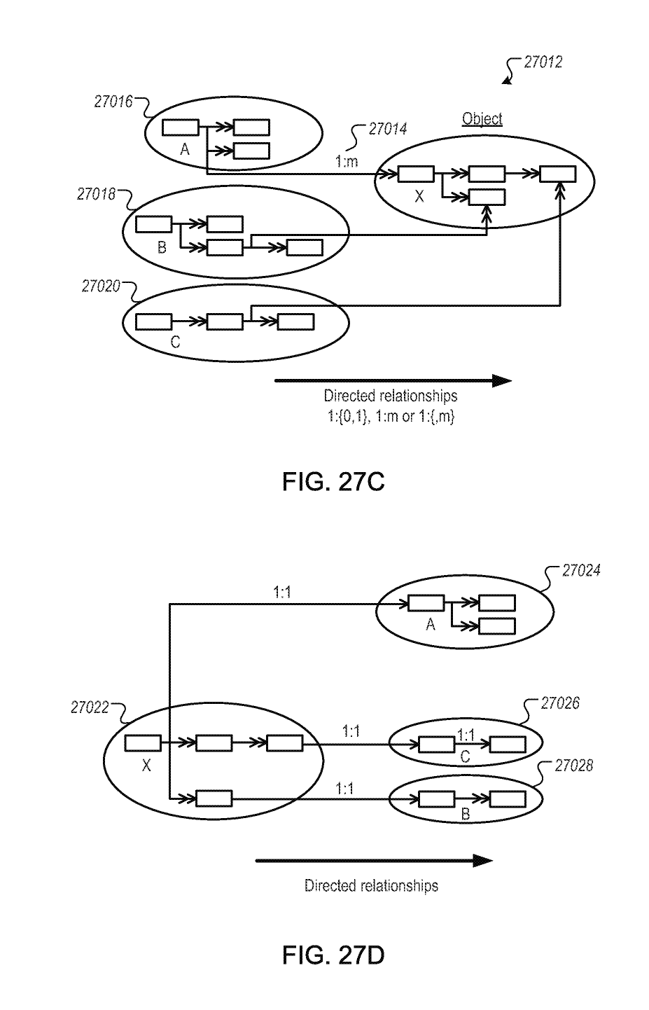

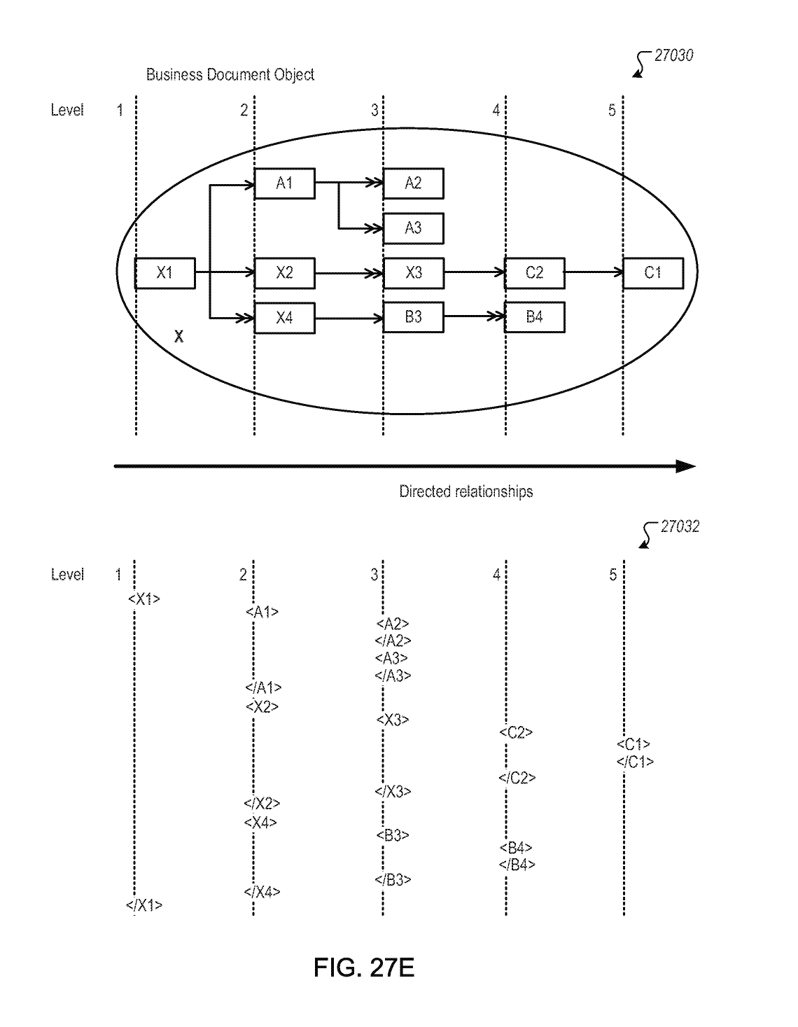

Interfaces are the starting point of the communication between two business entities. The structure of each interface determines how one business entity communicates with another business entity. The business entities may act as a unified whole when, based on the business scenario, the business entities know what an interface contains from a business perspective and how to fill the individual elements or fields of the interface. As illustrated in FIG. 27A, communication between components takes place via messages that contain business documents (e.g., business document 27002). The business document 27002 ensures a holistic business-related understanding for the recipient of the message. The business documents are created and accepted or consumed by interfaces, specifically by inbound and outbound interfaces. The interface structure and, hence, the structure of the business document are derived by a mapping rule. This mapping rule is known as “hierarchization.” An interface structure thus has a hierarchical structure created based on the leading business object 27000. The interface represents a usage-specific, hierarchical view of the underlying usage-neutral object model.

As illustrated in FIG. 27B, several business document objects 27006, 27008, and 27010 as overlapping views may be derived for a given leading object 27004. Each business document object results from the object model by hierarchization.

To illustrate the hierarchization process, FIG. 27C depicts an example of an object model 27012 (i.e., a portion of the business object model) that is used to derive a service operation signature (business document object structure). As depicted, leading object X 27014 in the object model 27012 is integrated in a net of object A 27016, object B 27018, and object C 27020. Initially, the parts of the leading object 27014 that are required for the business object document are adopted. In one variation, all parts required for a business document object are adopted from leading object 27014 (making such an operation a maximal service operation). Based on these parts, the relationships to the superordinate objects (i.e., objects A, B, and C from which object X depends) are inverted. In other words, these objects are adopted as dependent or subordinate objects in the new business document object.

For example, object A 27016, object B 27018, and object C 27020 have information that characterize object X. Because object A 27016, object B 27018, and object C 27020 are superordinate to leading object X 27014, the dependencies of these relationships change so that object A 27016, object B 27018, and object C 27020 become dependent and subordinate to leading object X 27014. This procedure is known as “derivation of the business document object by hierarchization.”

Business-related objects generally have an internal structure (parts). This structure can be complex and reflect the individual parts of an object and their mutual dependency. When creating the operation signature, the internal structure of an object is strictly hierarchized. Thus, dependent parts keep their dependency structure, and relationships between the parts within the object that do not represent the hierarchical structure are resolved by prioritizing one of the relationships.

Relationships of object X to external objects that are referenced and whose information characterizes object X are added to the operation signature. Such a structure can be quite complex (see, for example, FIG. 27D). The cardinality to these referenced objects is adopted as 1:1 or 1:C, respectively. By this, the direction of the dependency changes. The required parts of this referenced object are adopted identically, both in their cardinality and in their dependency arrangement.

The newly created business document object contains all required information, including the incorporated master data information of the referenced objects. As depicted in FIG. 27D, components Xi in leading object X 27022 are adopted directly. The relationship of object X 27022 to object A 27024, object B 27028, and object C 27026 are inverted, and the parts required by these objects are added as objects that depend from object X 27022. As depicted, all of object A 27024 is adopted. B3 and B4 are adopted from object B 27028, but B1 is not adopted. From object C 27026, C2 and C1 are adopted, but C3 is not adopted.

FIG. 27E depicts the business document object X 27030 created by this hierarchization process. As shown, the arrangement of the elements corresponds to their dependency levels, which directly leads to a corresponding representation as an XML structure 27032.

The following provides certain rules that can be adopted singly or in combination with regard to the hierarchization process. A business document object always refers to a leading business document object and is derived from this object. The name of the root entity in the business document entity is the name of the business object or the name of a specialization of the business object or the name of a service specific view onto the business object. The nodes and elements of the business object that are relevant (according to the semantics of the associated message type) are contained as entities and elements in the business document object.

The name of a business document entity is predefined by the name of the corresponding business object node. The name of the superordinate entity is not repeated in the name of the business document entity. The “full” semantic name results from the concatenation of the entity names along the hierarchical structure of the business document object.

The structure of the business document object is, except for deviations due to hierarchization, the same as the structure of the business object. The cardinalities of the business document object nodes and elements are adopted identically or more restrictively to the business document object. An object from which the leading business object is dependent can be adopted to the business document object. For this arrangement, the relationship is inverted, and the object (or its parts, respectively) are hierarchically subordinated in the business document object.

Nodes in the business object representing generalized business information can be adopted as explicit entities to the business document object (generally speaking, multiply TypeCodes out). When this adoption occurs, the entities are named according to their more specific semantic (name of TypeCode becomes prefix). Party nodes of the business object are modeled as explicit entities for each party role in the business document object. These nodes are given the name <Prefix><Party Role>Party, for example, BuyerParty, ItemBuyerParty. BTDReference nodes are modeled as separate entities for each reference type in the business document object. These nodes are given the name <Qualifier><BO><Node>Reference, for example SalesOrderReference, OriginSalesOrderReference, SalesOrderItemReference. A product node in the business object comprises all of the information on the Product, ProductCategory, and Batch. This information is modeled in the business document object as explicit entities for Product, ProductCategory, and Batch.

Entities which are connected by a 1:1 relationship as a result of hierarchization can be combined to a single entity, if they are semantically equivalent. Such a combination can often occurs if a node in the business document object that results from an assignment node is removed because it does not have any elements.

The message type structure is typed with data types. Elements are typed by GDTs according to their business objects. Aggregated levels are typed with message type specific data types (Intermediate Data Types), with their names being built according to the corresponding paths in the message type structure. The whole message type structured is typed by a message data type with its name being built according to the root entity with the suffix “Message”. For the message type, the message category (e.g., information, notification, query, response, request, confirmation, etc.) is specified according to the suited transaction communication pattern.

In one variation, the derivation by hierarchization can be initiated by specifying a leading business object and a desired view relevant for a selected service operation. This view determines the business document object. The leading business object can be the source object, the target object, or a third object. Thereafter, the parts of the business object required for the view are determined. The parts are connected to the root node via a valid path along the hierarchy. Thereafter, one or more independent objects (object parts, respectively) referenced by the leading object which are relevant for the service may be determined (provided that a relationship exists between the leading object and the one or more independent objects).

Once the selection is finalized, relevant nodes of the leading object node that are structurally identical to the message type structure can then be adopted. If nodes are adopted from independent objects or object parts, the relationships to such independent objects or object parts are inverted. Linearization can occur such that a business object node containing certain TypeCodes is represented in the message type structure by explicit entities (an entity for each value of the TypeCode). The structure can be reduced by checking all 1:1 cardinalities in the message type structure. Entities can be combined if they are semantically equivalent, one of the entities carries no elements, or an entity solely results from an n:m assignment in the business object.

After the hierarchization is completed, information regarding transmission of the business document object (e.g., CompleteTransmissionIndicator, ActionCodes, message category, etc.) can be added. A standardized message header can be added to the message type structure and the message structure can be typed. Additionally, the message category for the message type can be designated.

Invoice Request and Invoice Confirmation are examples of interfaces. These invoice interfaces are used to exchange invoices and invoice confirmations between an invoicing party and an invoice recipient (such as between a seller and a buyer) in a B2B process. Companies can create invoices in electronic as well as in paper form. Traditional methods of communication, such as mail or fax, for invoicing are cost intensive, prone to error, and relatively slow, since the data is recorded manually. Electronic communication eliminates such problems. The motivating business scenarios for the Invoice Request and Invoice Confirmation interfaces are the Procure to Stock (PTS) and Sell from Stock (SFS) scenarios. In the PTS scenario, the parties use invoice interfaces to purchase and settle goods. In the SFS scenario, the parties use invoice interfaces to sell and invoice goods. The invoice interfaces directly integrate the applications implementing them and also form the basis for mapping data to widely-used XML standard formats such as RosettaNet, PIDX, xCBL, and CIDX.

The invoicing party may use two different messages to map a B2B invoicing process: (1) the invoicing party sends the message type InvoiceRequest to the invoice recipient to start a new invoicing process; and (2) the invoice recipient sends the message type InvoiceConfirmation to the invoicing party to confirm or reject an entire invoice or to temporarily assign it the status “pending.”

An InvoiceRequest is a legally binding notification of claims or liabilities for delivered goods and rendered services—usually, a payment request for the particular goods and services. The message type InvoiceRequest is based on the message data type InvoiceMessage. The InvoiceRequest message (as defined) transfers invoices in the broader sense. This includes the specific invoice (request to settle a liability), the debit memo, and the credit memo.

InvoiceConfirmation is a response sent by the recipient to the invoicing party confirming or rejecting the entire invoice received or stating that it has been assigned temporarily the status “pending.” The message type InvoiceConfirmation is based on the message data type InvoiceMessage. An InvoiceConfirmation is not mandatory in a B2B invoicing process, however, it automates collaborative processes and dispute management.

Usually, the invoice is created after it has been confirmed that the goods were delivered or the service was provided. The invoicing party (such as the seller) starts the invoicing process by sending an InvoiceRequest message. Upon receiving the InvoiceRequest message, the invoice recipient (for instance, the buyer) can use the InvoiceConfirmation message to completely accept or reject the invoice received or to temporarily assign it the status “pending.” The InvoiceConfirmation is not a negotiation tool (as is the case in order management), since the options available are either to accept or reject the entire invoice. The invoice data in the InvoiceConfirmation message merely confirms that the invoice has been forwarded correctly and does not communicate any desired changes to the invoice. Therefore, the InvoiceConfirmation includes the precise invoice data that the invoice recipient received and checked. If the invoice recipient rejects an invoice, the invoicing party can send a new invoice after checking the reason for rejection (AcceptanceStatus and ConfirmationDescription at Invoice and InvoiceItem level). If the invoice recipient does not respond, the invoice is generally regarded as being accepted and the invoicing party can expect payment.

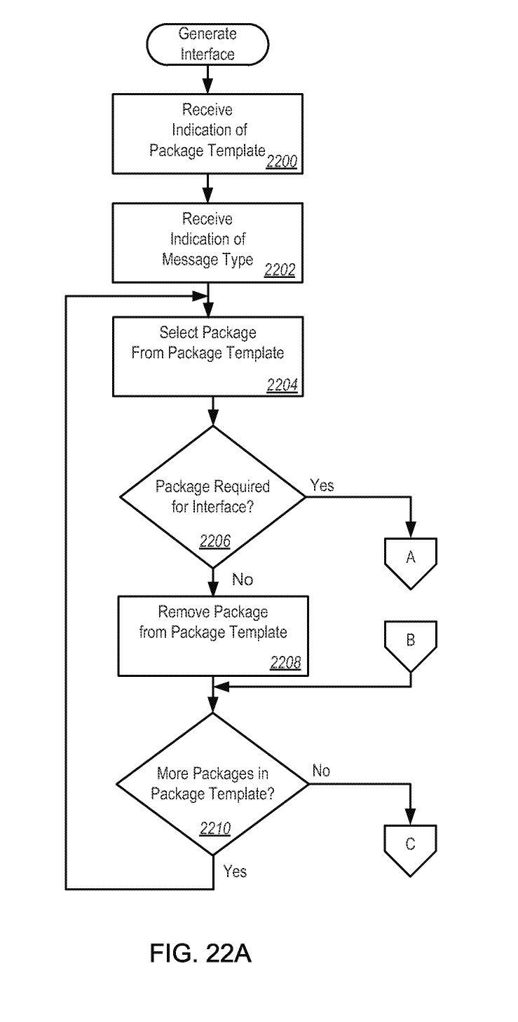

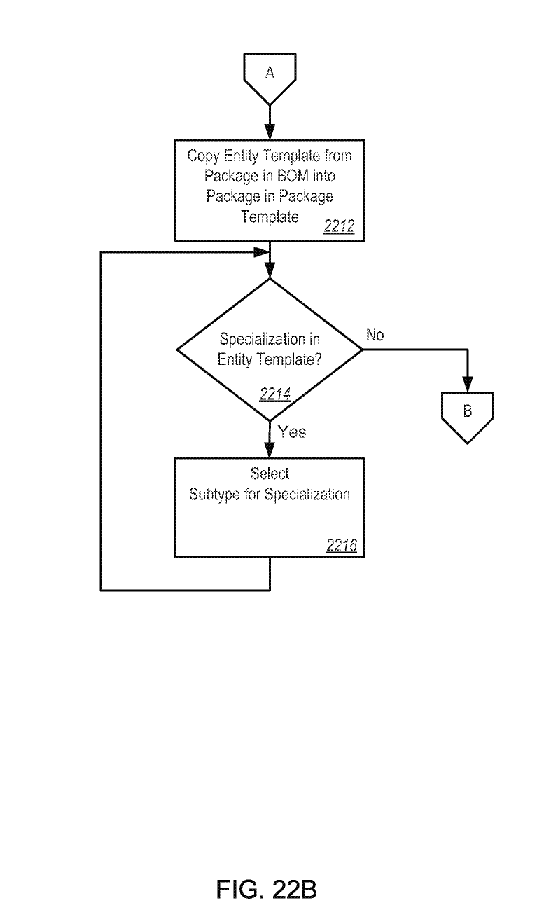

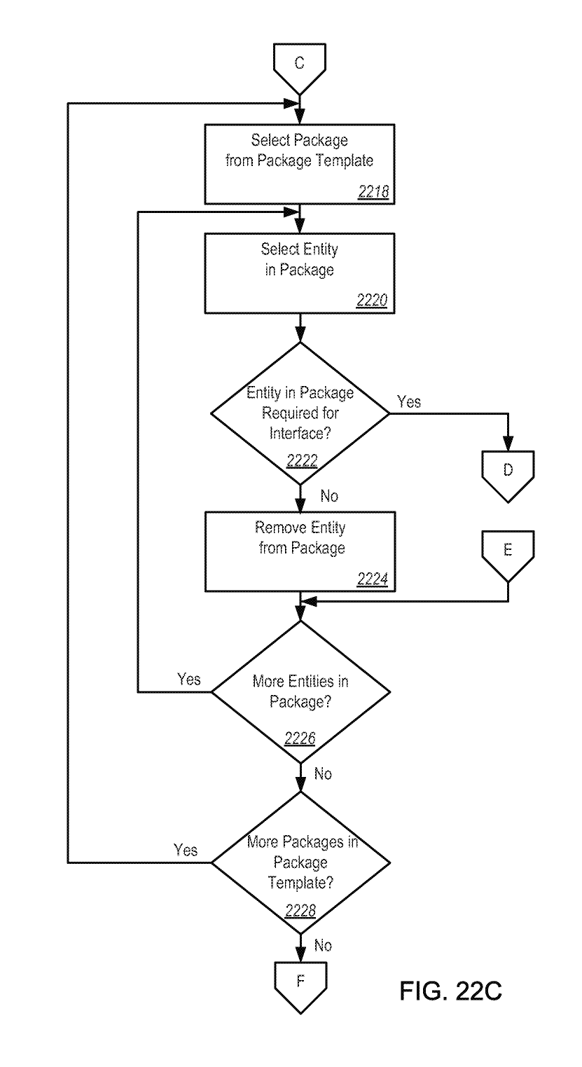

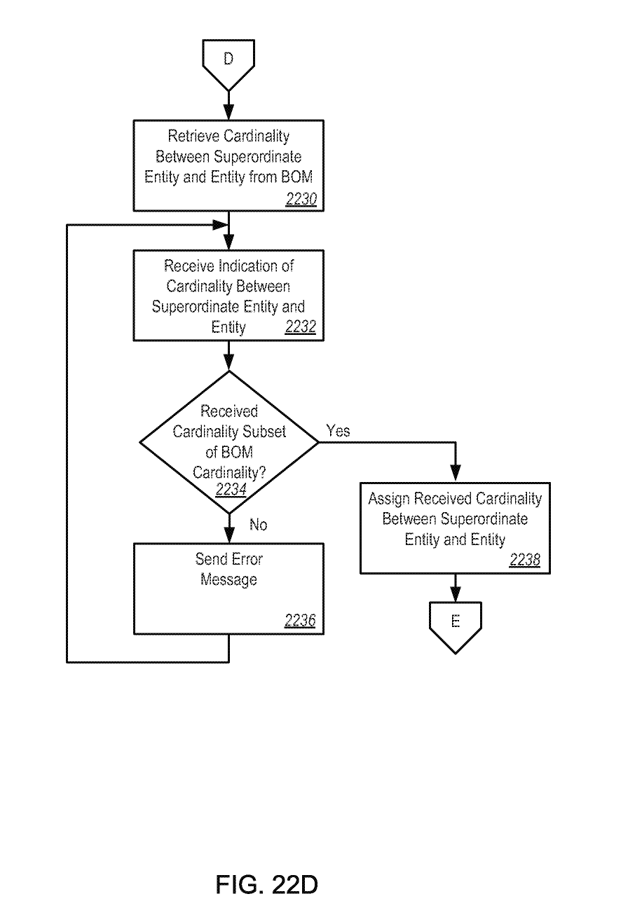

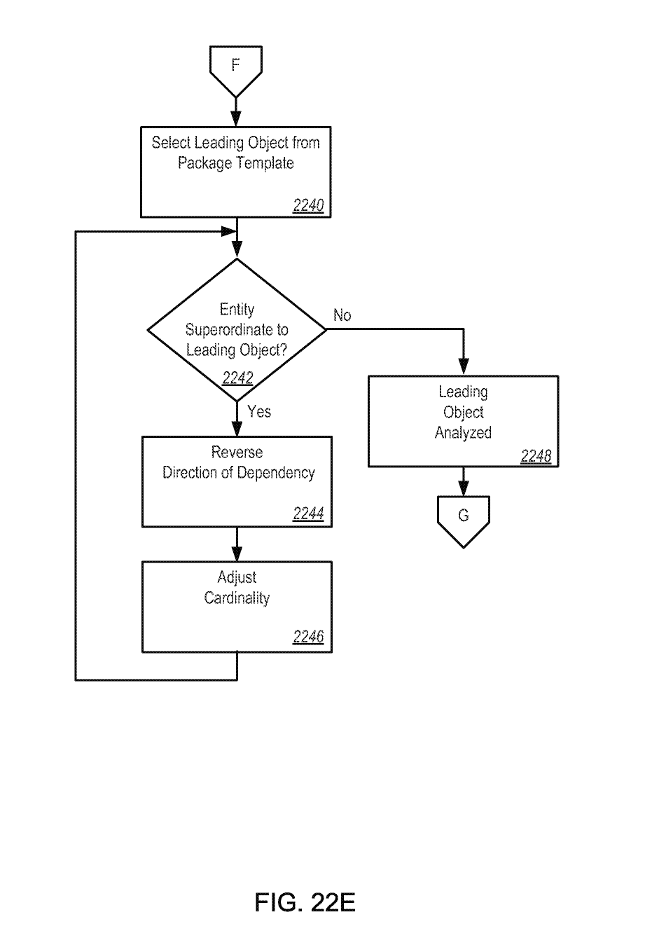

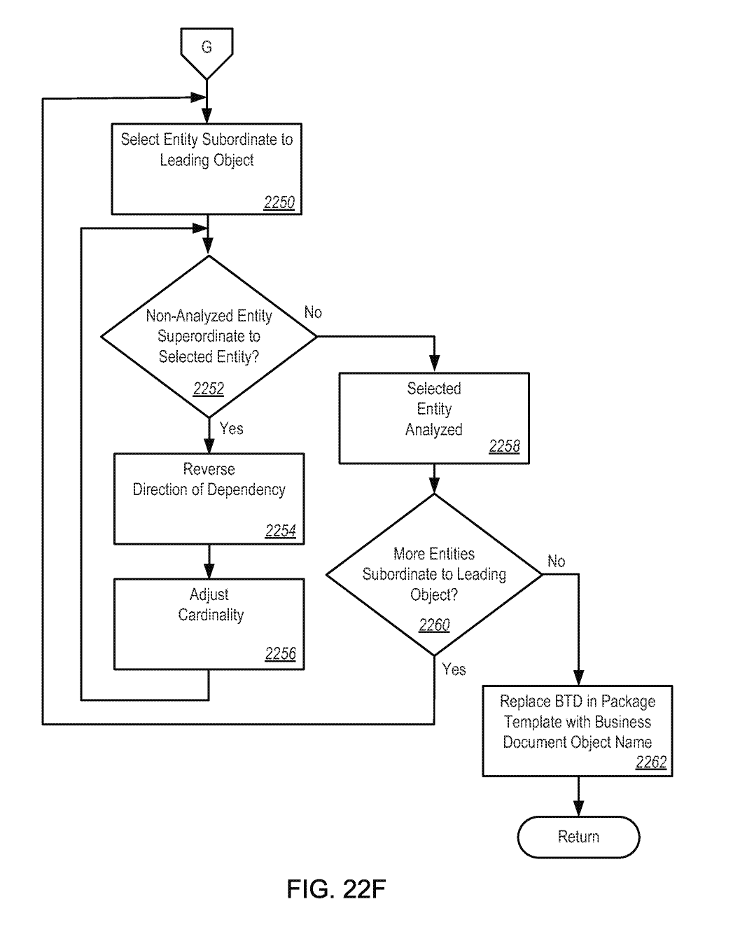

FIGS. 22A-F depict a flow diagram of the steps performed by methods and systems consistent with the subject matter described herein to generate an interface from the business object model. Although described as being performed by a computer, these steps may alternatively be performed manually, or using any combination thereof. The process begins when the system receives an indication of a package template from the designer, i.e., the designer provides a package template to the system (step 2200).

Package templates specify the arrangement of packages within a business transaction document. Package templates are used to define the overall structure of the messages sent between business entities. Methods and systems consistent with the subject matter described herein use package templates in conjunction with the business object model to derive the interfaces.

The system also receives an indication of the message type from the designer (step 2202). The system selects a package from the package template (step 2204), and receives an indication from the designer whether the package is required for the interface (step 2206). If the package is not required for the interface, the system removes the package from the package template (step 2208). The system then continues this analysis for the remaining packages within the package template (step 2210).

If, at step 2206, the package is required for the interface, the system copies the entity template from the package in the business object model into the package in the package template (step 2212, FIG. 22B). The system determines whether there is a specialization in the entity template (step 2214). If the system determines that there is a specialization in the entity template, the system selects a subtype for the specialization (step 2216). The system may either select the subtype for the specialization based on the message type, or it may receive this information from the designer. The system then determines whether there are any other specializations in the entity template (step 2214). When the system determines that there are no specializations in the entity template, the system continues this analysis for the remaining packages within the package template (step 2210, FIG. 22A).

At step 2210, after the system completes its analysis for the packages within the package template, the system selects one of the packages remaining in the package template (step 2218, FIG. 22C), and selects an entity from the package (step 2220). The system receives an indication from the designer whether the entity is required for the interface (step 2222). If the entity is not required for the interface, the system removes the entity from the package template (step 2224). The system then continues this analysis for the remaining entities within the package (step 2226), and for the remaining packages within the package template (step 2228).

If, at step 2222, the entity is required for the interface, the system retrieves the cardinality between a superordinate entity and the entity from the business object model (step 2230, FIG. 22D). The system also receives an indication of the cardinality between the superordinate entity and the entity from the designer (step 2232). The system then determines whether the received cardinality is a subset of the business object model cardinality (step 2234). If the received cardinality is not a subset of the business object model cardinality, the system sends an error message to the designer (step 2236). If the received cardinality is a subset of the business object model cardinality, the system assigns the received cardinality as the cardinality between the superordinate entity and the entity (step 2238). The system then continues this analysis for the remaining entities within the package (step 2226, FIG. 22C), and for the remaining packages within the package template (step 2228).

The system then selects a leading object from the package template (step 2240, FIG. 22E). The system determines whether there is an entity superordinate to the leading object (step 2242). If the system determines that there is an entity superordinate to the leading object, the system reverses the direction of the dependency (step 2244) and adjusts the cardinality between the leading object and the entity (step 2246). The system performs this analysis for entities that are superordinate to the leading object (step 2242). If the system determines that there are no entities superordinate to the leading object, the system identifies the leading object as analyzed (step 2248).

The system then selects an entity that is subordinate to the leading object (step 2250, FIG. 22F). The system determines whether any non-analyzed entities are superordinate to the selected entity (step 2252). If a non-analyzed entity is superordinate to the selected entity, the system reverses the direction of the dependency (step 2254) and adjusts the cardinality between the selected entity and the non-analyzed entity (step 2256). The system performs this analysis for non-analyzed entities that are superordinate to the selected entity (step 2252). If the system determines that there are no non-analyzed entities superordinate to the selected entity, the system identifies the selected entity as analyzed (step 2258), and continues this analysis for entities that are subordinate to the leading object (step 2260). After the packages have been analyzed, the system substitutes the BusinessTransactionDocument (“BTD”) in the package template with the name of the interface (step 2262). This includes the “BTD” in the BTDItem package and the “BTD” in the BTDItemScheduleLine package.

6. Use of an Interface

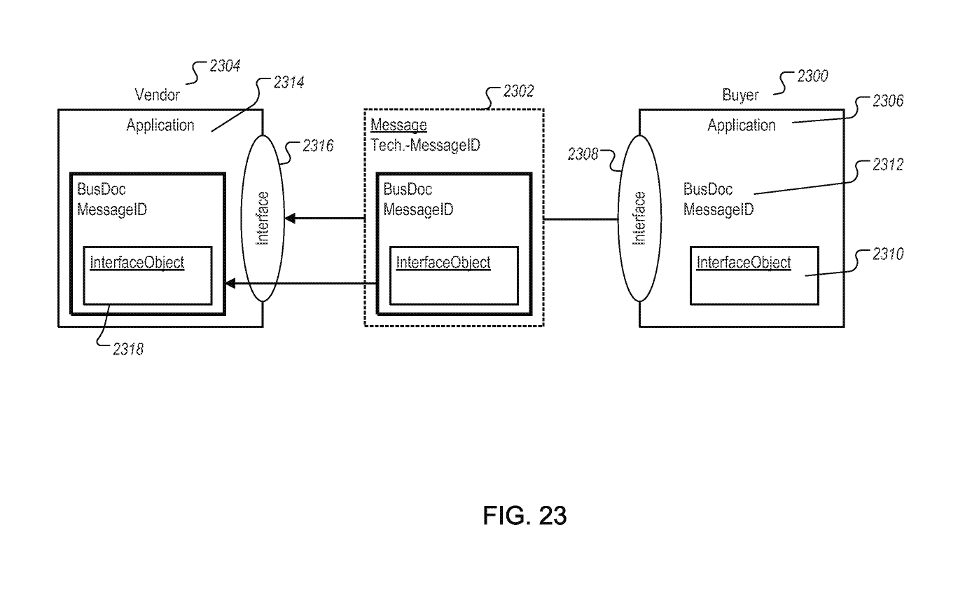

The XI stores the interfaces (as an interface type). At runtime, the sending party's program instantiates the interface to create a business document, and sends the business document in a message to the recipient. The messages are preferably defined using XML. In the example depicted in FIG. 23, the Buyer 2300 uses an application 2306 in its system to instantiate an interface 2308 and create an interface object or business document object 2310. The Buyer's application 2306 uses data that is in the sender's component-specific structure and fills the business document object 2310 with the data. The Buyer's application 2306 then adds message identification 2312 to the business document and places the business document into a message 2302. The Buyer's application 2306 sends the message 2302 to the Vendor 2304. The Vendor 2304 uses an application 2314 in its system to receive the message 2302 and store the business document into its own memory. The Vendor's application 2314 unpacks the message 2302 using the corresponding interface 2316 stored in its XI to obtain the relevant data from the interface object or business document object 2318.

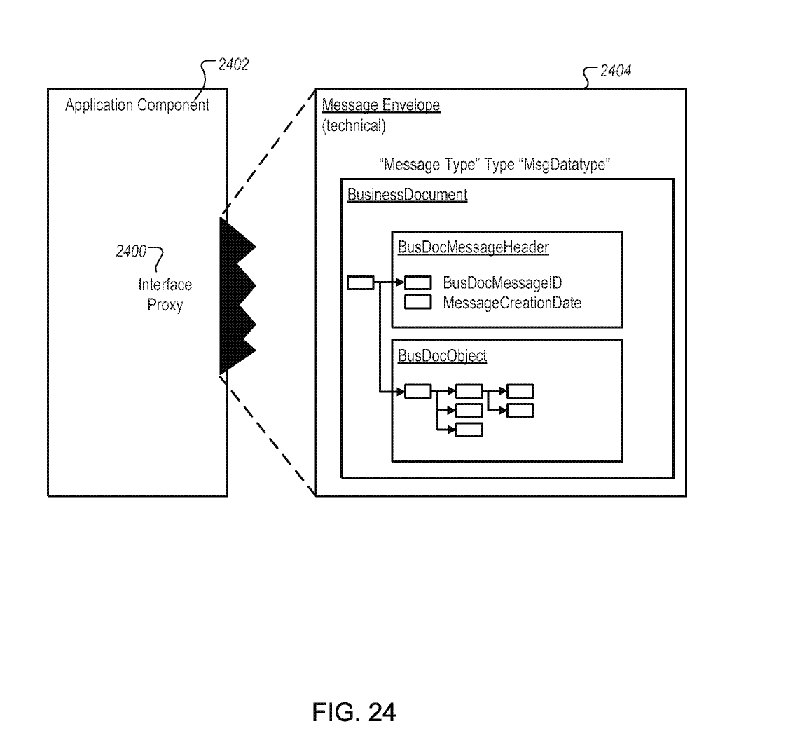

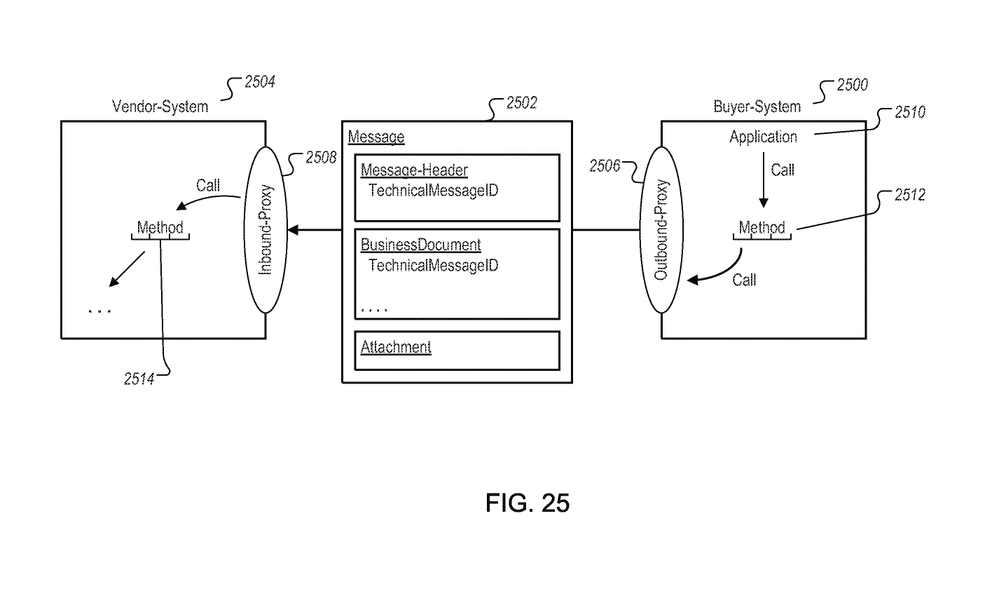

From the component's perspective, the interface is represented by an interface proxy 2400, as depicted in FIG. 24. The proxies 2400 shield the components 2402 of the sender and recipient from the technical details of sending messages 2404 via XI. In particular, as depicted in FIG. 25, at the sending end, the Buyer 2500 uses an application 2510 in its system to call an implemented method 2512, which generates the outbound proxy 2506. The outbound proxy 2506 parses the internal data structure of the components and converts them to the XML structure in accordance with the business document object. The outbound proxy 2506 packs the document into a message 2502. Transport, routing and mapping the XML message to the recipient 28304 is done by the routing system (XI, modeling environment 516, etc.).

When the message arrives, the recipient's inbound proxy 2508 calls its component-specific method 2514 for creating a document. The proxy 2508 at the receiving end downloads the data and converts the XML structure into the internal data structure of the recipient component 2504 for further processing.

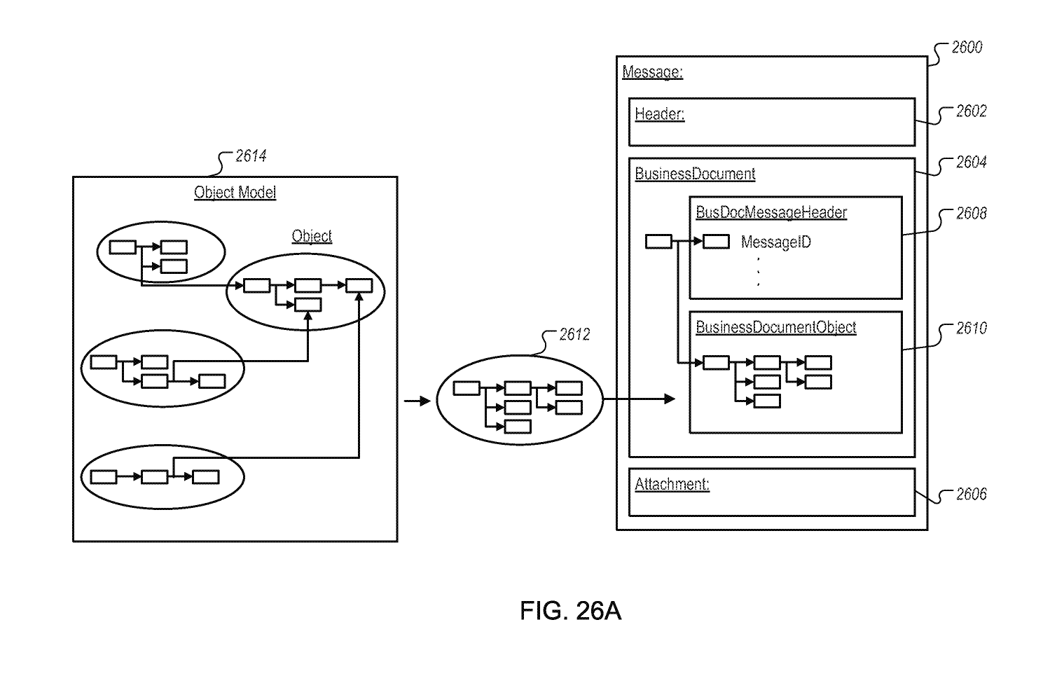

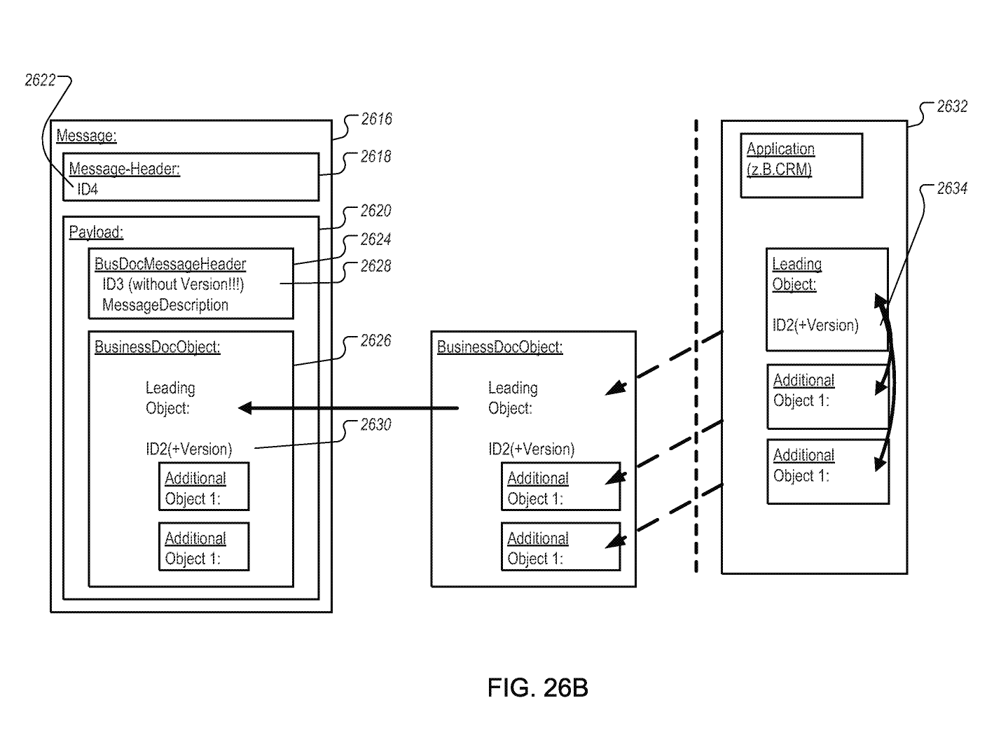

As depicted in FIG. 26A, a message 2600 includes a message header 2602 and a business document 2604. The message 2600 also may include an attachment 2606. For example, the sender may attach technical drawings, detailed specifications or pictures of a product to a purchase order for the product. The business document 2604 includes a business document message header 2608 and the business document object 2610. The business document message header 2608 includes administrative data, such as the message ID and a message description. As discussed above, the structure 2612 of the business document object 2610 is derived from the business object model 2614. Thus, there is a strong correlation between the structure of the business document object and the structure of the business object model. The business document object 2610 forms the core of the message 2600.

In collaborative processes as well as Q&A processes, messages should refer to documents from previous messages. A simple business document object ID or object ID is insufficient to identify individual messages uniquely because several versions of the same business document object can be sent during a transaction. A business document object ID with a version number also is insufficient because the same version of a business document object can be sent several times. Thus, messages require several identifiers during the course of a transaction.

As depicted in FIG. 26B, the message header 2618 in message 2616 includes a technical ID (“ID4”) 2622 that identifies the address for a computer to route the message. The sender's system manages the technical ID 2622.

The administrative information in the business document message header 2624 of the payload or business document 2620 includes a BusinessDocumentMessageID (“ID3”) 2628. The business entity or component 2632 of the business entity manages and sets the BusinessDocumentMessageID 2628. The business entity or component 2632 also can refer to other business documents using the BusinessDocumentMessageID 2628. The receiving component 2632 requires no knowledge regarding the structure of this ID. The BusinessDocumentMessageID 2628 is, as an ID, unique. Creation of a message refers to a point in time. No versioning is typically expressed by the ID. Besides the BusinessDocumentMessageID 2628, there also is a business document object ID 2630, which may include versions.

The component 2632 also adds its own component object ID 2634 when the business document object is stored in the component. The component object ID 2634 identifies the business document object when it is stored within the component. However, not all communication partners may be aware of the internal structure of the component object ID 2634. Some components also may include a versioning in their ID 2634.

7. Use of Interfaces Across Industries

Methods and systems consistent with the subject matter described herein provide interfaces that may be used across different business areas for different industries. Indeed, the interfaces derived using methods and systems consistent with the subject matter described herein may be mapped onto the interfaces of different industry standards. Unlike the interfaces provided by any given standard that do not include the interfaces required by other standards, methods and systems consistent with the subject matter described herein provide a set of consistent interfaces that correspond to the interfaces provided by different industry standards. Due to the different fields provided by each standard, the interface from one standard does not easily map onto another standard. By comparison, to map onto the different industry standards, the interfaces derived using methods and systems consistent with the subject matter described herein include most of the fields provided by the interfaces of different industry standards. Missing fields may easily be included into the business object model. Thus, by derivation, the interfaces can be extended consistently by these fields. Thus, methods and systems consistent with the subject matter described herein provide consistent interfaces or services that can be used across different industry standards.

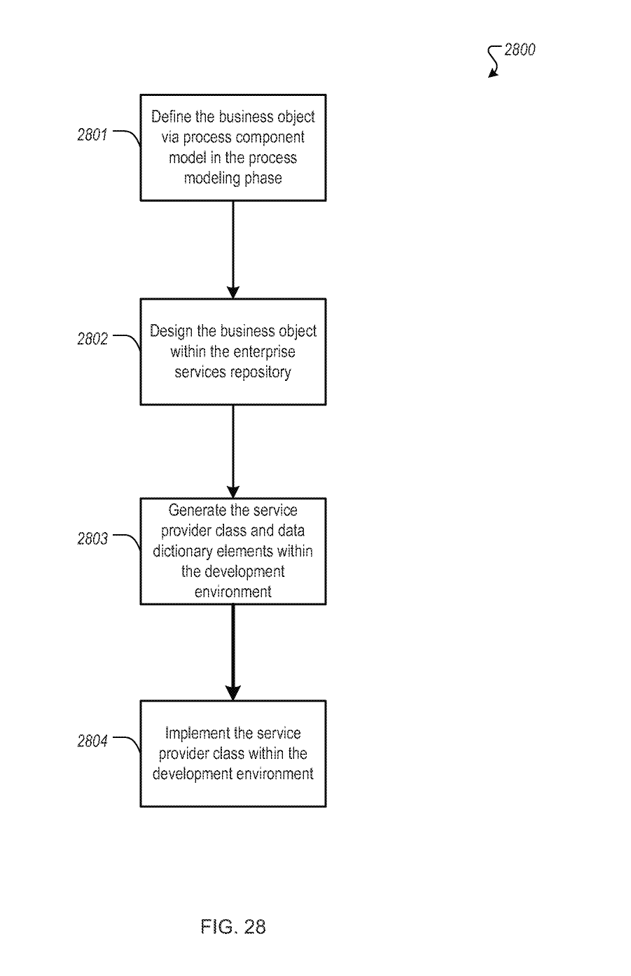

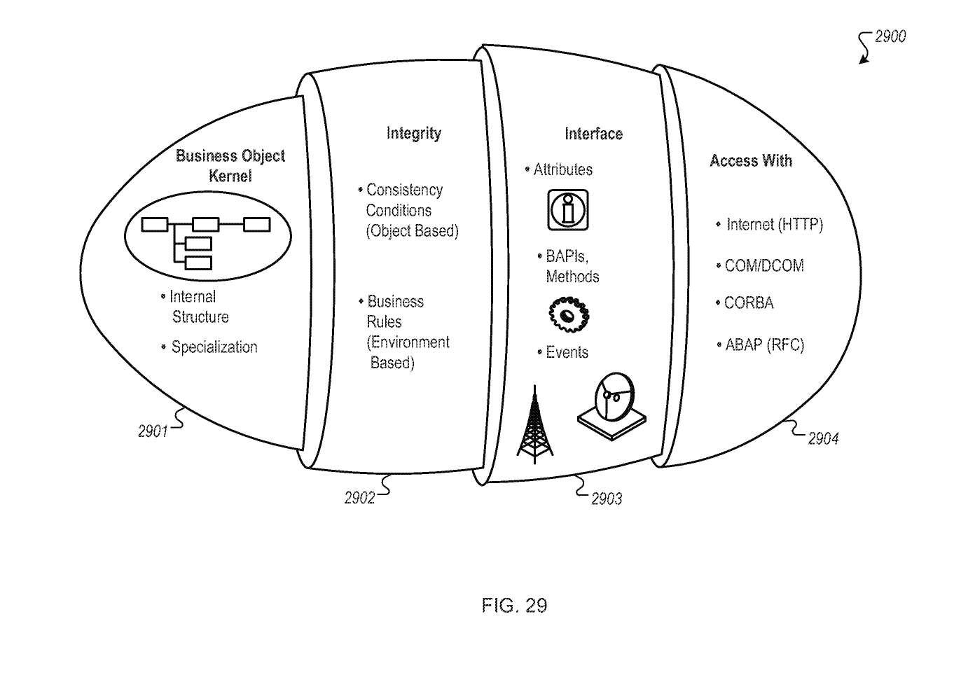

For example, FIG. 28 illustrates an example method 2800 for service enabling. In this example, the enterprise services infrastructure may offer one common and standard-based service infrastructure. Further, one central enterprise services repository may support uniform service definition, implementation and usage of services for user interface, and cross-application communication. In step 2801, a business object is defined via a process component model in a process modeling phase. Next, in step 2802, the business object is designed within an enterprise services repository. For example, FIG. 29 provides a graphical representation of one of the business objects 2900. As shown, an innermost layer or kernel 2901 of the business object may represent the business object's inherent data. Inherent data may include, for example, an employee's name, age, status, position, address, etc. A second layer 2902 may be considered the business object's logic. Thus, the layer 2902 includes the rules for consistently embedding the business object in a system environment as well as constraints defining values and domains applicable to the business object. For example, one such constraint may limit sale of an item only to a customer with whom a company has a business relationship. A third layer 2903 includes validation options for accessing the business object. For example, the third layer 2903 defines the business object's interface that may be interfaced by other business objects or applications. A fourth layer 2904 is the access layer that defines technologies that may externally access the business object.

Accordingly, the third layer 2903 separates the inherent data of the first layer 2901 and the technologies used to access the inherent data. As a result of the described structure, the business object reveals only an interface that includes a set of clearly defined methods. Thus, applications access the business object via those defined methods. An application wanting access to the business object and the data associated therewith usually includes the information or data to execute the clearly defined methods of the business object's interface. Such clearly defined methods of the business object's interface represent the business object's behavior. That is, when the methods are executed, the methods may change the business object's data. Therefore, an application may utilize any business object by providing the information or data without having any concern for the details related to the internal operation of the business object. Returning to method 2800, a service provider class and data dictionary elements are generated within a development environment at step 2803. In step 2804, the service provider class is implemented within the development environment.

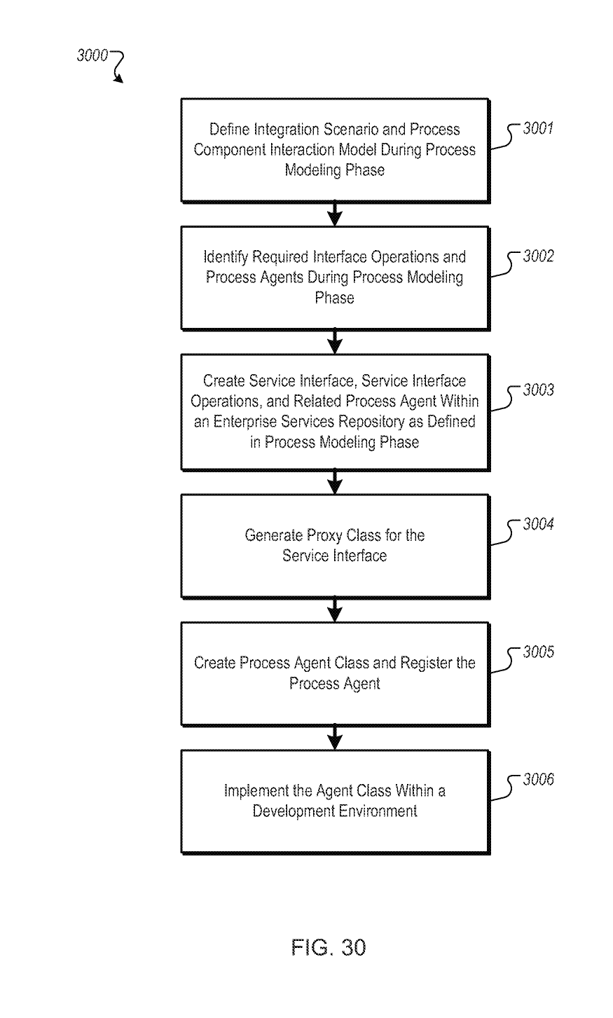

FIG. 30 illustrates an example method 3000 for a process agent framework. For example, the process agent framework may be the basic infrastructure to integrate business processes located in different deployment units. It may support a loose coupling of these processes by message based integration. A process agent may encapsulate the process integration logic and separate it from business logic of business objects. As shown in FIG. 30, an integration scenario and a process component interaction model are defined during a process modeling phase in step 3001. In step 3002, required interface operations and process agents are identified during the process modeling phase also. Next, in step 3003, a service interface, service interface operations, and the related process agent are created within an enterprise services repository as defined in the process modeling phase. In step 3004, a proxy class for the service interface is generated. Next, in step 3005, a process agent class is created and the process agent is registered. In step 3006, the agent class is implemented within a development environment.

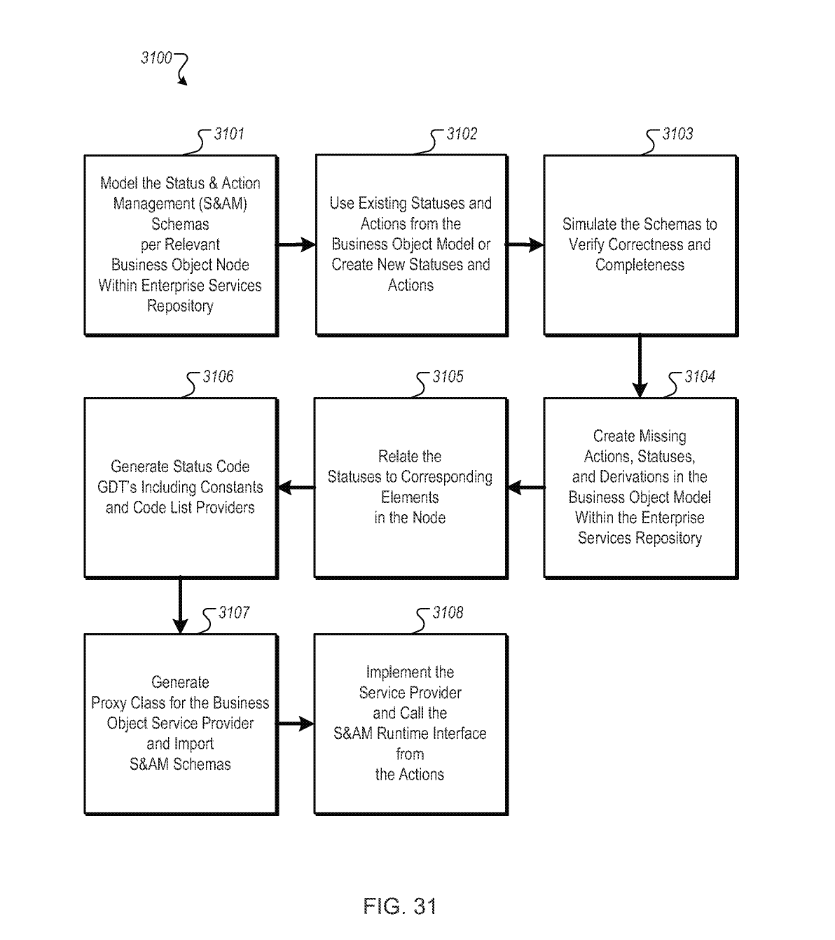

FIG. 31 illustrates an example method 3100 for status and action management (S&AM). For example, status and action management may describe the life cycle of a business object (node) by defining actions and statuses (as their result) of the business object (node), as well as, the constraints that the statuses put on the actions. In step 3101, the status and action management schemas are modeled per a relevant business object node within an enterprise services repository. In step 3102, existing statuses and actions from the business object model are used or new statuses and actions are created. Next, in step 3103, the schemas are simulated to verify correctness and completeness. In step 3104, missing actions, statuses, and derivations are created in the business object model with the enterprise services repository. Continuing with method 3100, the statuses are related to corresponding elements in the node in step 3105. In step 3106, status code GDT's are generated, including constants and code list providers. Next, in step 3107, a proxy class for a business object service provider is generated and the proxy class S&AM schemas are imported. In step 3108, the service provider is implemented and the status and action management runtime interface is called from the actions.

Regardless of the particular hardware or software architecture used, the disclosed systems or software are generally capable of implementing business objects and deriving (or otherwise utilizing) consistent interfaces that are suitable for use across industries, across businesses, and across different departments within a business in accordance with some or all of the following description. In short, system 100 contemplates using any appropriate combination and arrangement of logical elements to implement some or all of the described functionality.

Moreover, the preceding flowcharts and accompanying description illustrate example methods. The present services environment contemplates using or implementing any suitable technique for performing these and other tasks. It will be understood that these methods are for illustration purposes only and that the described or similar techniques may be performed at any appropriate time, including concurrently, individually, or in combination. In addition, many of the steps in these flowcharts may take place simultaneously and/or in different orders than as shown. Moreover, the services environment may use methods with additional steps, fewer steps, and/or different steps, so long as the methods remain appropriate.

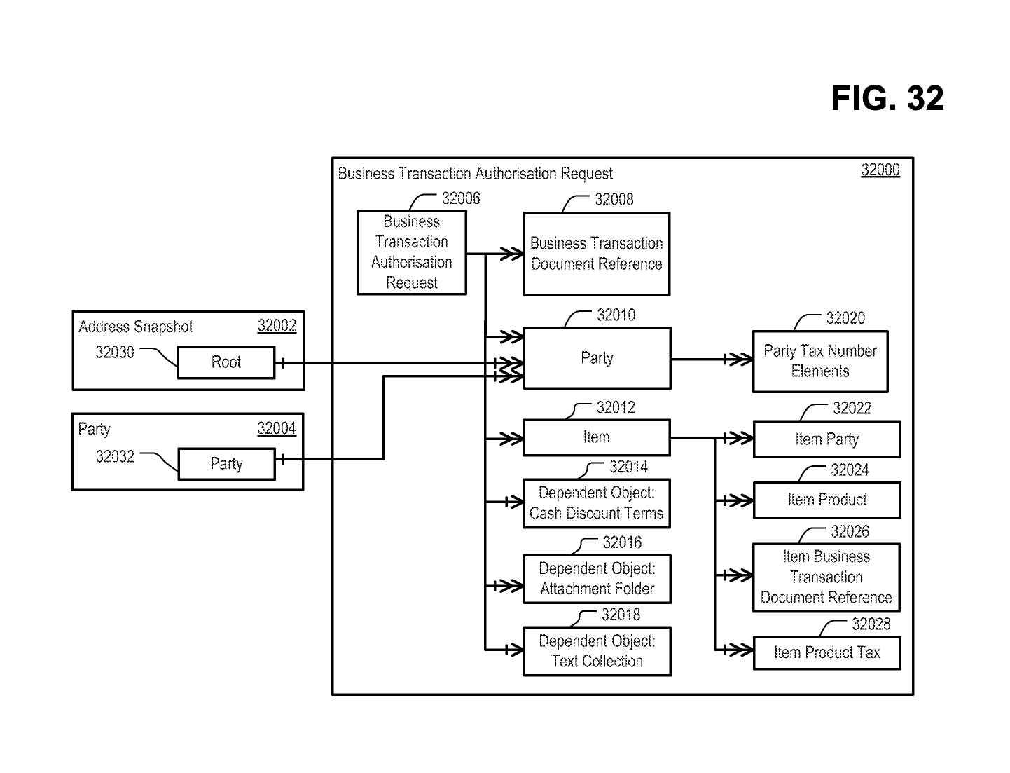

FIG. 32 illustrates an example object model for a Business Transaction Authorisation Request business object 32000. Specifically, the object model depicts interactions among various components of the Business Transaction Authorisation Request business object 32000, as well as external components that interact with the Business Transaction Authorisation Request business object 32000 (shown here as 32002 through 32004 and 32030 through 32032). The Business Transaction Authorisation Request business object 32000 includes elements 32006 through 32028, that can be hierarchical, as depicted. For example, Business Transaction Authorisation Request entity 32006 hierarchically includes one or more Business Transaction Document Reference entities 32008, one or more Party entities 32010, one or more Item entities 32012, zero or one Cash Discount Terms dependent object entities 32014, zero or more Attachment Folder dependent object entities 32016, and zero or one text Collection dependent object entities 32018. Similarly, Party entity 32010 includes zero or more Party Tax Number Elements entities 32020. Some or all of the entities 32006 through 32028 can correspond to packages and/or entities in the message data types described below.

The business object Business Transaction Authorisation Request is an internal request to trigger a process to obtain legal authorization for a business transaction from a legal authority. The Business Transaction Authorisation Request business object belongs to the process component Business Transaction Legal Authorisation Processing. The Business Transaction Authorisation Request business object belongs to the deployment unit Business Transaction Legal Authorisation. The business object Business Transaction Authorisation Request has an object category of Business Transaction Document and a technical category of Standard Business Object. The business object Business Transaction Authorisation Request is involved in the following Process Component Interactions: Customer Invoice Processing_Business Transaction Legal Authorisation Processing.

A service interface Authorisation Internal Request In has a technical name of BusinessTransactionLegalAuthorisationProcessingAuthorisationInternalRequestIn. The service interface Authorisation Internal Request In is part of the following Process Component Interactions Customer Invoice Processing_Business Transaction Legal Authorisation Processing. An operation Process Business Transaction Authorisation Internal Request has a technical name of BusinessTransactionLegalAuthorisationProcessingAuthorisationInternalRequestIn.ProcessBusinessTransactionAuthorisationInternalRequest, and is based on the message type Business Transaction Authorisation Internal Request that is derived from the business object Business Transaction Authorisation Request.

A service interface Authorisation Internal Request Out has a technical name of BusinessTransactionLegalAuthorisationProcessingAuthorisationInternalRequestOut. The service interface Authorisation Internal Request Out is part of the process component interaction Customer Invoice Processing_Business Transaction Legal Authorisation Processing and is an interface to request authorisation of internal requests. A Confirm Authorisation operation has a technical name of BusinessTransactionLegalAuthorisationProcessingAuthorisationInternalRequestOut.Confirm Authorisation and is based on the message type Business Transaction Authorisation Confirmation derived from the business object Business Transaction Authorisation Request.

The business object Business Transaction Authorisation Request can include a Root node. The elements located directly at the node Business Transaction Authorisation Request are defined by the inline structure LAP_S_BTRNSAR_ROOT_EL. These elements include: UUID, BusinessTransactionDocumentID, CashDiscountTermsUUID, TypeCode, ProcessingTypeCode, Date, CancellationDocumentIndicator, TotalGrossAmount, TotalNetAmount, TotalTaxAmount, Status, SellerRegistrationCountryCode, CreationDateTime, TotalDiscountAmount, and CancellationDateTime. UUID may be optional, may be an alternative key, is an internally assigned universally unique ID of a Customer Invoice on which other business objects foreign keys can be defined, and may be based on datatype GDT: UUID. BusinessTransactionDocumentID may be optional, is a unique identifier for a Customer Invoice assigned by a BillFromParty invoice number, and may be based on datatype GDT: BusinessTransactionDocumentID. CashDiscountTermsUUID may be optional and may be based on datatype GDT: UUID. TypeCode may be optional, is a coded representation of a type of a Customer Invoice, and may be based on datatype GDT: BusinessTransactionDocumentTypeCode. ProcessingTypeCode may be optional, is a processing type of a Customer Invoice which controls the behavior of a Customer Invoice within a process component, and may be based on datatype GDT: BusinessTransactionDocumentProcessingTypeCode. Date may be optional, is an issue date of a Customer Invoice, and may be based on datatype GDT: Date. CancellationDocumentIndicator may be optional, indicates whether an invoice is a cancellation invoice, and may be based on datatype GDT: Indicator. TotalGrossAmount may be optional, is a total gross value of a Customer Invoice, and may be based on datatype GDT: Amount. TotalNetAmount may be optional, is a total net value of a Customer Invoice, and may be based on datatype GDT: Amount. TotalTaxAmount may be optional, is a total tax value of a Customer Invoice, and may be based on datatype GDT: Amount. Status may be based on datatype GDT: BusinessTransactionAuthorisationRequestStatus SellerRegistrationCountryCode may be optional and may be based on datatype GDT: CountryCode. CreationDateTime may be optional and may be based on datatype GDT: GLOBAL_DateTime. TotalDiscountAmount may be optional and may be based on datatype GDT: Amount. CancellationDateTime may be optional and may be based on datatype GDT: LOCAL_DateTime.

The following composition relationships to subordinate nodes exist: Business Transaction Document Reference, with a cardinality of 1:N; Party, with a cardinality of 1:N; and Item, with a cardinality of 1:N. The following composition relationships to dependent objects exist: Cash Discount Terms, with a cardinality of 1:C; Attachment Folder, with a cardinality of 1:CN; and TextCollection, with a cardinality of 1:C. The following specialization associations for navigation may exist to the node Party: Seller Party, with a target cardinality of 1; and Buyer Party, with a target cardinality of 1.

The following Enterprise Service Infrastructure actions can exist: a StartLegalApproval action, a NotifyApproval action, a NotifyRejection action, a Cancel action, and a RequestCancel action. A Select All query can be used to select all instances of the node.

A Query By Elements query can be used to select instances which match query elements. The query elements are defined by the inline structure LAP_S_ROOT_QUERY_EL. These elements include: ID, ReferenceID, BusinessTransactionDocumentRelationshipRoleCode, BusinessTransactionDocumentReferenceTypeCode, and BusinessTransactionDocumentReferenceItemTypeCode. ID may be based on datatype GDT: BusinessTransactionDocumentID. ReferenceID may be based on datatype GDT: BusinessTransactionDocumentID. BusinessTransactionDocumentRelationshipRoleCode may be based on datatype GDT: BusinessTransactionDocumentRelationshipRoleCode. BusinessTransactionDocumentReferenceTypeCode may be based on datatype GDT: BusinessTransactionDocumentTypeCode. BusinessTransactionDocumentReferenceItemTypeCode may be based on datatype GDT: BusinessTransactionDocumentItemTypeCode.

Business Transaction Document Reference is a reference to a business document on which a Business Transaction Authorisation Request is based. The elements located directly at the node Business Transaction Document Reference are defined by the inline structure LAP_S_LAR_BTD_REFERENCE_EL. These elements include: BusinessTransactionDocumentReference, BusinessTransactionDocumentRelationshipRoleCode, and CancellationDocumentIndicator. BusinessTransactionDocumentReference may be optional, is a unique identification of a referenced business document item related to a Business Transaction Authorisation Request, and may be based on datatype GDT: BusinessTransactionDocumentReference. BusinessTransactionDocumentRelationshipRoleCode may be optional, is a coded representation of a role of a referenced business transaction document, and may be based on datatype GDT: BusinessTransactionDocumentRelationshipRoleCode. CancellationDocumentIndicator may be optional and may be based on datatype GDT: Indicator. The following specialization associations for navigation may exist to the node Business Transaction Authorisation Request: Parent, with a target cardinality of 1; and Root, with a target cardinality of 1.

A node Party can exist. The elements located directly at the node Party are defined by the inline structure LAP_S_BTRNSAR_PARTY_ELEMENTS. These elements include: PartyKey, PartyUUID, RoleCategoryCode, RoleCode, AddressReference, MainIndicator, PartyTaxID, and PartyTaxIdentificationNumberTypeCode. PartyKey may be optional, is a unique identifier of a Party, and may be based on datatype KDT: PartyKey. PartyKey can include PartyKey/PartyTypeCode, which may be optional, is a coded representation of a type of party, and may be based on datatype GDT: BusinessObjectTypeCode. PartyKey can include PartyKey/PartyID, which may be optional, is an identifier for a party, and may be based on datatype GDT: PartyID. PartyUUID may be optional, is a universally unique identifier for referencing a business partner or organizational unit, and may be based on datatype GDT: UUID. RoleCategoryCode may be optional, is a coded representation of a grouping of partner roles by process-controlling criteria, and may be based on datatype GDT: PartyRoleCategoryCode. RoleCode may be optional, is a coded representation of a partner role, and may be based on datatype GDT: PartyRoleCode. AddressReference may be optional, is a reference to an address of a Party, and may be based on datatype GDT: PartyAddressReference. MainIndicator may be optional, indicates whether a Party has a predominant position towards other parties of a same role, and may be based on datatype GDT: Indicator, with a qualifier of Main. PartyTaxID may be optional and may be based on datatype GDT: PartyTaxID. PartyTaxIdentificationNumberTypeCode may be optional and may be based on datatype GDT: TaxIdentificationNumberTypeCode.

The following composition relationships to subordinate nodes exist: PartyTax NumberElements, with a cardinality of 1:CN. The following inbound aggregation relationships may exist: Address Snapshot, from the business object Address Snapshot/node Root, with a cardinality of C:CN; and Party, from the business object Party/node Party, with a cardinality of C:CN. The following specialization associations for navigation may exist to the node Business Transaction Authorisation Request: Parent, with a target cardinality of 1; and Root, with a target cardinality of 1.

A node PartyTax NumberElements can exist. The elements located directly at the node PartyTax NumberElements are defined by the data type BusinessTransactionAuthorisationRequestPartyPartyTaxNumberElements. These elements include CountryCode, TaxIdentificationNumberTypeCode, and PartyTaxID. CountryCode may be optional and may be based on datatype GDT: CountryCode. TaxIdentificationNumberTypeCode may be optional and may be based on datatype GDT: TaxIdentificationNumberTypeCode. PartyTaxID may be optional and may be based on datatype GDT: PartyTaxID. The following specialization associations for navigation may exist: Root, to the node Business Transaction Authorisation Request, with a target cardinality of 1; and Parent, to the node Party, with a target cardinality of 1.

Item is a statement of an individual receivable, receivables adjustment, or credit memo relating to an invoiced product or service. An item can include quantity information for a product or service and/or an invoice value or value to be credited. An item can also include information about involved parties, locations, and references to underlying business documents. In some implementations, Invoice items and items describing an amount to be credited to a customer can be distinguishable by ReceivablesPropertyMovementDirectionCode, rather than by element TypeCode. The elements located directly at the node Item are defined by the inline structure LAP_S_BTA_ITEM_ELEMENTS. These elements include: UUID, ID, TypeCode, ProcessingTypeCode, Description, GrossAmount, NetAmount, TaxAmount, DiscountRate, Quantity, QuantityTypeCode, ServiceProvisionEndDate, ServiceProvisionStartDate, UnitPriceAmount, ItemMainTotalAmount, and ItemMainTotalRate. UUID may be optional, may be an alternative key, and may be based on datatype GDT: UUID. ID may be optional and may be based on datatype GDT: BusinessTransactionDocumentItemIDTypeCode may be optional and may be based on datatype GDT: BusinessTransactionDocumentItemTypeCode. ProcessingTypeCode may be optional and may be based on datatype GDT: BusinessTransactionDocumentItemProcessingTypeCode. Description may be optional and may be based on datatype GDT: SHORT_Description. GrossAmount may be optional and may be based on datatype GDT: Amount, with a qualifier of Gross. NetAmount may be optional and may be based on datatype GDT: Amount, with a qualifier of Net. TaxAmount may be optional and may be based on datatype GDT: Amount, with a qualifier of Tax. DiscountRate may be optional and may be based on datatype GDT: Rate. Quantity may be optional and may be based on datatype GDT: Quantity. QuantityTypeCode may be optional and may be based on datatype GDT: QuantityTypeCode. ServiceProvisionEndDate may be optional and may be based on datatype GDT: Date. ServiceProvisionStartDate may be optional and may be based on datatype GDT: Date. UnitPriceAmount may be optional and may be based on datatype GDT: Amount. ItemMainTotalAmount may be optional and may be based on datatype GDT: Amount. ItemMainTotalRate may be optional and may be based on datatype GDT: Rate. The following composition relationships to subordinate nodes exist: Item Party, with a cardinality of 1:CN; Item Product, with a cardinality of 1:CN; Item Business Transaction Document Reference, with a cardinality of 1:CN; and Item Product Tax, with a cardinality of 1:CN. The following specialization associations for navigation may exist to the node Business Transaction Authorisation Request: Parent, with a target cardinality of 1; and Root, with a target cardinality of 1. In some implementations, if a quantity or a measure is set, a corresponding quantity or measure type is also filled.

An Item Party is a natural or legal person, organization, organizational unit or group that is involved in an invoice item. The elements located directly at the node Item Party are defined by the inline structure LAP_S_BTRNS_ITEM_PARTY_ELEMENT. These elements include: PartyKey, PartyUUID, RoleCategoryCode, RoleCode, AddressReference, and MainIndicator. PartyKey may be optional and may be based on datatype KDT: PartyKey. PartyKey may include PartyKey/PartyTypeCode, which may be optional, is a coded representation of a type of party, and may be based on datatype GDT: BusinessObjectTypeCode. PartyKey/PartyID may be optional, is an identifier for a party, and may be based on datatype GDT: PartyID. PartyUUID may be optional and may be based on datatype GDT: UUID. RoleCategoryCode may be optional and may be based on datatype GDT: PartyRoleCategoryCode. RoleCode may be optional and may be based on datatype GDT: PartyRoleCode. AddressReference may be optional and may be based on datatype GDT: PartyAddressReference. MainIndicator may be optional and may be based on datatype GDT: Indicator, with a qualifier of Main. The following specialization associations for navigation may exist: Root, to the node Business Transaction Authorisation Request, with a target cardinality of 1; and Parent, to the node Item, with a target cardinality of 1.

Item Product is an identification, description, and classification of a product or service that is invoiced. The elements located directly at the node Item Product are defined by the inline structure LAP_S_BTR_ITEM_PRD_ELEMENTS. These elements include: ProductKey, ProductBuyerID, and ProductUUID. ProductKey may be optional and may be based on datatype KDT: ProductUnformattedKey. ProductKey may include ProductKey/ProductTypeCode, which may be optional, is a coded representation of a product type, such as material or service, and may be based on datatype GDT: ProductTypeCode. ProductKey may include ProductKey/ProductidentifierTypeCode, which may be optional, is a coded representation of a product identifier type, and may be based on datatype GDT: ProductidentifierTypeCode. ProductKey/ProductID may be optional, is an identifier for a product, and may be based on datatype GDT: NOCONVERSION_ProductID. ProductBuyerID may be optional and may be based on datatype GDT: ProductPartyID. ProductUUID may be optional and may be based on datatype GDT: UUID. The following specialization associations for navigation may exist: Root, to the node Business Transaction Authorisation Request, with a target cardinality of 1; and Parent, to the node Item, with a target cardinality of 1.

A node Item Business Transaction Document Reference can exist. The elements located directly at the node Item Business Transaction Document Reference are defined by the inline structure LAP_S_BTR_ITEM_BTD_ELEMENTS. These elements include: BusinessTransactionDocumentReference, BusinessTransactionDocumentRelationshipRoleCode, and BusinessTransactionDocumentUpdateRequiredIndicator. BusinessTransactionDocumentReference may be optional, is a unique identification of a referenced business document item related to a Business Transaction Authorisation Request item, and may be based on datatype GDT: BusinessTransactionDocumentReference. BusinessTransactionDocumentRelationshipRoleCode may be optional, is a coded representation of a role of a referenced business transaction document or a business transaction document item, and may be based on datatype GDT: BusinessTransactionDocumentRelationshipRoleCode. BusinessTransactionDocumentUpdateRequiredIndicator may be optional, indicates whether a referenced business transaction document requires an update regarding invoiced quantities and amounts via Customer Invoice Issued Confirmation, and may be based on datatype GDT: Indicator, with a qualifier of Required. The following specialization associations for navigation may exist: Root, to the node Business Transaction Authorisation Request, with a target cardinality of 1; and Parent, to the node Item, with a target cardinality of 1.

Item Product Tax includes detailed information used for a declaration of a product tax. The elements located directly at the node Item Product Tax are defined by the data type ItemProductTaxElements. These elements include TaxDeclarationTaxAmount, TaxDeclarationNonDeductibleAmount, ProductTaxStandardClassificationSystemCode, ProductTaxStandardClassificationCode, PermanentEstablishmentUUID, and ProductTax. TaxDeclarationTaxAmount may be optional and may be based on datatype GDT: Amount, with a qualifier of Tax. TaxDeclarationNonDeductibleAmount may be optional and may be based on datatype GDT: Amount, with a qualifier of Deductible. ProductTaxStandardClassificationSystemCode may be optional, is a coded representation of a product tax standard classification system, and may be based on datatype GDT: ProductTaxStandardClassificationSystemCode. ProductTaxStandardClassificationCode may be optional, is a coded representation of a product tax standard classification, and may be based on datatype GDT: ProductTaxStandardClassificationCode. PermanentEstablishmentUUID may be optional, is a universally unique identifier of a permanent establishment registered at a tax authority for taxation, and may be based on datatype GDT: UUID. ProductTax may be optional, is a tax that is incurred when products are purchased, sold, or consumed, can be an amount in a tax declaration currency, and may be based on datatype GDT: FINANCIALACCOUNTING_ProductTax. TaxJurisdictionProductTaxStandardClassificationCode may be optional and may be based on datatype GDT: TaxJurisdictionProductTaxStandardClassificationCode. The following specialization associations for navigation may exist: Root, to the node Business Transaction Authorisation Request, with a target cardinality of 1; and Parent, to the node Item, with a target cardinality of 1.

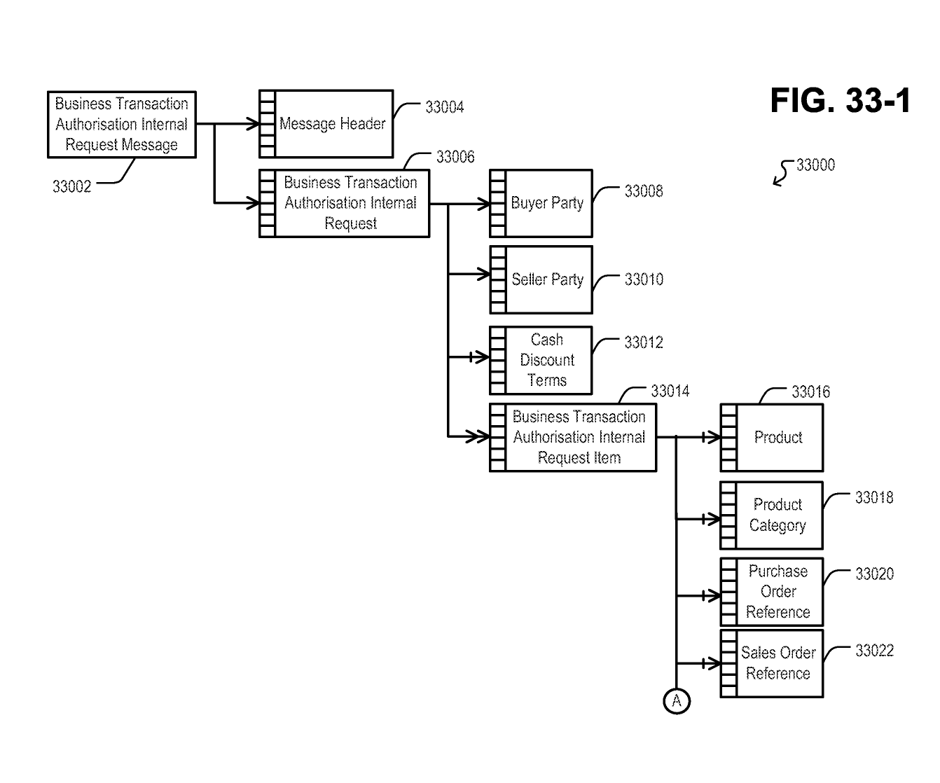

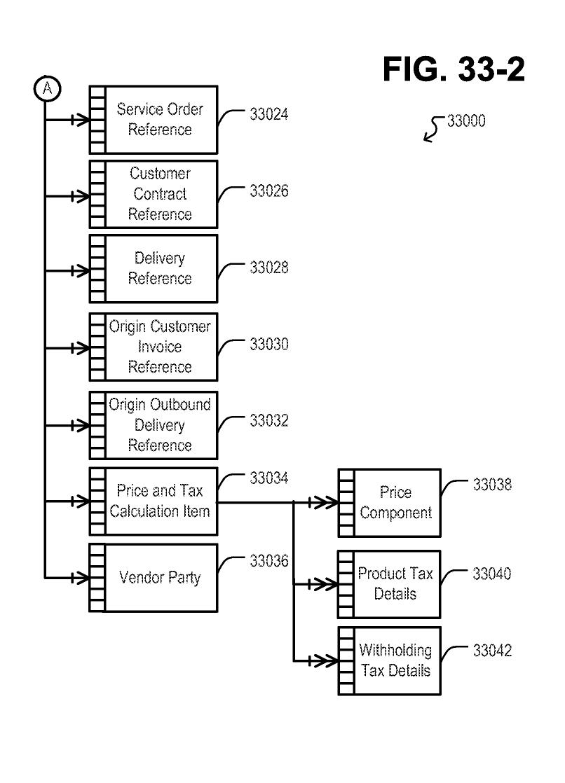

FIGS. 33-1 through 33-2 collectively illustrate one example logical configuration of a Business Transaction Authorisation Internal Request message 33000. Specifically, these figures depict the arrangement and hierarchy of various components such as one or more levels of packages, entities, and datatypes, shown here as 33002 through 33042. As described above, packages may be used to represent hierarchy levels, and different types of cardinality relationships among entities can be represented using different arrowhead styles. Entities are discrete business elements that are used during a business transaction. Data types are used to type object entities and interfaces with a structure. For example, the Business Transaction Authorisation Internal Request message 33000 includes, among other things, the Business Transaction Authorisation Internal Request entity 33006. Accordingly, heterogeneous applications may communicate using this consistent message configured as such.

The message type Business Transaction Authorisation Internal Request is derived from the business object Business Transaction Authorisation Request as a leading object together with its operation signature. The message type Business Transaction Authorisation Internal Request is an internal request to trigger a process to obtain legal authorization of a business transaction by legal authorities. The structure of the message type Business Transaction Authorisation Internal Request is determined by the message data type BusinessTransactionAuthorisationInternalRequestMessage. The message data type BusinessTransactionAuthorisationInternalRequestMessage includes the MessageHeader package and the BusinessTransactionAuthorisationInternalRequest package. The package MessageHeader includes the sub-packages Party and Business Scope and the entity MessageHeader. MessageHeader is typed by BusinessDocumentMessageHeader.

The package BusinessTransactionAuthorisationInternalRequest includes the sub-packages Party, CashDiscountTerms, and Item, and the entity BusinessTransactionAuthorisationInternalRequest. BusinessTransactionAuthorisationInternalRequest includes the ReconciliationPeriodCounterValue attribute, which may have a multiplicity of 0 . . . 1 and may be based on datatype BGDT:CounterValue. BusinessTransactionAuthorisationInternalRequest includes the following non-node elements: BaseBusinessTransactionDocumentID, BaseBusinessTransactionDocumentUUID, BaseBusinessTransactionDocumentTypeCode, ProcessingTypeCode, CreationDate, CreationDateTime, CancellationDocumentIndicator, TotalGrossAmount, TotalNetAmount, TotalTaxAmount, TotalDiscountAmount, and SellerRegistrationCountryCode. BaseBusinessTransactionDocumentID may have a multiplicity of 1 and may be based on datatype BGDT:BusinessTransactionDocumentID. BaseBusinessTransactionDocumentUUID may have a multiplicity of 0 . . . 1 and may be based on datatype BGDT:UUID. BaseBusinessTransactionDocumentTypeCode may have a multiplicity of 0 . . . 1 and may be based on datatype BGDT:BusinessTransactionDocumentTypeCode. ProcessingTypeCode may have a multiplicity of 0 . . . 1 and may be based on datatype BGDT:BusinessTransactionDocumentProcessingTypeCode. CreationDate may have a multiplicity of 1 and may be based on datatype CDT:Date. CreationDateTime may have a multiplicity of 0 . . . 1 and may be based on datatype CDT:GLOBAL_DateTime. CancellationDocumentIndicator may have a multiplicity of 0 . . . 1 and may be based on datatype CDT:Indicator. TotalGrossAmount may have a multiplicity of 0 . . . 1 and may be based on datatype CDT:Amount. TotalNetAmount may have a multiplicity of 0 . . . 1 and may be based on datatype CDT:Amount. TotalTaxAmount may have a multiplicity of 0 . . . 1 and may be based on datatype CDT:Amount. TotalDiscountAmount may have a multiplicity of 0 . . . 1 and may be based on datatype CDT:Amount. SellerRegistrationCountryCode may have a multiplicity of 0 . . . 1 and may be based on datatype BGDT:CountryCode. BusinessTransactionAuthorisationInternalRequest includes the following node elements: BuyerParty, with a cardinality of 1:1; SellerParty, with a cardinality of 1:1; CashDiscountTerms, with a cardinality of 1:C; and BusinessTransactionAuthorisationInternalRequestItem, with a cardinality of 1:N.

The package BusinessTransactionAuthorisationInternalRequestParty includes the sub-packages Address and Contact Person and the entities BuyerParty and SellerParty. BuyerParty is typed by BusinessTransactionAuthorisationInternalRequestBusinessTransactionDocumentParty. SellerParty is typed by BusinessTransactionAuthorisationInternalRequestBusinessTransactionDocumentParty. The package BusinessTransactionAuthorisationInternalRequestCashDiscountTerms includes the entity CashDiscountTerms. CashDiscountTerms is typed by CashDiscountTerms.

The package BusinessTransactionAuthorisationInternalRequestItem includes the sub-packages ProductInformation, BusinessTransactionDocumentReference, PriceAndTaxCalculation, and Party, and the entity BusinessTransactionAuthorisationInternalRequestItem. BusinessTransactionAuthorisationInternalRequestItem includes the following non-node elements: ID, UUID, TypeCode, Description, ItemProcessingTypeCode, ProductUUID, Quantity, QuantityTypeCode, ServiceProvisionEndDate, and ServiceProvisionStartDate. ID may have a multiplicity of 1 and may be based on datatype BGDT:BusinessTransactionDocumentItemID UUID may have a multiplicity of 0 . . . 1 and may be based on datatype BGDT:UUID. TypeCode may have a multiplicity of 1 and may be based on datatype BGDT:BusinessTransactionDocumentItemTypeCode. Description may have a multiplicity of 0 . . . 1 and may be based on datatype BGDT:SHORT_Description. ItemProcessingTypeCode may have a multiplicity of 0 . . . 1 and may be based on datatype BGDT:BusinessTransactionDocumentProcessingTypeCode. ProductUUID may have a multiplicity of 0 . . . 1 and may be based on datatype BGDT:UUID. Quantity may have a multiplicity of 0 . . . 1 and may be based on datatype CDT:Quantity. QuantityTypeCode may have a multiplicity of 0 . . . 1 and may be based on datatype BGDT:QuantityTypeCode. ServiceProvisionEndDate may have a multiplicity of 0 . . . 1 and may be based on datatype CDT:Date. ServiceProvisionStartDate may have a multiplicity of 0 . . . 1 and may be based on datatype CDT:Date. BusinessTransactionAuthorisationInternalRequestItem includes the following node elements: Product, in a 1:C cardinality relationship; ProductCategory, in a 1:C cardinality relationship; PurchaseOrderReference, in a 1:C cardinality relationship; SalesOrderReference, in a 1:C cardinality relationship; ServiceOrderReference, in a 1:C cardinality relationship; CustomerContractReference, in a 1:C cardinality relationship; DeliveryReference, in a 1:C cardinality relationship; OriginCustomerinvoiceReference, in a 1:C cardinality relationship; OriginOutboundDeliveryReference, in a 1:C cardinality relationship; PriceandTaxCalculationitem, in a 1:C cardinality relationship; and VendorParty, in a 1:C cardinality relationship.

The package BusinessTransactionAuthorisationInternalRequestItemProductInformation includes the entities Product and ProductCategory. Product is typed by BusinessTransactionDocumentProduct. ProductCategory is typed by BusinessTransactionDocumentProductCategory.

The package BusinessTransactionAuthorisationInternalRequestItemBusinessTransactionDocumentReference includes the entities PurchaseOrderReference, SalesOrderReference, ServiceOrderReference, CustomerContractReference, DeliveryReference, OriginCustomerinvoiceReference, and OriginOutboundDeliveryReference.

PurchaseOrderReference is typed by BusinessTransactionDocumentReference. SalesOrderReference is typed by BusinessTransactionDocumentReference. ServiceOrderReference is typed by BusinessTransactionDocumentReference. CustomerContractReference is typed by BusinessTransactionDocumentReference. DeliveryReference is typed by BusinessTransactionDocumentReference. OriginCustomerinvoiceReference is typed by BusinessTransactionDocumentReference. OriginOutboundDeliveryReference is typed by BusinessTransactionDocumentReference.

The package BusinessTransactionAuthorisationInternalRequestItemPriceAndTaxCalculation includes the entity PriceandTaxCalculationitem. PriceandTaxCalculationitem includes the following non-node elements: GrossAmount, NetAmount, TaxAmount, TaxationCharacteristicsCode, TaxationCharacteristicsDeterminationMethodCode, WithholdingTaxationCharacteristicsCode, WithholdingTaxationCharacteristicsDeterminationMethodCode, RegisterDateTime, RegionCode, TaxJurisdictionCode, CalculatedAmountAdaptationFactorDecimalValue, MainDiscountComponent, MainPriceComponent, MainSurchargeComponent, MainTotalComponent, and TaxationTerms. GrossAmount may have a multiplicity of 0 . . . 1 and may be based on datatype CDT:Amount. NetAmount may have a multiplicity of 0 . . . 1 and may be based on datatype CDT:Amount. TaxAmount may have a multiplicity of 0 . . . 1 and may be based on datatype CDT:Amount. TaxationCharacteristicsCode may have a multiplicity of 0 . . . 1 and may be based on datatype BGDT:ProductTaxationCharacteristicsCode. TaxationCharacteristicsDeterminationMethodCode may have a multiplicity of 0 . . . 1 and may be based on datatype BGDT:TaxationCharacteristicsDeterminationMethodCode. WithholdingTaxationCharacteristicsCode may have a multiplicity of 0 . . . 1 and may be based on datatype BGDT:WithholdingTaxationCharacteristicsCode. WithholdingTaxationCharacteristicsDeterminationMethodCode may have a multiplicity of 0 . . . 1 and may be based on datatype BGDT:TaxationCharacteristicsDeterminationMethodCode. RegisterDateTime may have a multiplicity of 0 . . . 1 and may be based on datatype CDT:GLOBAL_DateTime. RegionCode may have a multiplicity of 0 . . . 1 and may be based on datatype BGDT:RegionCode. TaxJurisdictionCode may have a multiplicity of 0 . . . 1 and may be based on datatype BGDT:TaxJurisdictionCode. CalculatedAmountAdaptationFactorDecimalValue may have a multiplicity of 0 . . . 1 and may be based on datatype BGDT:DecimalValue. MainDiscountComponent may have a multiplicity of 0 . . . 1 and may be based on datatype AGDT:PriceComponent, with a qualifier of Main. MainPriceComponent may have a multiplicity of 0 . . . 1 and may be based on datatype AGDT:PriceComponent, with a qualifier of Main. MainSurchargeComponent may have a multiplicity of 0 . . . 1 and may be based on datatype AGDT:PriceComponent, with a qualifier of Main. MainTotalComponent may have a multiplicity of 0 . . . 1 and may be based on datatype AGDT:PriceComponent, with a qualifier of Main. TaxationTerms may have a multiplicity of 0 . . . 1 and may be based on datatype AGDT:TaxationTerms. PriceandTaxCalculationitem includes the following node elements: PriceComponent, in a 1:CN cardinality relationship; ProductTaxDetails, in a 1:CN cardinality relationship; and WithholdingTaxDetails, in a 1:CN cardinality relationship. PriceComponent is typed by PriceComponent. ProductTaxDetails is typed by ProductTaxDetails. WithholdingTaxDetails is typed by WithholdingTaxDetails.

The package BusinessTransactionAuthorisationInternalRequestItemParty includes the sub-packages Address and Contact Person, and the entity VendorParty. VendorParty is typed by BusinessTransactionDocumentParty.

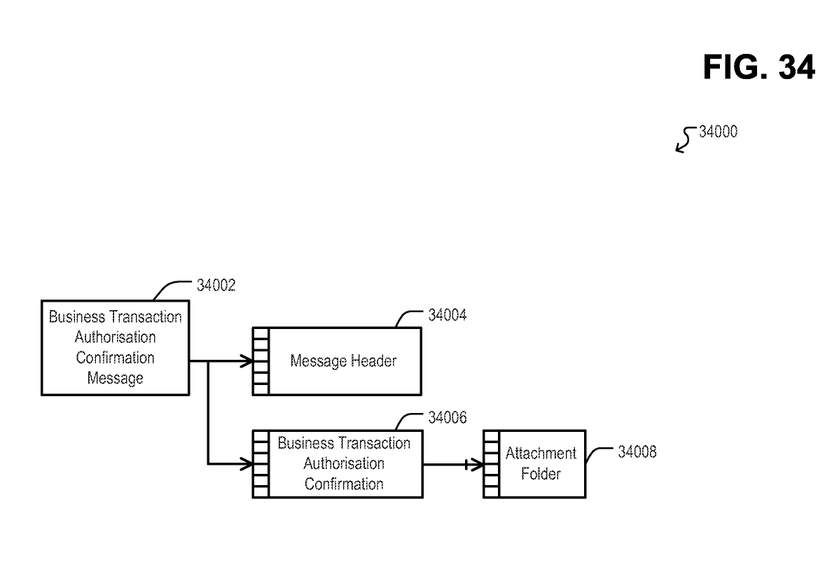

FIG. 34 illustrates one example logical configuration of a Business Transaction Authorisation Confirmation message 34000. Specifically, this figure depicts the arrangement and hierarchy of various components such as one or more levels of packages, entities, and datatypes, shown here as 33002 through 34008. As described above, packages may be used to represent hierarchy levels, and different types of cardinality relationships among entities can be represented using different arrowhead styles. Entities are discrete business elements that are used during a business transaction. Data types are used to type object entities and interfaces with a structure. For example, Business Transaction Authorisation Confirmation message 34000 includes, among other things, the Business Transaction Authorisation Confirmation entity 34006. Accordingly, heterogeneous applications may communicate using this consistent message configured as such.

The message type Business Transaction Authorisation Confirmation is derived from the business object Business Transaction Authorisation Request as a leading object together with its operation signature. The message type Business Transaction Authorisation Confirmation is a positive or negative reply to a request to trigger a process to obtain legal authorization of a business transaction by legal authorities. The structure of the message type Business Transaction Authorisation Confirmation is determined by the message data type BusinessTransactionAuthorisationConfirmationMessage.

The message data type BusinessTransactionAuthorisationConfirmationMessage includes the MessageHeader package and the BusinessTransactionAuthorisationConfirmation package. The package MessageHeader includes the sub-packages Party and Business Scope and the entity MessageHeader. MessageHeader is typed by BusinessDocumentMessageHeader.

The package BusinessTransactionAuthorisationConfirmation includes the sub-package AttachmentFolder and the entity BusinessTransactionAuthorisationConfirmation. BusinessTransactionAuthorisationConfirmation includes the following non-node elements: ID, UUID, CustomerInvoiceUUID, and CancellationDateTime. ID may have a multiplicity of 1 and may be based on datatype BGDT:BusinessTransactionDocumentID. UUID may have a multiplicity of 1 and may be based on datatype BGDT:UUID. CustomerInvoiceUUID may have a multiplicity of 1 and may be based on datatype BGDT:UUID. CancellationDateTime may have a multiplicity of 0 . . . 1 and may be based on datatype CDT:LOCAL_DateTime. BusinessTransactionAuthorisationConfirmation includes the node element AttachmentFolder in a 1:C cardinality relationship. The package BusinessTransactionAuthorisationConfirmationAttachmentFolder includes the sub-package Document and the entity AttachmentFolder. AttachmentFolder is typed by AttachmentFolder.

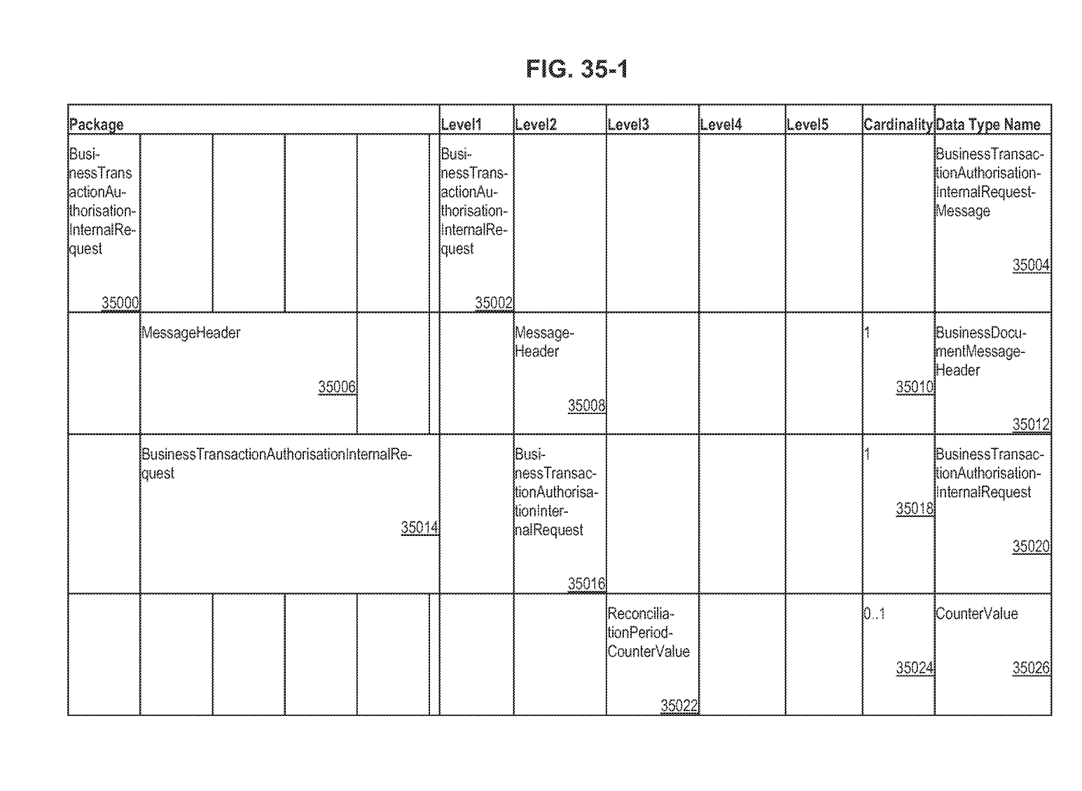

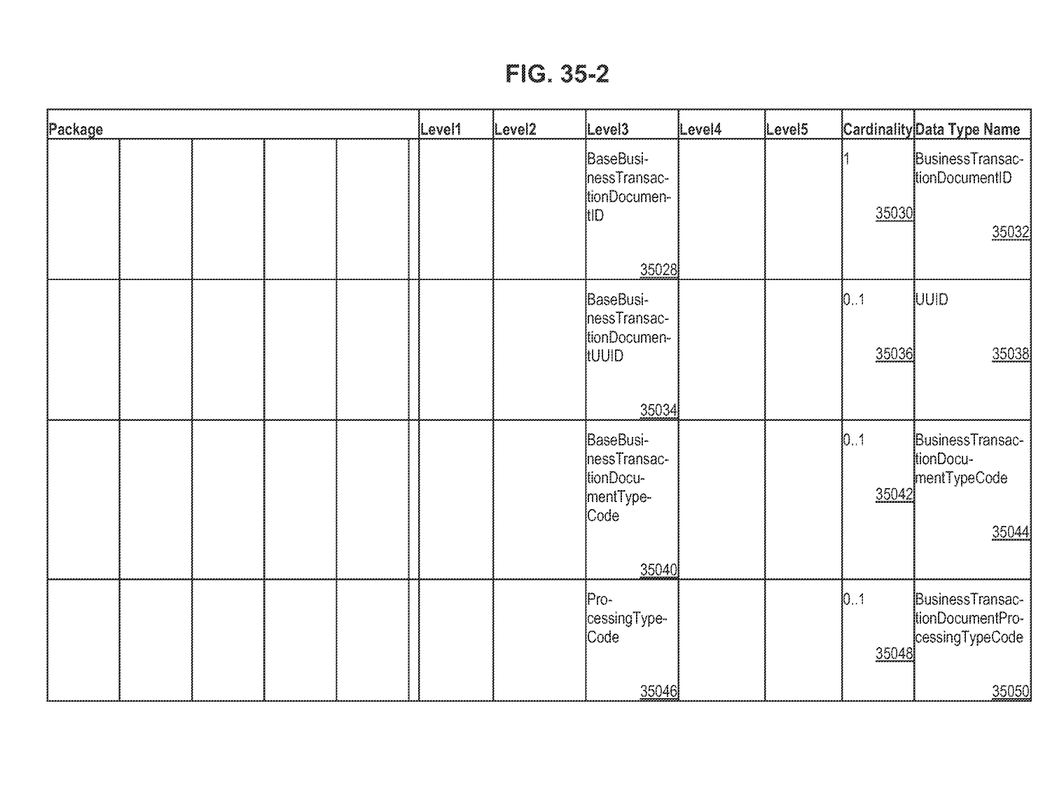

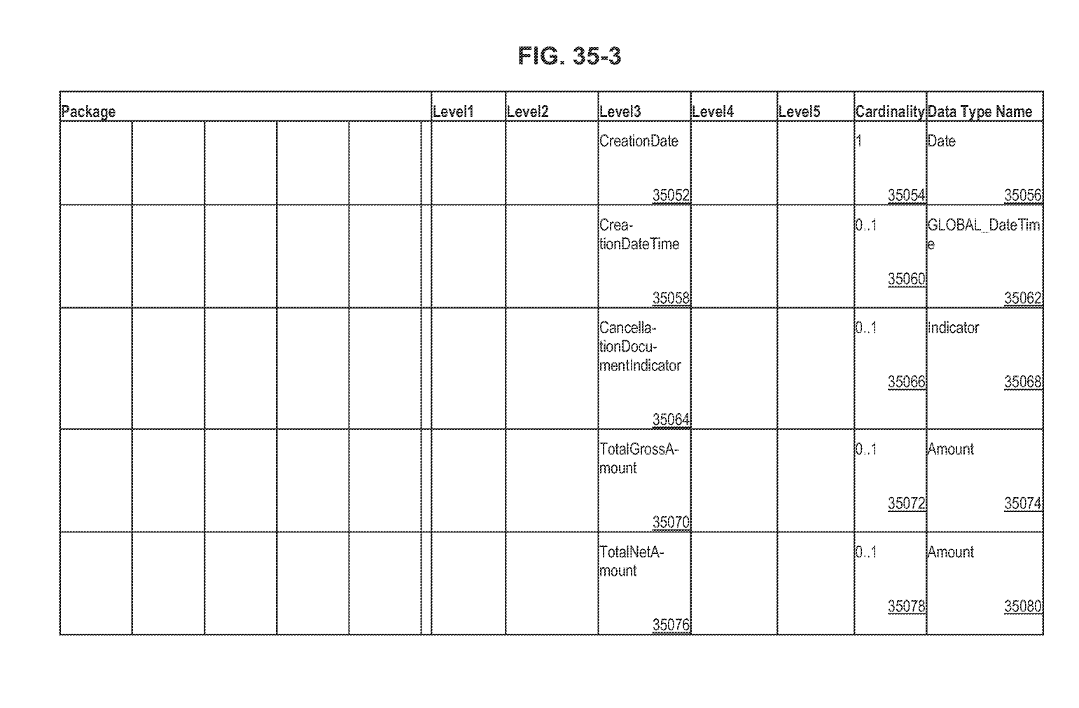

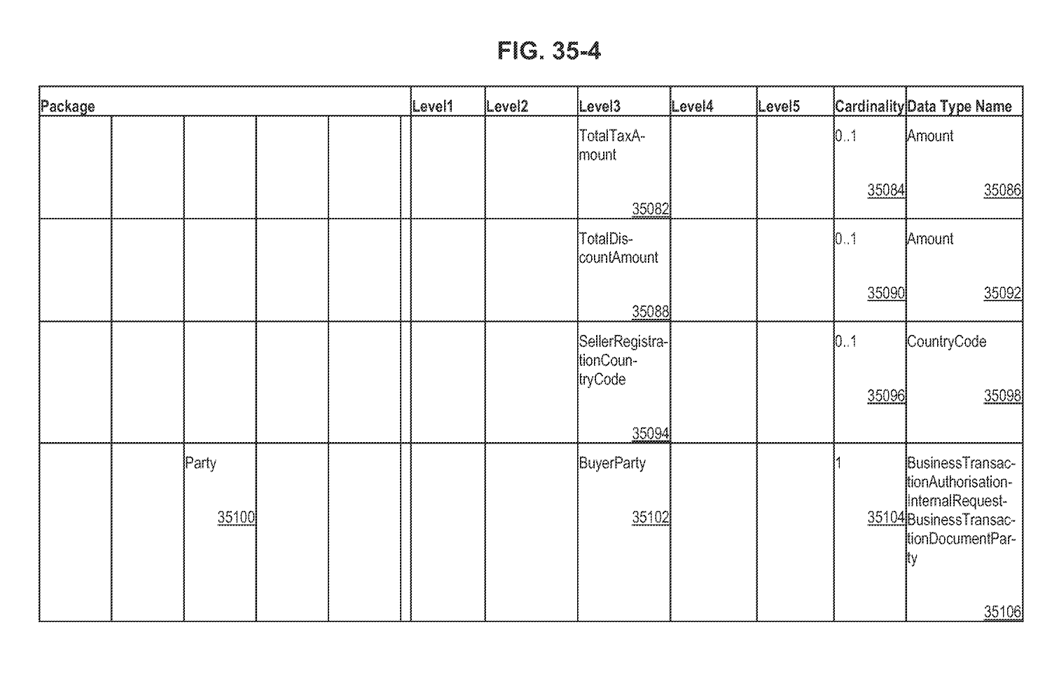

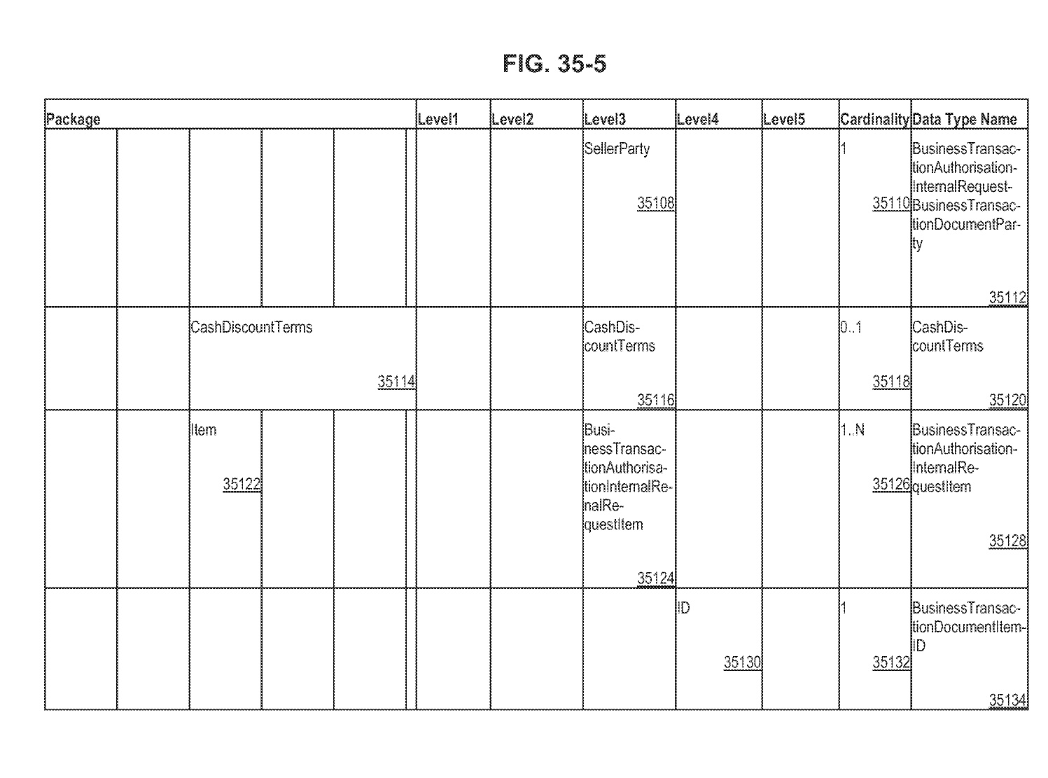

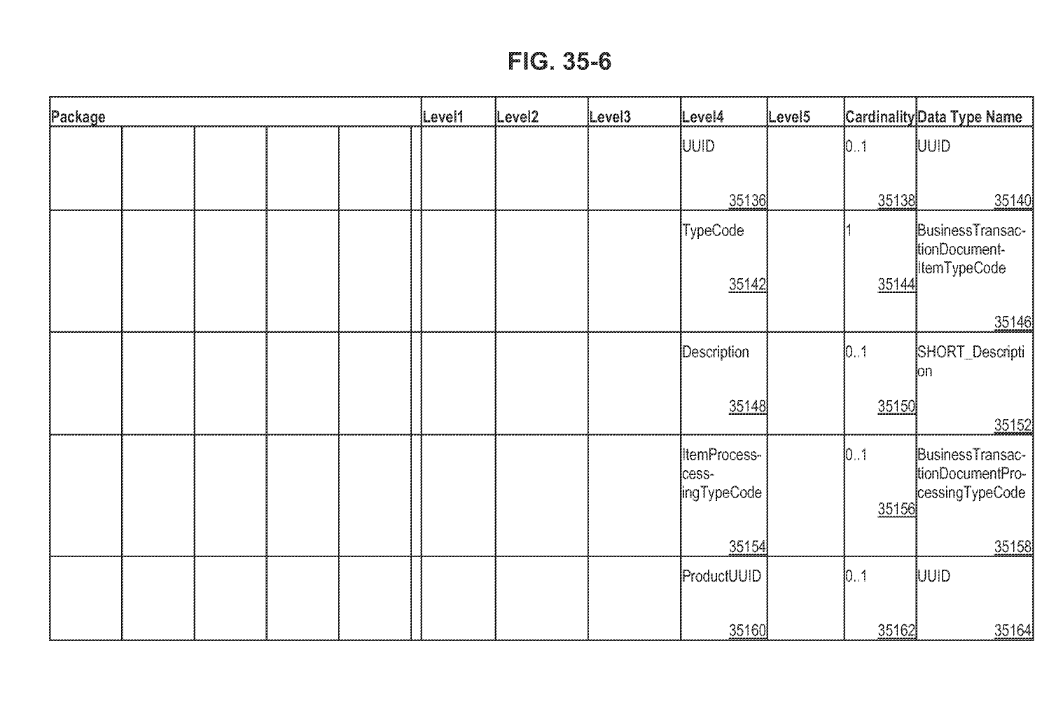

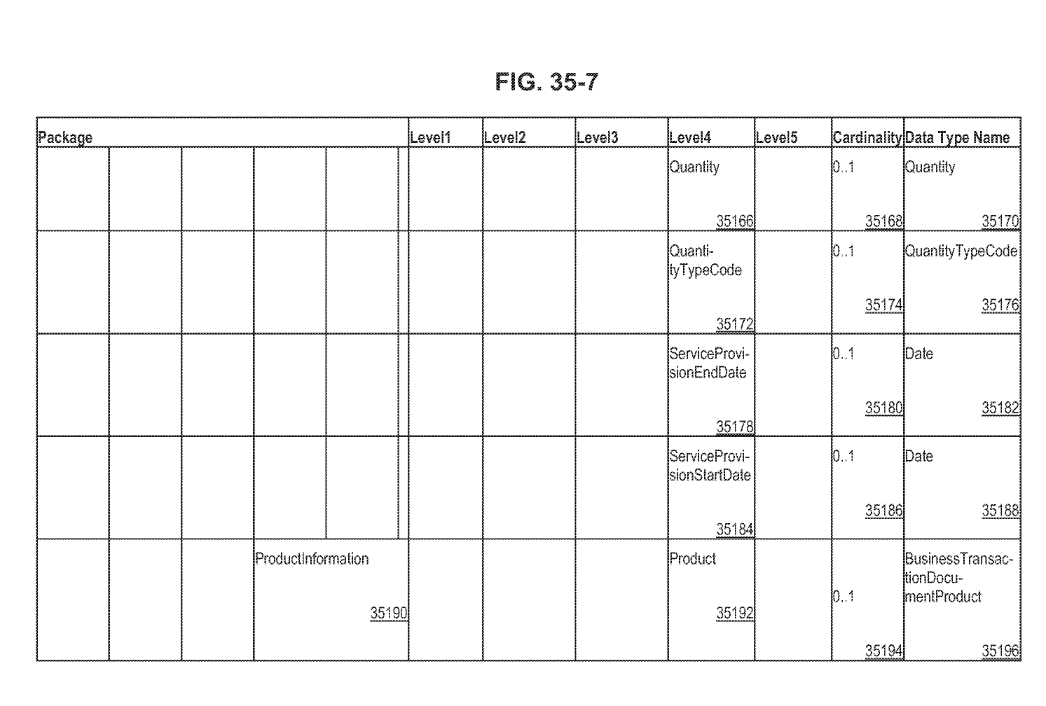

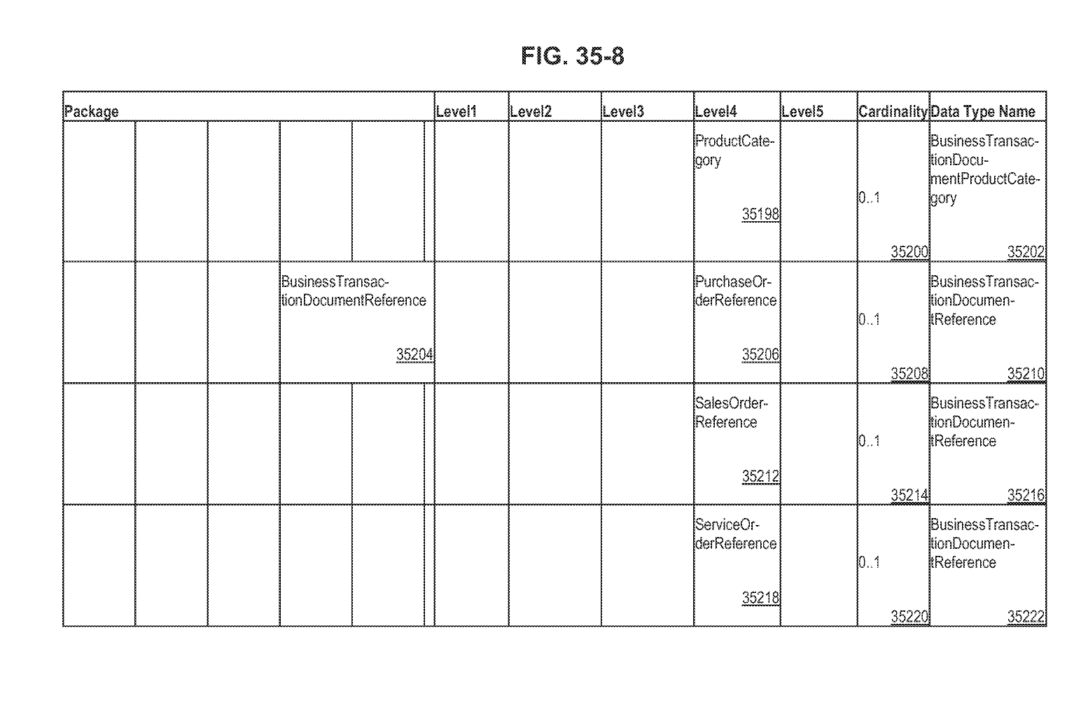

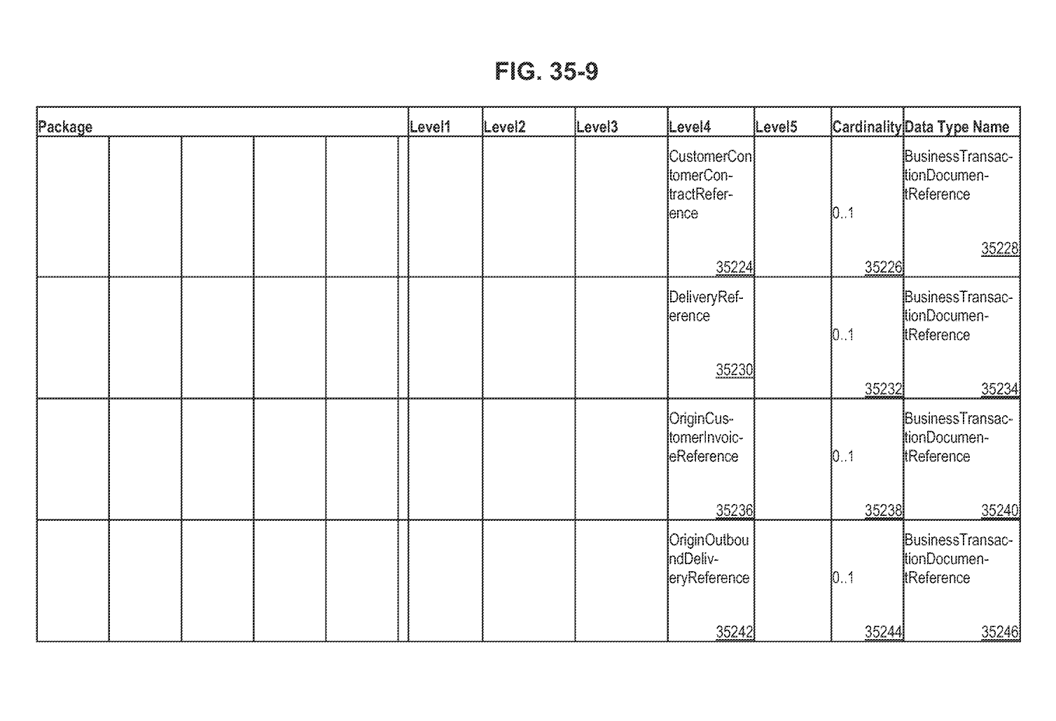

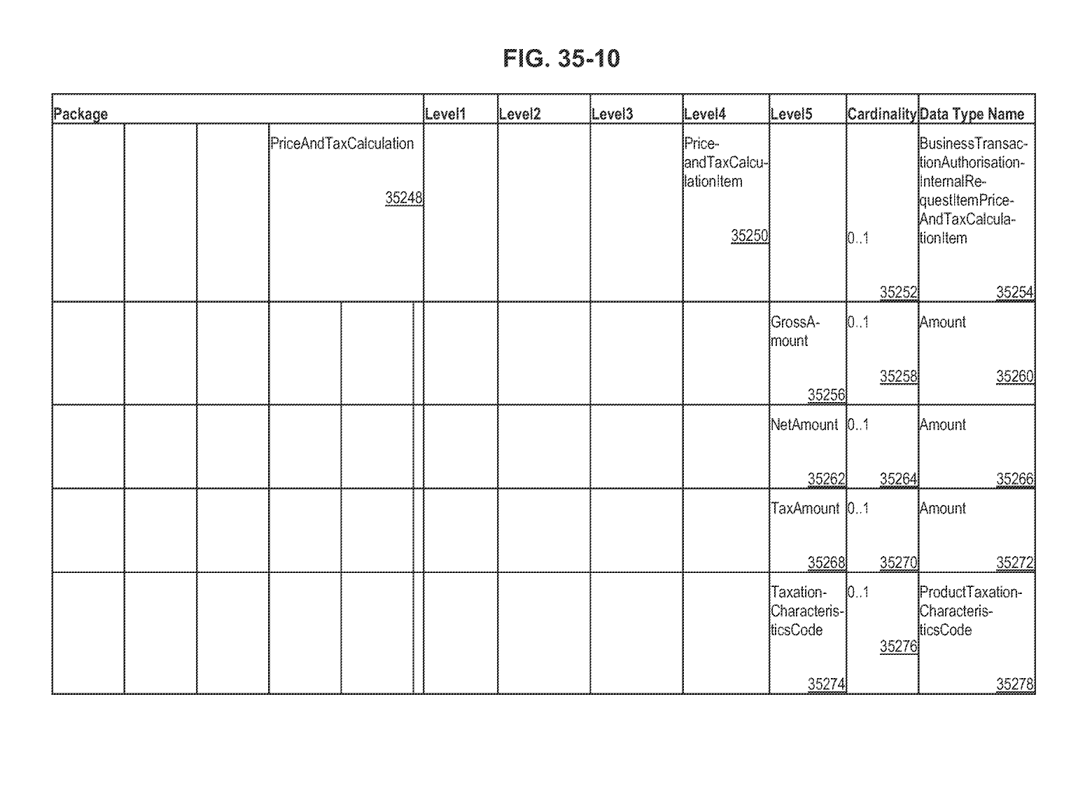

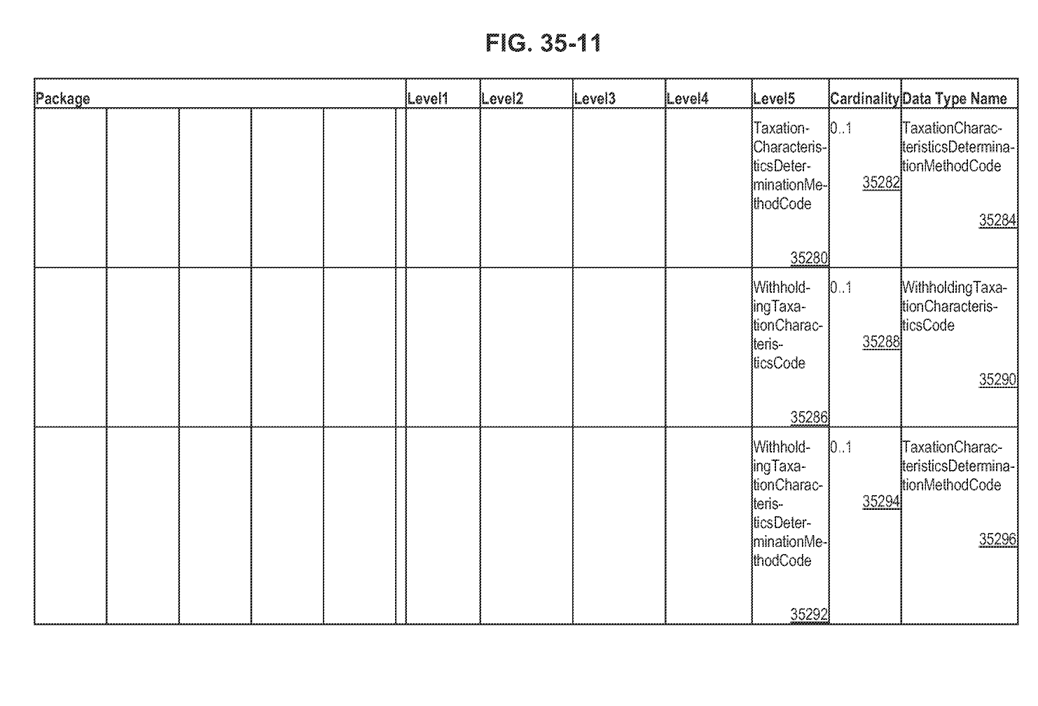

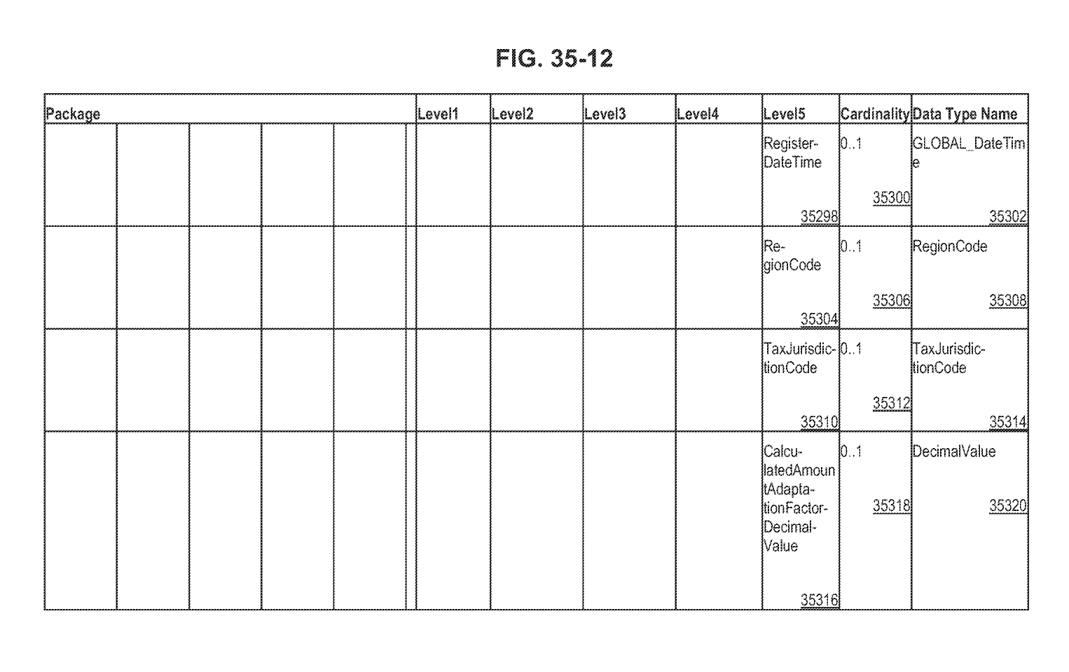

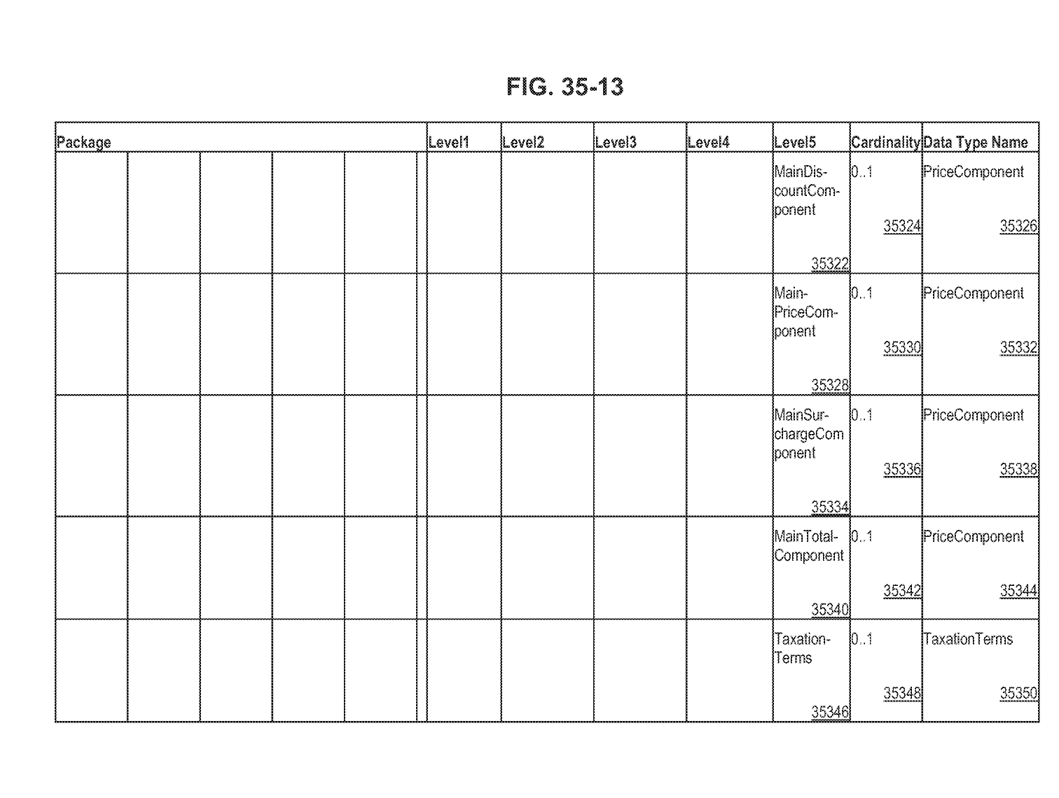

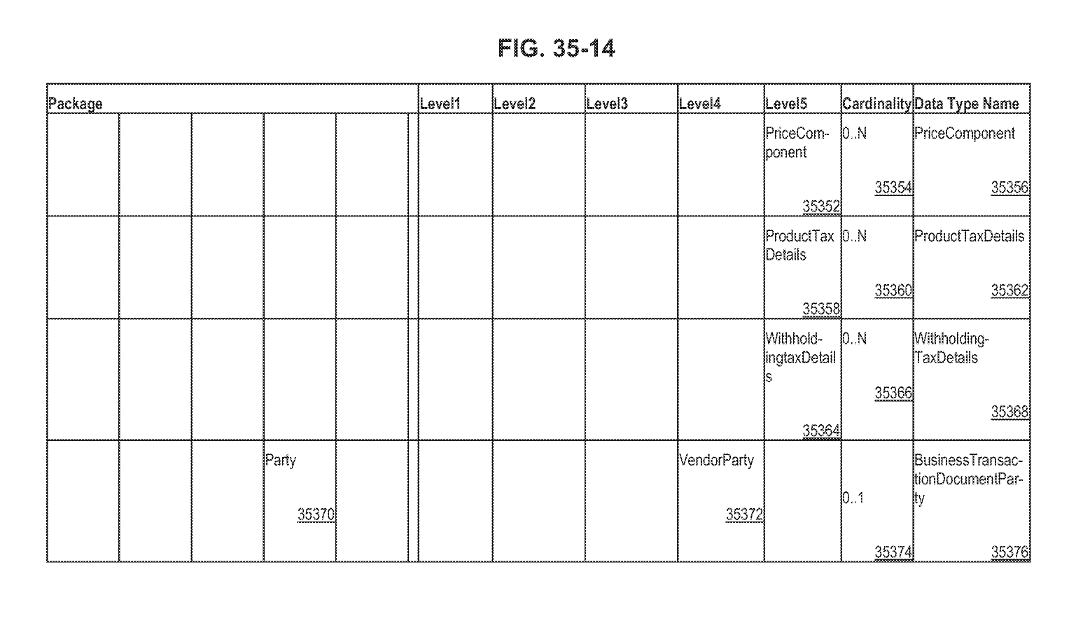

FIGS. 35-1 through 35-14 show an example configuration of an Element Structure that includes a BusinessTransactionAuthorisationInternalRequest 35000 package. Specifically, these figures depict the arrangement and hierarchy of various components such as one or more levels of packages, entities, and datatypes, shown here as 35000 through 35376. As described above, packages may be used to represent hierarchy levels. Entities are discrete business elements that are used during a business transaction. Data types are used to type object entities and interfaces with a structure. For example, the BusinessTransactionAuthorisationInternalRequest 35000 includes, among other things, a BusinessTransactionAuthorisationInternalRequest 35002. Accordingly, heterogeneous applications may communicate using this consistent message configured as such.

The BusinessTransactionAuthorisationInternalRequest 35000 package is a BusinessTransactionAuthorisationInternalRequestMessage 35004 data type. The BusinessTransactionAuthorisationInternalRequest 35000 package includes a BusinessTransactionAuthorisationInternalRequest 35002 entity. The BusinessTransactionAuthorisationInternalRequest 35000 package includes various packages, namely a MessageHeader 35006 and a BusinessTransactionAuthorisationInternalRequest 35014.

The MessageHeader 35006 package is a BusinessDocumentMessageHeader 35012 data type. The MessageHeader 35006 package includes a MessageHeader 35008 entity. The MessageHeader 35008 entity has a cardinality of 1 35010 meaning that for each instance of the MessageHeader 35006 package there is one MessageHeader 35008 entity.

The BusinessTransactionAuthorisationInternalRequest 35014 package is a BusinessTransactionAuthorisationInternalRequest 35020 data type. The BusinessTransactionAuthorisationInternalRequest 35014 package includes a BusinessTransactionAuthorisationInternalRequest 35016 entity. The BusinessTransactionAuthorisationInternalRequest 35014 package includes various packages, namely a Party 35100, a CashDiscountTerms 35114 and an Item 35122.

The BusinessTransactionAuthorisationInternalRequest 35016 entity has a cardinality of 1 35018 meaning that for each instance of the BusinessTransactionAuthorisationInternalRequest 35014 package there is one BusinessTransactionAuthorisationInternalRequest 35016 entity. The BusinessTransactionAuthorisationInternalRequest 35016 entity includes various attributes, namely a ReconciliationPeriodCounterValue 35022, a BaseBusinessTransactionDocumentID 35028, a BaseBusinessTransactionDocumentUUID 35034, a BaseBusinessTransactionDocumentTypeCode 35040, a ProcessingTypeCode 35046, a CreationDate 35052, a CreationDateTime 35058, a CancellationDocumentIndicator 35064, a TotalGrossAmount 35070, a TotalNetAmount 35076, a TotalTaxAmount 35082, a TotalDiscountAmount 35088 and a SellerRegistrationCountryCode 35094.

The ReconciliationPeriodCounterValue 35022 attribute is a CounterValue 35026 data type. The ReconciliationPeriodCounterValue 35022 attribute has a cardinality of 0 . . . 1 35024 meaning that for each instance of the BusinessTransactionAuthorisationInternalRequest 35016 entity there may be one ReconciliationPeriodCounterValue 35022 attribute. The BaseBusinessTransactionDocumentID 35028 attribute is a BusinessTransactionDocumentID 35032 data type. The BaseBusinessTransactionDocumentID 35028 attribute has a cardinality of 1 35030 meaning that for each instance of the BusinessTransactionAuthorisationInternalRequest 35016 entity there is one BaseBusinessTransactionDocumentID 35028 attribute.

The BaseBusinessTransactionDocumentUUID 35034 attribute is an UUID 35038 data type. The BaseBusinessTransactionDocumentUUID 35034 attribute has a cardinality of 0 . . . 1 35036 meaning that for each instance of the BusinessTransactionAuthorisationInternalRequest 35016 entity there may be one BaseBusinessTransactionDocumentUUID 35034 attribute. The BaseBusinessTransactionDocumentTypeCode 35040 attribute is a BusinessTransactionDocumentTypeCode 35044 data type. The BaseBusinessTransactionDocumentTypeCode 35040 attribute has a cardinality of 0 . . . 1 35042 meaning that for each instance of the BusinessTransactionAuthorisationInternalRequest 35016 entity there may be one BaseBusinessTransactionDocumentTypeCode 35040 attribute.

The ProcessingTypeCode 35046 attribute is a BusinessTransactionDocumentProcessingTypeCode 35050 data type. The ProcessingTypeCode 35046 attribute has a cardinality of 0 . . . 1 35048 meaning that for each instance of the BusinessTransactionAuthorisationInternalRequest 35016 entity there may be one ProcessingTypeCode 35046 attribute. The CreationDate 35052 attribute is a Date 35056 data type. The CreationDate 35052 attribute has a cardinality of 1 35054 meaning that for each instance of the BusinessTransactionAuthorisationInternalRequest 35016 entity there is one CreationDate 35052 attribute.

The CreationDateTime 35058 attribute is a GLOBAL_DateTime 35062 data type. The CreationDateTime 35058 attribute has a cardinality of 0 . . . 1 35060 meaning that for each instance of the BusinessTransactionAuthorisationInternalRequest 35016 entity there may be one CreationDateTime 35058 attribute. The CancellationDocumentIndicator 35064 attribute is an Indicator 35068 data type. The CancellationDocumentIndicator 35064 attribute has a cardinality of 0 . . . 1 35066 meaning that for each instance of the BusinessTransactionAuthorisationInternalRequest 35016 entity there may be one CancellationDocumentIndicator 35064 attribute.

The TotalGrossAmount 35070 attribute is an Amount 35074 data type. The TotalGrossAmount 35070 attribute has a cardinality of 0 . . . 1 35072 meaning that for each instance of the BusinessTransactionAuthorisationInternalRequest 35016 entity there may be one TotalGrossAmount 35070 attribute. The TotalNetAmount 35076 attribute is an Amount 35080 data type. The TotalNetAmount 35076 attribute has a cardinality of 0 . . . 1 35078 meaning that for each instance of the BusinessTransactionAuthorisationInternalRequest 35016 entity there may be one TotalNetAmount 35076 attribute.

The TotalTaxAmount 35082 attribute is an Amount 35086 data type. The TotalTaxAmount 35082 attribute has a cardinality of 0 . . . 1 35084 meaning that for each instance of the BusinessTransactionAuthorisationInternalRequest 35016 entity there may be one TotalTaxAmount 35082 attribute. The TotalDiscountAmount 35088 attribute is an Amount 35092 data type. The TotalDiscountAmount 35088 attribute has a cardinality of 0 . . . 1 35090 meaning that for each instance of the BusinessTransactionAuthorisationInternalRequest 35016 entity there may be one TotalDiscountAmount 35088 attribute. The SellerRegistrationCountryCode 35094 attribute is a CountryCode 35098 data type. The SellerRegistrationCountryCode 35094 attribute has a cardinality of 0 . . . 1 35096 meaning that for each instance of the BusinessTransactionAuthorisationInternalRequest 35016 entity there may be one SellerRegistrationCountryCode 35094 attribute.

The Party 35100 package is a BusinessTransactionAuthorisationInternalRequestBusinessTransactionDocumentParty 35106 data type. The Party 35100 package includes various entities, namely a BuyerParty 35102 and a SellerParty 35108. The BuyerParty 35102 entity has a cardinality of 1 35104 meaning that for each instance of the Party 35100 package there is one BuyerParty 35102 entity. The SellerParty 35108 entity has a cardinality of 1 35110 meaning that for each instance of the Party 35100 package there is one SellerParty 35108 entity.

The CashDiscountTerms 35114 package is a CashDiscountTerms 35120 data type. The CashDiscountTerms 35114 package includes a CashDiscountTerms 35116 entity. The CashDiscountTerms 35116 entity has a cardinality of 0 . . . 1 35118 meaning that for each instance of the CashDiscountTerms 35114 package there may be one CashDiscountTerms 35116 entity.

The Item 35122 package is a BusinessTransactionAuthorisationInternalRequestItem 35128 data type. The Item 35122 package includes a BusinessTransactionAuthorisationInternalRequestItem 35124 entity. The Item 35122 package includes various packages, namely a ProductInformation 35190, a BusinessTransactionDocumentReference 35204, a PriceAndTaxCalculation 35248 and a Party 35370. The BusinessTransactionAuthorisationInternalRequestItem 35124 entity has a cardinality of 1 . . . N 35126 meaning that for each instance of the Item 35122 package there are one or more BusinessTransactionAuthorisationInternalRequestItem 35124 entities. The BusinessTransactionAuthorisationInternalRequestItem 35124 entity includes various attributes, namely an ID 35130, an UUID 35136, a TypeCode 35142, a Description 35148, an ItemProcessingTypeCode 35154, a ProductUUID 35160, a Quantity 35166, a QuantityTypeCode 35172, a ServiceProvisionEndDate 35178 and a ServiceProvisionStartDate 35184.

The ID 35130 attribute is a BusinessTransactionDocumentItemID 35134 data type. The ID 35130 attribute has a cardinality of 1 35132 meaning that for each instance of the BusinessTransactionAuthorisationInternalRequestItem 35124 entity there is one ID 35130 attribute. The UUID 35136 attribute is an UUID 35140 data type. The UUID 35136 attribute has a cardinality of 0 . . . 1 35138 meaning that for each instance of the BusinessTransactionAuthorisationInternalRequestItem 35124 entity there may be one UUID 35136 attribute.

The TypeCode 35142 attribute is a BusinessTransactionDocumentItemTypeCode 35146 data type. The TypeCode 35142 attribute has a cardinality of 1 35144 meaning that for each instance of the BusinessTransactionAuthorisationInternalRequestItem 35124 entity there is one TypeCode 35142 attribute. The Description 35148 attribute is a SHORT_Description 35152 data type. The Description 35148 attribute has a cardinality of 0 . . . 1 35150 meaning that for each instance of the BusinessTransactionAuthorisationInternalRequestItem 35124 entity there may be one Description 35148 attribute.

The ItemProcessingTypeCode 35154 attribute is a BusinessTransactionDocumentProcessingTypeCode 35158 data type. The ItemProcessingTypeCode 35154 attribute has a cardinality of 0 . . . 1 35156 meaning that for each instance of the BusinessTransactionAuthorisationInternalRequestItem 35124 entity there may be one ItemProcessingTypeCode 35154 attribute. The ProductUUID 35160 attribute is an UUID 35164 data type. The ProductUUID 35160 attribute has a cardinality of 0 . . . 1 35162 meaning that for each instance of the BusinessTransactionAuthorisationInternalRequestItem 35124 entity there may be one ProductUUID 35160 attribute.

The Quantity 35166 attribute is a Quantity 35170 data type. The Quantity 35166 attribute has a cardinality of 0 . . . 1 35168 meaning that for each instance of the BusinessTransactionAuthorisationInternalRequestItem 35124 entity there may be one Quantity 35166 attribute. The QuantityTypeCode 35172 attribute is a QuantityTypeCode 35176 data type. The QuantityTypeCode 35172 attribute has a cardinality of 0 . . . 1 35174 meaning that for each instance of the BusinessTransactionAuthorisationInternalRequestItem 35124 entity there may be one QuantityTypeCode 35172 attribute.

The ServiceProvisionEndDate 35178 attribute is a Date 35182 data type. The ServiceProvisionEndDate 35178 attribute has a cardinality of 0 . . . 1 35180 meaning that for each instance of the BusinessTransactionAuthorisationInternalRequestItem 35124 entity there may be one ServiceProvisionEndDate 35178 attribute. The ServiceProvisionStartDate 35184 attribute is a Date 35188 data type. The ServiceProvisionStartDate 35184 attribute has a cardinality of 0 . . . 1 35186 meaning that for each instance of the BusinessTransactionAuthorisationInternalRequestItem 35124 entity there may be one ServiceProvisionStartDate 35184 attribute.

The ProductInformation 35190 package is a BusinessTransactionDocumentProduct 35196 data type. The ProductInformation 35190 package includes various entities, namely a Product 35192 and a ProductCategory 35198. The Product 35192 entity has a cardinality of 0 . . . 1 35194 meaning that for each instance of the ProductInformation 35190 package there may be one Product 35192 entity. The ProductCategory 35198 entity has a cardinality of 0 . . . 1 35200 meaning that for each instance of the ProductInformation 35190 package there may be one ProductCategory 35198 entity.

The BusinessTransactionDocumentReference 35204 package is a BusinessTransactionDocumentReference 35210 data type. The BusinessTransactionDocumentReference 35204 package includes various entities, namely a PurchaseOrderReference 35206, a SalesOrderReference 35212, a ServiceOrderReference 35218, a CustomerContractReference 35224, a DeliveryReference 35230, an OriginCustomerInvoiceReference 35236 and an OriginOutboundDeliveryReference 35242. The PurchaseOrderReference 35206 entity has a cardinality of 0 . . . 1 35208 meaning that for each instance of the BusinessTransactionDocumentReference 35204 package there may be one PurchaseOrderReference 35206 entity. The SalesOrderReference 35212 entity has a cardinality of 0 . . . 1 35214 meaning that for each instance of the BusinessTransactionDocumentReference 35204 package there may be one SalesOrderReference 35212 entity.

The ServiceOrderReference 35218 entity has a cardinality of 0 . . . 1 35220 meaning that for each instance of the BusinessTransactionDocumentReference 35204 package there may be one ServiceOrderReference 35218 entity. The CustomerContractReference 35224 entity has a cardinality of 0 . . . 1 35226 meaning that for each instance of the BusinessTransactionDocumentReference 35204 package there may be one CustomerContractReference 35224 entity. The DeliveryReference 35230 entity has a cardinality of 0 . . . 1 35232 meaning that for each instance of the BusinessTransactionDocumentReference 35204 package there may be one DeliveryReference 35230 entity. The OriginCustomerInvoiceReference 35236 entity has a cardinality of 0 . . . 1 35238 meaning that for each instance of the BusinessTransactionDocumentReference 35204 package there may be one OriginCustomerInvoiceReference 35236 entity. The OriginOutboundDeliveryReference 35242 entity has a cardinality of 0 . . . 1 35244 meaning that for each instance of the BusinessTransactionDocumentReference 35204 package there may be one OriginOutboundDeliveryReference 35242 entity.

The PriceAndTaxCalculation 35248 package is a BusinessTransactionAuthorisationInternalRequestItemPriceAndTaxCalculationItem 35254 data type. The PriceAndTaxCalculation 35248 package includes a PriceandTaxCalculationitem 35250 entity. The PriceandTaxCalculationitem 35250 entity has a cardinality of 0 . . . 1 35252 meaning that for each instance of the PriceAndTaxCalculation 35248 package there may be one PriceandTaxCalculationitem 35250 entity. The PriceandTaxCalculationitem 35250 entity includes various attributes, namely a GrossAmount 35256, a NetAmount 35262, a TaxAmount 35268, a TaxationCharacteristicsCode 35274, a TaxationCharacteristiesDeterminationMethodCode 35280, a WithholdingTaxationCharacteristicsCode 35286, a WithholdingTaxationCharacteristicsDeterminationMethodCode 35292, a RegisterDateTime 35298, a RegionCode 35304, a TaxJurisdictionCode 35310, a CalculatedAmountAdaptationFactorDecimalValue 35316, a MainDiscountComponent 35322, a MainPriceComponent 35328, a MainSurchargeComponent 35334, a MainTotalComponent 35340, a TaxationTerms 35346, a PriceComponent 35352, a ProductTaxDetails 35358 and a WithholdingTaxDetails 35364.

The GrossAmount 35256 attribute is an Amount 35260 data type. The GrossAmount 35256 attribute has a cardinality of 0 . . . 1 35258 meaning that for each instance of the PriceandTaxCalculationitem 35250 entity there may be one GrossAmount 35256 attribute. The NetAmount 35262 attribute is an Amount 35266 data type. The NetAmount 35262 attribute has a cardinality of 0 . . . 1 35264 meaning that for each instance of the PriceandTaxCalculationitem 35250 entity there may be one NetAmount 35262 attribute.

The TaxAmount 35268 attribute is an Amount 35272 data type. The TaxAmount 35268 attribute has a cardinality of 0 . . . 1 35270 meaning that for each instance of the PriceandTaxCalculationitem 35250 entity there may be one TaxAmount 35268 attribute. The TaxationCharacteristicsCode 35274 attribute is a ProductTaxationCharacteristicsCode 35278 data type. The TaxationCharacteristicsCode 35274 attribute has a cardinality of 0 . . . 1 35276 meaning that for each instance of the PriceandTaxCalculationitem 35250 entity there may be one TaxationCharacteristicsCode 35274 attribute.

The TaxationCharacteristicsDeterminationMethodCode 35280 attribute is a TaxationCharacteristicsDeterminationMethodCode 35284 data type. The TaxationCharacteristicsDeterminationMethodCode 35280 attribute has a cardinality of 0 . . . 1 35282 meaning that for each instance of the PriceandTaxCalculationitem 35250 entity there may be one TaxationCharacteristicsDeterminationMethodCode 35280 attribute. The WithholdingTaxationCharacteristicsCode 35286 attribute is a WithholdingTaxationCharacteristicsCode 35290 data type. The WithholdingTaxationCharacteristicsCode 35286 attribute has a cardinality of 0 . . . 1 35288 meaning that for each instance of the PriceandTaxCalculationitem 35250 entity there may be one WithholdingTaxationCharacteristicsCode 35286 attribute.

The WithholdingTaxationCharacteristicsDeterminationMethodCode 35292 attribute is a TaxationCharacteristicsDeterminationMethodCode 35296 data type. The WithholdingTaxationCharacteristicsDeterminationMethodCode 35292 attribute has a cardinality of 0 . . . 1 35294 meaning that for each instance of the PriceandTaxCalculationitem 35250 entity there may be one WithholdingTaxationCharacteristicsDeterminationMethodCode 35292 attribute. The RegisterDateTime 35298 attribute is a GLOBAL_DateTime 35302 data type. The RegisterDateTime 35298 attribute has a cardinality of 0 . . . 1 35300 meaning that for each instance of the PriceandTaxCalculationitem 35250 entity there may be one RegisterDateTime 35298 attribute.

The RegionCode 35304 attribute is a RegionCode 35308 data type. The RegionCode 35304 attribute has a cardinality of 0 . . . 1 35306 meaning that for each instance of the PriceandTaxCalculationitem 35250 entity there may be one RegionCode 35304 attribute. The TaxJurisdictionCode 35310 attribute is a TaxJurisdictionCode 35314 data type. The TaxJurisdictionCode 35310 attribute has a cardinality of 0 . . . 1 35312 meaning that for each instance of the PriceandTaxCalculationitem 35250 entity there may be one TaxJurisdictionCode 35310 attribute.

The CalculatedAmountAdaptationFactorDecimalValue 35316 attribute is a DecimalValue 35320 data type. The CalculatedAmountAdaptationFactorDecimalValue 35316 attribute has a cardinality of 0 . . . 1 35318 meaning that for each instance of the PriceandTaxCalculationitem 35250 entity there may be one CalculatedAmountAdaptationFactorDecimalValue 35316 attribute. The MainDiscountComponent 35322 attribute is a PriceComponent 35326 data type. The MainDiscountComponent 35322 attribute has a cardinality of 0 . . . 1 35324 meaning that for each instance of the PriceandTaxCalculationitem 35250 entity there may be one MainDiscountComponent 35322 attribute.

The MainPriceComponent 35328 attribute is a PriceComponent 35332 data type. The MainPriceComponent 35328 attribute has a cardinality of 0 . . . 1 35330 meaning that for each instance of the PriceandTaxCalculationitem 35250 entity there may be one MainPriceComponent 35328 attribute. The MainSurchargeComponent 35334 attribute is a PriceComponent 35338 data type. The MainSurchargeComponent 35334 attribute has a cardinality of 0 . . . 1 35336 meaning that for each instance of the PriceandTaxCalculationitem 35250 entity there may be one MainSurchargeComponent 35334 attribute.

The MainTotalComponent 35340 attribute is a PriceComponent 35344 data type. The MainTotalComponent 35340 attribute has a cardinality of 0 . . . 1 35342 meaning that for each instance of the PriceandTaxCalculationitem 35250 entity there may be one MainTotalComponent 35340 attribute. The TaxationTerms 35346 attribute is a TaxationTerms 35350 data type. The TaxationTerms 35346 attribute has a cardinality of 0 . . . 1 35348 meaning that for each instance of the PriceandTaxCalculationitem 35250 entity there may be one TaxationTerms 35346 attribute.

The PriceComponent 35352 attribute is a PriceComponent 35356 data type. The PriceComponent 35352 attribute has a cardinality of 0 . . . N 35354 meaning that for each instance of the PriceandTaxCalculationitem 35250 entity there may be one or more PriceComponent 35352 attributes. The ProductTaxDetails 35358 attribute is a ProductTaxDetails 35362 data type. The ProductTaxDetails 35358 attribute has a cardinality of 0 . . . N 35360 meaning that for each instance of the PriceandTaxCalculationitem 35250 entity there may be one or more ProductTaxDetails 35358 attributes. The WithholdingTaxDetails 35364 attribute is a WithholdingTaxDetails 35368 data type. The WithholdingTaxDetails 35364 attribute has a cardinality of 0 . . . N 35366 meaning that for each instance of the PriceandTaxCalculationitem 35250 entity there may be one or more WithholdingTaxDetails 35364 attributes.

The Party 35370 package is a BusinessTransactionDocumentParty 35376 data type. The Party 35370 package includes a VendorParty 35372 entity. The VendorParty 35372 entity has a cardinality of 0 . . . 1 35374 meaning that for each instance of the Party 35370 package there may be one VendorParty 35372 entity.

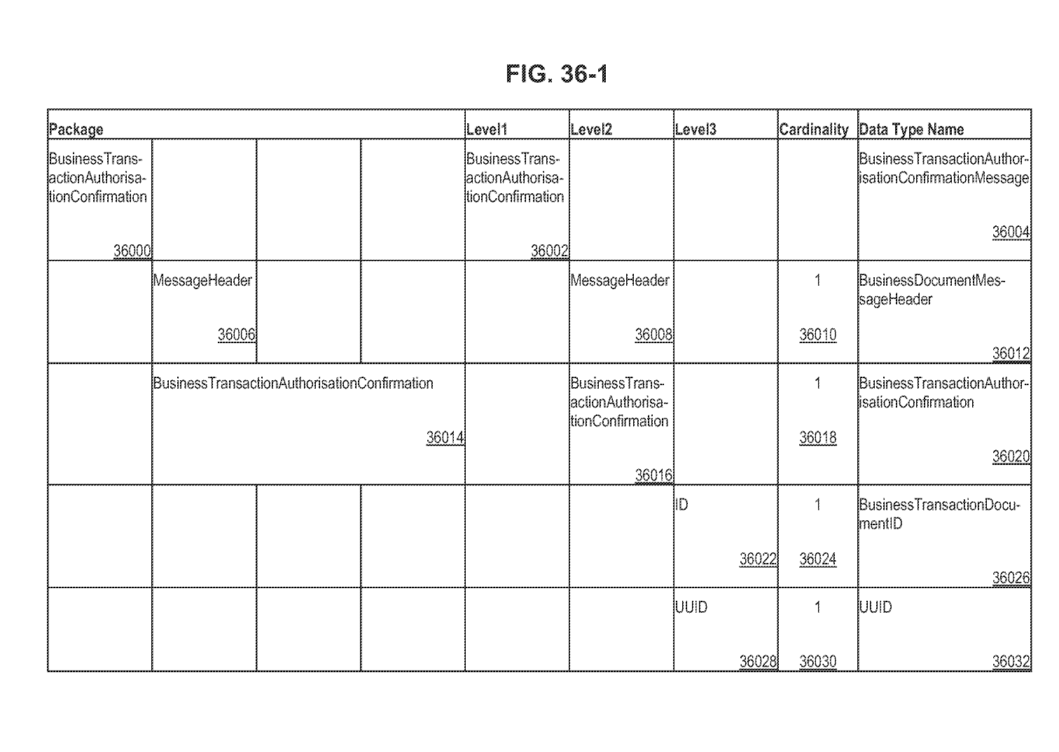

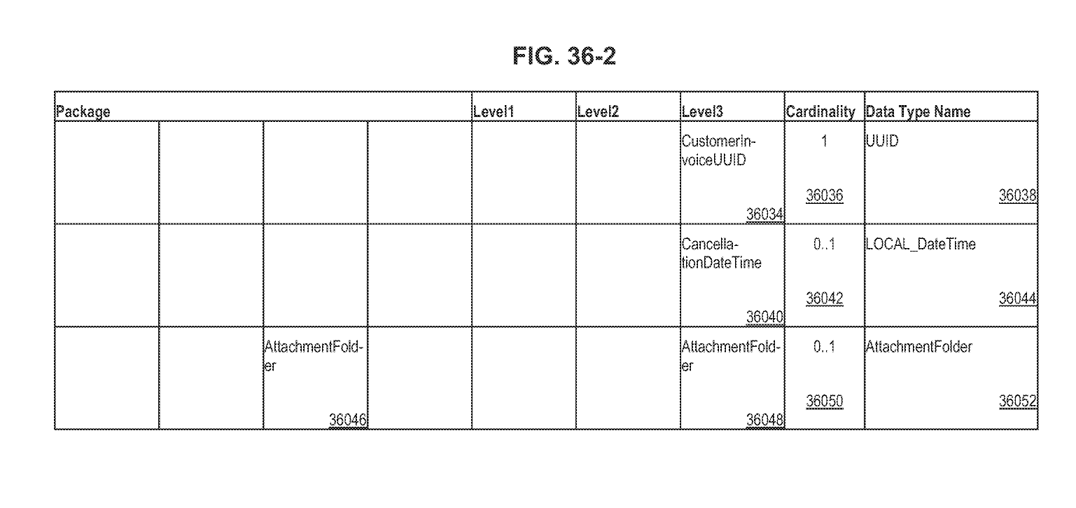

FIGS. 36-1 through 36-2 show an example configuration of an Element Structure that includes a BusinessTransactionAuthorisationConfirmation 36000 package. Specifically, these figures depict the arrangement and hierarchy of various components such as one or more levels of packages, entities, and datatypes, shown here as 36000 through 36052. As described above, packages may be used to represent hierarchy levels. Entities are discrete business elements that are used during a business transaction. Data types are used to type object entities and interfaces with a structure. For example, the BusinessTransactionAuthorisationConfirmation 36000 includes, among other things, a BusinessTransactionAuthorisationConfirmation 36002. Accordingly, heterogeneous applications may communicate using this consistent message configured as such.

The BusinessTransactionAuthorisationConfirmation 36000 package is a BusinessTransactionAuthorisationConfirmationMessage 36004 data type. The BusinessTransactionAuthorisationConfirmation 36000 package includes a BusinessTransactionAuthorisationConfirmation 36002 entity. The BusinessTransactionAuthorisationConfirmation 36000 package includes various packages, namely a MessageHeader 36006 and a BusinessTransactionAuthorisationConfirmation 36014.

The MessageHeader 36006 package is a BusinessDocumentMessageHeader 36012 data type. The MessageHeader 36006 package includes a MessageHeader 36008 entity. The MessageHeader 36008 entity has a cardinality of 1 36010 meaning that for each instance of the MessageHeader 36006 package there is one MessageHeader 36008 entity.

The BusinessTransactionAuthorisationConfirmation 36014 package is a BusinessTransactionAuthorisationConfirmation 36020 data type. The BusinessTransactionAuthorisationConfirmation 36014 package includes a BusinessTransactionAuthorisationConfirmation 36016 entity. The BusinessTransactionAuthorisationConfirmation 36014 package includes an AttachmentFolder 36046 package. The BusinessTransactionAuthorisationConfirmation 36016 entity has a cardinality of 1 36018 meaning that for each instance of the BusinessTransactionAuthorisationConfirmation 36014 package there is one BusinessTransactionAuthorisationConfirmation 36016 entity. The BusinessTransactionAuthorisationConfirmation 36016 entity includes various attributes, namely an ID 36022, an UUID 36028, a CustomerInvoiceUUID 36034 and a CancellationDateTime 36040.

The ID 36022 attribute is a BusinessTransactionDocumentID 36026 data type. The ID 36022 attribute has a cardinality of 1 36024 meaning that for each instance of the BusinessTransactionAuthorisationConfirmation 36016 entity there is one ID 36022 attribute. The UUID 36028 attribute is an UUID 36032 data type. The UUID 36028 attribute has a cardinality of 1 36030 meaning that for each instance of the BusinessTransactionAuthorisationConfirmation 36016 entity there is one UUID 36028 attribute. The CustomerInvoiceUUID 36034 attribute is an UUID 36038 data type. The CustomerInvoiceUUID 36034 attribute has a cardinality of 1 36036 meaning that for each instance of the BusinessTransactionAuthorisationConfirmation 36016 entity there is one CustomerInvoiceUUID 36034 attribute. The CancellationDateTime 36040 attribute is a LOCAL_DateTime 36044 data type. The CancellationDateTime 36040 attribute has a cardinality of 0 . . . 1 36042 meaning that for each instance of the BusinessTransactionAuthorisationConfirmation 36016 entity there may be one CancellationDateTime 36040 attribute.

The AttachmentFolder 36046 package is an AttachmentFolder 36052 data type. The AttachmentFolder 36046 package includes an AttachmentFolder 36048 entity. The AttachmentFolder 36048 entity has a cardinality of 0 . . . 1 36050 meaning that for each instance of the AttachmentFolder 36046 package there may be one AttachmentFolder 36048 entity.

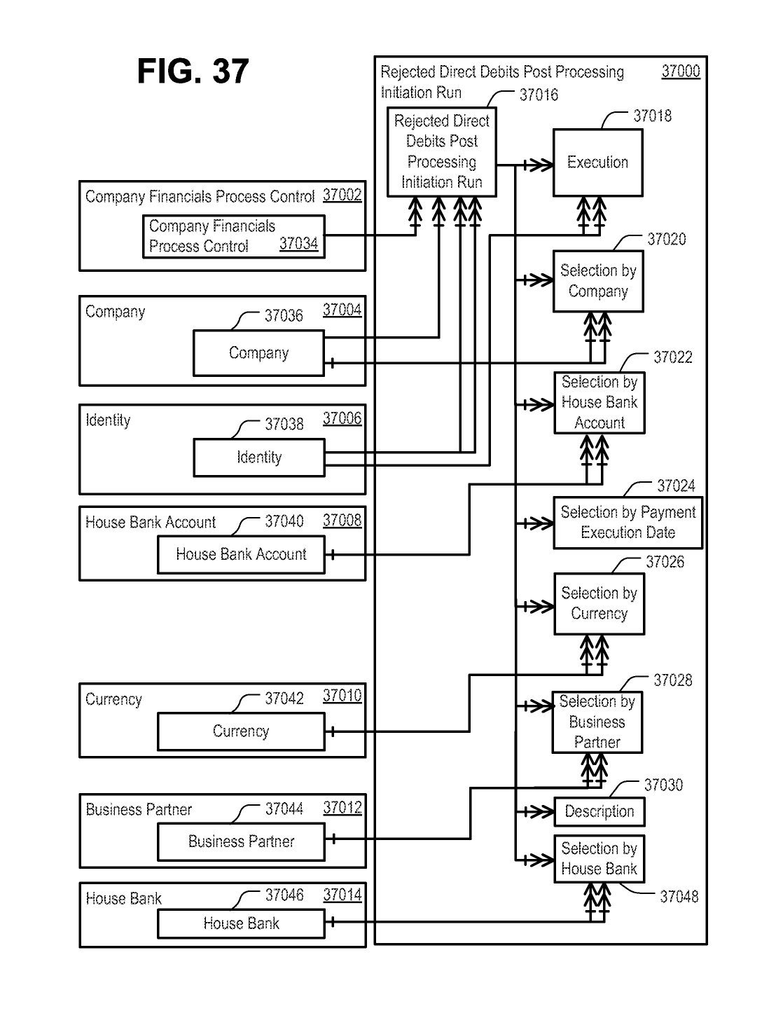

FIG. 37 illustrates an example object model for a Rejected Direct Debits Post Processing Initiation Run business object 37000. Specifically, the object model depicts interactions among various components of the Rejected Direct Debits Post Processing Initiation Run business object 37000, as well as external components that interact with the Rejected Direct Debits Post Processing Initiation Run business object 37000 (shown here as 37002 through 37014 and 37034 through 37046). The Rejected Direct Debits Post Processing Initiation Run business object 37000 includes elements 37016 through 37032 that can be hierarchical, as depicted. For example, Rejected Direct Debits Post Processing Initiation Run entity 37016 hierarchically includes zero or more Execution entities 37018, zero or more Selection by Company entities 37020, zero or more Selection by House Bank Account entities 37022, zero or more Selection by Payment Execution Date entities 37024, zero or more Selection by Currency entities 37026, zero or more Selection by Business Partner entities 37028, zero or more Description entities 37030, zero or more House Bank entities 37032. Some or all of the entities 37016 through 37032 can correspond to packages and/or entities in the message data types described below.

The business object Rejected Direct Debits Post Processing Initiation Run is a specification for and the execution of an automated run that identifies unrealized direct debit receivables in the system and triggers a Reject action. The triggering of the Reject action initiates a creation of a business task for the post processing of unrealized payments. The Rejected Direct Debits Post Processing Initiation Run business object belongs to the process component Payment Processing. The Rejected Direct Debits Post Processing Initiation Run business object belongs to the deployment unit Financials. A Rejected Direct Debits Post Processing Initiation Run includes criteria for the selection of bank transfers to be processed. The business object Rejected Direct Debits Post Processing Initiation Run has an object category of Mass Data Run Object and a technical category of Standard Business Object.

The business object Rejected Direct Debits Post Processing Initiation Run has a Root node. The Root node includes a natural-language description of the Mass Data Run Object, criteria for selecting direct debits to be processed, and information regarding the execution of a Rejected Direct Debits Post Processing Initiation Run mass data run object. The elements located directly at the node Root are defined by the inline structure: GLO_REJDD_POSTPROC_IR_EL. These elements include: UUID, CompanyUUID, ID, MassDataRunObjectTypeCode, SystemAdministrativeData, and Status. UUID may be optional, may be an alternative key, is a universally unique identifier for a rejected direct debits post-processing initiation run business object, and may be based on datatype GDT: UUID. CompanyUUID is a universally unique identifier for a selected company that controls one or more financial processes involved in a rejected direct debits post processing initiation run, and may be based on datatype GDT: UUID. ID may be an alternative key, is an identifier for a rejected direct debits post-processing initiation run, and may be based on datatype GDT: MassDataRunObjectID. MassDataRunObjectTypeCode may be optional, is a coded representation of a type of a mass data run object, and may be based on datatype GDT: MassDataRunObjectTypeCode. SystemAdministrativeData includes administrative data about a rejected direct debits post-processing initiation run, such as system users and change dates/times, and may be based on datatype GDT: SystemAdministrativeData. Status is a status of a rejected direct debits post-processing initiation run, and may be based on datatype BOIDT: RejectionDirectDebitPostProcessingInitiationRunStatus. Status may include Status/LifeCycleStatusCode, which may be based on datatype GDT: MassDataRunObjectLifeCycleStatusCode.

The following composition relationships to subordinate nodes exist: Execution, with a cardinality of 1:CN; Selection by Company, with a cardinality of 1:CN; Selection by House Bank Account, with a cardinality of 1:CN; Selection by Payment Execution Date, with a cardinality of 1:CN; Selection by Currency, with a cardinality of 1:CN; Selection by Business Partner, with a cardinality of 1:CN; Description, with a cardinality of 1:CN, which may be or may include a text composition; and Selection by House Bank, with a cardinality of 1:CN.

The following inbound association relationships may exist: Company Financials Process Control, from the business object Company Financials Process Control/node Company Financials Process Control, with a cardinality of 1:CN; Company, from the business object Company/node Company, with a cardinality of 1:CN; CreationIdentity, from the business object Identity/node Identity, with a cardinality of 1:CN; and LastChangeIdentity, from the business object Identity/node Identity, with a cardinality of 1:CN.

An Execute action starts identification of unrealized payments from direct debits that meet specified selection criteria. The execution of the Execute action triggers an entry to be created in an Execution node, including an instance of the ApplicationLog business object, to document the execution of a Rejected Direct Debits Post Processing Initiation Run. The Execute action can be initiated from a user interface.

A Schedule Directly action schedules a Rejected Direct Debits Post Processing Initiation Run for execution. Preconditions of the Schedule Directly action can include the Mass Data Run Object Life Cycle status being set to Active. Action elements for the Schedule Directly action can include PlannedDateTime, which may be optional and may be based on datatype GDT: GLOBAL_DateTime. The Schedule Directly action can be initiated from a user interface.

A Flag As Obsolete action changes a Mass Data Run Object Life Cycle status of a Rejected Direct Debits Post Processing Initiation Run to Obsolete. The Flag As Obsolete action can be performed automatically.

A Revoke Obsolescence action changes a Mass Data Run Object Life Cycle status of a Rejected Direct Debits Post Processing Initiation Run from Obsolete to In Revision. The Revoke Obsolescence action can be performed automatically.

An Activate action activates a Rejected Direct Debits Post Processing Initiation Run. Preconditions for the Revoke Obsolescence action can include the selection of data to be processed on which the execution is based being entered in full. The Activate action sets a Mass Data Run Object Life Cycle status to Active. The Revoke Obsolescence action can be performed automatically.

An Adjust Responsible Agent And Access Control List action adjusts Responsible Agents and corresponding entries in an Access Control List of an associated Application Log based on current responsibility settings. The Access Control List of an Application Log can receive a new copy of an Access Control List of a Company Financials Process Control associated with an Accounting Adjustment Run. The Adjust Responsible Agent And Access Control List action can be used for adjustments of Responsible Functional Units and an Access Control List resulting from changes in responsibility settings for Functional Units.

A Query By ID query can be used to query instances by an identifier. The query elements are defined by the inline structure GLO_REJDD_PP_QUERY_ID. These elements include: SearchText and ID. SearchText may be based on datatype GDT: SearchText. ID is an identifier for a rejected direct debits post-processing initiation run, and may be based on datatype GDT: MassDataRunObjectID. A Select All query can be used to select all instances of the node.

Execution is a specification of how a rejected direct debits post-processing initiation run has been executed. The elements located directly at the node Execution are defined by the inline structure GLO_REJDD_POSTPROC_IR_EXEC_EL. These elements include: UUID, ID, SystemAdministrativeData, ApplicationLogID, ApplicationLogUUID, BackgroundJobID, and Status. UUID may be an alternative key, is a universally unique identifier for an execution of a rejected direct debits post-processing initiation run, and may be based on datatype GDT: UUID. ID is an identifier for an execution of a rejected direct debits post-processing initiation run, and may be based on datatype GDT: MassDataRunObjectExecutionID. SystemAdministrativeData includes administrative data about an execution of a rejected direct debits post-processing initiation run. This data includes system users and change dates/times, and may be based on datatype GDT: SystemAdministrativeData. ApplicationLogID is an identifier for an application log generated for an instance of a rejected direct debits post-processing initiation run, and may be based on datatype GDT: ApplicationLogID. ApplicationLogUUID is a universally unique identifier for a root node of an application log generated for an instance of a rejected direct debits post processing initiation run, and may be based on datatype GDT: UUID. BackgroundJobID is an identifier for a job scheduled in the background which executes a rejected direct debits post processing initiation run, and may be based on datatype GDT: BackgroundJobID. Status is a status of an execution of a rejected direct debits post processing initiation run, and may be based on datatype BOIDT: RejectedDirectDebitsPostProcessingInitiationRunExecutionStatus. Status can include Status/ProcessingStatusCode, which is a coded representation of a processing status of a rejected direct debits post processing initiation run which may be based on datatype GDT: INPROCESSFINISHED_ProcessingStatusCode.

The following inbound association relationships may exist: CreationIdentity, from the business object Identity/node Identity, with a cardinality of 1:CN, and LastChangeIdentity, from the business object Identity/node Identity, with a cardinality of 1:CN. The following specialization associations for navigation may exist: Application Log, to the business object Application Log/node Application Log, with a target cardinality of C; Parent, to the node Root, with a target cardinality of 1; and Root, to the node Root, with a target cardinality of 1. A Finish action can exist.

A Query By Elements query can be used to return a list of rejected direct debits post-processing initiation runs according to specified selection elements. The query elements are defined by the inline structure GLO_REJDD_PP_INIT_RUN_EXECUTE. These elements include: RejectedDirectDebitsPostProcessingInitiationRunID, ID, UUID, QueryElementSystemAdministrativeData, ApplicationLogID, ApplicationLogUUID, BackgroundJobID, Status, and RejectionDirectDebitPostProcessingInitiationRunStatus. RejectedDirectDebitsPostProcessingInitiationRunID is an identifier for an instance of a rejected direct debits post-processing initiation run, and may be based on datatype GDT: MassDataRunObjectID. UUID is a universally unique identifier for an instance of a rejected direct debits post-processing initiation run, and may be based on datatype GDT: UUID. ID is an identifier for a rejected direct debits post-processing initiation run, and may be based on datatype GDT: MassDataRunObjectExecutionID. QueryElementSystemAdministrativeData includes administrative data about a rejected direct debits post-processing initiation run, such as system users and change dates/times, and may be based on datatype QueryIDT: QueryElementSystemAdministrativeData. QueryElementSystemAdministrativeData may include QueryElementSystemAdministrativeData/CreationDateTime, QueryElementSystemAdministrativeData/CreationIdentityUUID, QueryElementSystemAdministrativeData/CreationIdentityID, QueryElementSystemAdministrativeData/CreationIdentityBusinessPartnerInternalID, QueryElementSystemAdministrativeData/CreationIdentityBusinessPartnerPersonFamilyName, QueryElementSystemAdministrativeData/CreationIdentityBusinessPartnerPersonGivenName, QueryElementSystemAdministrativeData/CreationIdentityEmployeeID, QueryElementSystemAdministrativeData/LastChangeDateTime, QueryElementSystemAdministrativeData/LastChangeIdentityUUID, QueryElementSystemAdministrativeData/LastChangeIdentityID, QueryElementSystemAdministrativeData/LastChangeIdentityBusinessPartnerInternalID, QueryElementSystemAdministrativeData/LastChangeIdentityBusinessPartnerPersonFamilyName, QueryElementSystemAdministrativeData/LastChangeIdentityBusinessPartnerPersonGivenName, and QueryElementSystemAdministrativeData/LastChangeIdentityEmployeeID. QueryElementSystemAdministrativeData/CreationDateTime includes administrative data about a rejected direct debits post-processing initiation run, such as system users and change dates/times, and may be based on datatype GDT: GLOBAL_DateTime. QueryElementSystemAdministrativeData/CreationIdentityUUID is a universally unique identifier for the creator of an instance of a run, and may be based on datatype GDT: UUID. QueryElementSystemAdministrativeData/CreationIdentityID is an identifier for the creator of an instance of a run, and may be based on datatype GDT: IdentityID. QueryElementSystemAdministrativeData/CreationIdentityBusinessPartnerInternalID is an identifier for a business partner who is attributed to a creator of an instance of a run, and may be based on datatype GDT: BusinessPartnerInternalID. QueryElementSystemAdministrativeData/CreationIdentityBusinessPartnerPersonFamilyNam e is a last name of a business partner who is attributed to the creator of an instance of a run, and may be based on datatype GDT: LANGUAGEINDEPENDENT_MEDIUM_Name. QueryElementSystemAdministrativeData/CreationIdentityBusinessPartnerPersonGivenName is a name of a business partner who is attributed to the creator of an instance of a run, and may be based on datatype GDT: LANGUAGEINDEPENDENT_MEDIUM_Name. QueryElementSystemAdministrativeData/CreationIdentityEmployeeID is an identifier for an employee who is attributed to the creator of an instance of a run, and may be based on datatype GDT: EmployeeID. QueryElementSystemAdministrativeData/LastChangeDateTime is a point in time date and time stamp at which a last change was made to an attribute of an instance of a run, and may be based on datatype GDT: GLOBAL_DateTime. QueryElementSystemAdministrativeData/LastChangeIdentityUUID is a universally unique identifier for a party who last changed an attribute of an instance of a run, and may be based on datatype GDT: UUID. QueryElementSystemAdministrativeData/LastChangeIdentityID is an identifier for a party who last changed an attribute of an instance of a run, and may be based on datatype GDT: IdentityID. QueryElementSystemAdministrativeData/LastChangeIdentityBusinessPartnerInternalID is an identifier for a business partner who is attributed to a party who last changed an attribute of an instance of a run, and may be based on datatype GDT: BusinessPartnerInternalID. QueryElementSystemAdministrativeData/LastChangeIdentityBusinessPartnerPerson FamilyName is a last name of a business partner who is attributed to a person who last changed an instance of a run, and may be based on datatype GDT: LANGUAGEINDEPENDENT_MEDIUM_Name. QueryElementSystemAdministrativeData/LastChangeIdentityBusinessPartnerPersonGivenName is a name of a business partner who is attributed to a person who last changed an instance of a run, and may be based on datatype GDT: LANGUAGEINDEPENDENT_MEDIUM_Name. QueryElementSystemAdministrativeData/LastChangeIdentityEmployeeID is an identifier for an employee who is attributed to a person who last changed an instance of a run, and may be based on datatype GDT: EmployeeID. ApplicationLogID is an identifier for an application log of the execution of a rejected direct debits post-processing initiation run, and may be based on datatype GDT: ApplicationLogID. ApplicationLogUUID is a universally unique identifier for an application log of the execution of a rejected direct debits post-processing initiation run, and may be based on datatype GDT: UUID. BackgroundJobID is an identifier for a job scheduled in the background which executes a rejected direct debits post-processing initiation run, and may be based on datatype GDT: BackgroundJobID. Status is a coded representation of the execution status of a rejected direct debits post processing initiation run, and may be based on datatype BOIDT: RejectedDirectDebitsPostProcessingInitiationRunExecutionStatus. Status may include Status/ProcessingStatusCode, which is a coded representation of a processing status of a rejected direct debits post processing initiation run which may be based on datatype GDT: INPROCESSFINISHED_ProcessingStatusCode. RejectionDirectDebitPostProcessingInitiationRunStatus is a coded representation of an execution status of a rejected direct debits post processing initiation run, and may be based on datatype BOIDT: RejectionDirectDebitPostProcessingInitiationRunStatus. RejectionDirectDebitPostProcessingInitiationRunStatus can include RejectionDirectDebitPostProcessingInitiationRunStatus/LifeCycleStatusCode, which may be based on datatype GDT: MassDataRunObjectLifeCycleStatusCode.

A Select All query can be used to return all instances of the node. A Query by Background Job and Application Log can exist. The query elements are defined by the data type MassDataRunObjectExecutionQueryByBackgroundJobAndApplicationLogQueryElements. These elements include: MassDataRunObjectID, MassDataRunObjectUUID, MassDataRunObjectExecutionID, MassDataRunObjectExecutionUUID, BackgroundJobID, BackgroundJobScheduleID, BackgroundJobScheduleReleaseStatusCode, ApplicationLogID, ApplicationLogUUID, ApplicationLogMaximumLogItemSeverityCode, ApplicationLogLogItemCounterValue, ApplicationLogErrorLogItemCounterValue, ApplicationLogWarningLogItemCounterValue, ApplicationLogClosureStatusCode, ApplicationLogLifeCycleStatusCode, and ApplicationLogSystemAdministrativeData. ApplicationLogSystemAdministrativeData can include ApplicationLogSystemAdministrativeData/CreationDateTime, ApplicationLogSystemAdministrativeData/CreationIdentityUUID, ApplicationLogSystemAdministrativeData/CreationIdentityID, ApplicationLogSystemAdministrativeData/CreationIdentityBusinessPartnerInternalID, ApplicationLogSystemAdministrativeData/CreationIdentityBusinessPartnerPersonFamilyName, ApplicationLogSystemAdministrativeData/CreationIdentityBusinessPartnerPersonGivenName, ApplicationLogSystemAdministrativeData/CreationIdentityEmployeeID, ApplicationLogSystemAdministrativeData/LastChangeDateTime, ApplicationLogSystemAdministrativeData/LastChangeIdentityUUID, ApplicationLogSystemAdministrativeData/LastChangeIdentityID, ApplicationLogSystemAdministrativeData/LastChangeIdentityBusinessPartnerInternalID, ApplicationLogSystemAdministrativeData/LastChangeIdentityBusinessPartnerPerson Family Name, ApplicationLogSystemAdministrativeData/LastChangeIdentityBusinessPartnerPersonGiven Name, and ApplicationLogSystemAdministrativeData/LastChangeIdentityEmployeeID.

MassDataRunObjectID is an identifier for an instance of a rejected direct debits post-processing initiation run, and may be based on datatype GDT: MassDataRunObjectID. MassDataRunObjectUUID is a universally unique identifier for an instance of a rejected direct debits post-processing initiation run, and may be based on datatype GDT: UUID. MassDataRunObjectExecutionID is an identifier for an execution of a rejected direct debits post-processing initiation run, and may be based on datatype GDT: MassDataRunObjectExecutionID. MassDataRunObjectExecutionUUID is a universally unique identifier for an execution of a rejected direct debits post-processing initiation run, and may be based on datatype GDT: UUID. BackgroundJobID is an identifier for a job which may be scheduled in the background which executes a rejected direct debits post-processing initiation run, and may be based on datatype GDT: BackgroundJobID. BackgroundJobScheduleID is an identifier for a job schedule for a job scheduled to run in the background which executes a rejected direct debits post-processing initiation run, and may be based on datatype GDT: BackgroundJobScheduleID. BackgroundJobScheduleReleaseStatusCode is a coded representation of a job scheduled in the background which executes a rejected direct debits post-processing initiation run, and may be based on datatype GDT: BackgroundJobScheduleStatusCode. ApplicationLogID is an identifier for an application log of an execution of a rejected direct debits post-processing initiation run, and may be based on datatype GDT: ApplicationLogID. ApplicationLogUUID is a universally unique identifier for an application log of an execution of a rejected direct debits post-processing initiation run, and may be based on datatype GDT: UUID. ApplicationLogMaximumLogItemSeverityCode is a coded representation of a maximum severity level of an item in an application log, and may be based on datatype GDT: LogItemSeverityCode. ApplicationLogLogItemCounterValue is a value that represents a number of items in an application log, and may be based on datatype GDT: CounterValue. ApplicationLogErrorLogItemCounterValue is a value that represents a number of errors logged in an application log, and may be based on datatype GDT: CounterValue. ApplicationLogWarningLogItemCounterValue is a value that represents a number of items in an application log, and may be based on datatype GDT: CounterValue. ApplicationLogClosureStatusCode is a coded representation of a closure status of an application log, and may be based on datatype GDT: ClosureStatusCode. ApplicationLogLifeCycleStatusCode is a coded representation of a life cycle status of an application log which describes a current state of the application log, and may be based on datatype GDT: ApplicationLogLifeCycleStatusCode. A life cycle status is a status that denotes a prominent stage of a life cycle. A life cycle is a series of prominent stages through which an object can pass during its lifetime. A possible sequence of stages can be determined by constraints under which an object can pass from one stage to another. ApplicationLogSystemAdministrativeData may be based on datatype QueryIDT: QueryElementSystemAdministrativeData. ApplicationLogSystemAdministrativeData/CreationDateTime is a point in time date and time stamp at which an application log is created, and may be based on datatype GDT: GLOBAL_DateTime. ApplicationLogSystemAdministrativeData/CreationIdentityUUID is a universally unique identifier for a person or entity that created an instance of a run, and may be based on datatype GDT: UUID. ApplicationLogSystemAdministrativeData/CreationIdentityID is an identifier for a person or entity that created an instance of a run, and may be based on datatype GDT: IdentityID. ApplicationLogSystemAdministrativeData/CreationIdentityBusinessPartnerInternalID is an identifier for a business partner who is attributed to a creator of an instance of a run, and may be based on datatype GDT: BusinessPartnerInternalID. ApplicationLogSystemAdministrativeData/CreationIdentityBusinessPartnerPersonFamilyName is a name of a business partner who is attributed to a creator of an instance of a run, and may be based on datatype GDT: LANGUAGEINDEPENDENT_MEDIUM_Name. ApplicationLogSystemAdministrativeData/CreationIdentityBusinessPartnerPersonGivenNam e is a given name of a business partner who is attributed to a creator of an instance of a run, and may be based on datatype GDT: LANGUAGEINDEPENDENT_MEDIUM_Name. ApplicationLogSystemAdministrativeData/CreationIdentityEmployeeID is an identifier for an employee who is attributed to a creator of an instance of a run, and may be based on datatype GDT: EmployeeID. ApplicationLogSystemAdministrativeData/LastChangeDateTime is a point in time date and time stamp at which a last change was made to an instance of a run, and may be based on datatype GDT: GLOBAL_DateTime. ApplicationLogSystemAdministrativeData/LastChangeIdentityUUID is a universally unique identifier for a party who last changed an attribute of an instance of a run, and may be based on datatype GDT: UUID. ApplicationLogSystemAdministrativeData/LastChangeIdentityID is an identifier for a party who last changed an attribute of an instance of a run, and may be based on datatype GDT: IdentityID. ApplicationLogSystemAdministrativeData/LastChangeIdentityBusinessPartnerInternalID is an identifier for a business partner who is attributed to a person who last changed an instance of a run, and may be based on datatype GDT: BusinessPartnerInternalID. ApplicationLogSystemAdministrativeData/LastChangeIdentityBusinessPartnerPersonFamily Name is a last name of a business partner who is attributed to a person who last changed an instance of a run, and may be based on datatype GDT: LANGUAGEINDEPENDENT_MEDIUM_Name. ApplicationLogSystemAdministrativeData/LastChangeIdentityBusinessPartnerPersonGiven Name is a name of a business partner who is attributed to a person who last changed an instance of a run, and may be based on datatype GDT: LANGUAGEINDEPENDENT_MEDIUM_Name. ApplicationLogSystemAdministrativeData/LastChangeIdentityEmployeeID is an identifier for an employee who is attributed to a person who last changed an instance of a run, and may be based on datatype GDT: EmployeeID.

Selection by Company represents a company which initiates one or more payment transactions that are used for the selection of one or more unrealized direct debit payments to be processed in a run. The elements located directly at the node Selection by Company are defined by the inline structure GLO_REJDD_PPIR_SEL_BY_COMP_EL. These elements include: InclusionExclusionCode, IntervalBoundaryTypeCode, LowerBoundaryCompanyID, LowerBoundaryCompanyUUID, UpperBoundaryCompanyID, and UpperBoundaryCompanyUUID. InclusionExclusionCode is a coded representation of a result of a following interval selection that specifies whether the result is included or excluded from a total result, and may be based on datatype GDT: InclusionExclusionCode. IntervalBoundaryTypeCode is a coded representation of an interval boundary type for a selection, and may be based on datatype GDT: MDRO_IntervalBoundaryTypeCode. LowerBoundaryCompanyID is an identifier for a company that is used as a lower interval boundary for a selection, and may be based on datatype GDT: OrganisationalCentreID. LowerBoundaryCompanyUUID may be optional, is a universally unique identifier for a company that is used as a lower interval boundary for a selection, and may be based on datatype GDT: UUID. UpperBoundaryCompanyID may be optional, is an identifier for a company that is used as an upper interval boundary for a selection, and may be based on datatype GDT: OrganisationalCentreID. UpperBoundaryCompanyUUID may be optional, is a universally unique identifier for a Company that is used as an upper interval boundary for a selection, and may be based on datatype GDT: UUID.

The following inbound association relationships may exist: LowerBoundaryCompany, from the business object Company/node Company, with a cardinality of C:CN; and UpperBoundaryCompany, from the business object Company/node Company, with a cardinality of C:CN. The following specialization associations for navigation may exist to the node Root: Parent, with a target cardinality of 1; and Root, with a target cardinality of 1. In some implementations, if one boundary is used in a selection condition, that boundary is specified in the LowerBoundaryCompanyID. A SelectAll query can be used to select all instances of the node.

Selection by House Bank Account represents a house bank account used for a selection of unrealized direct debit payments to be processed in a run. The elements located directly at the node Selection by House Bank Account are defined by the inline structure GLO_REJDD_PP_SEL_BY_HBA_EL. These elements include: InclusionExclusionCode, IntervalBoundaryTypeCode, LowerBoundaryHouseBankAccountKey, and UpperBoundaryHouseBankAccountKey. InclusionExclusionCode is a coded representation of a result of a following interval selection that specifies whether the result is included or excluded from a total result, and may be based on datatype GDT: InclusionExclusionCode. IntervalBoundaryTypeCode is a coded representation of an interval boundary type for a selection, and may be based on datatype GDT: MDRO_IntervalBoundaryTypeCode. LowerBoundaryHouseBankAccountKey is a grouping of elements that uniquely identifies a house bank account that is used as a lower interval boundary for a selection, and may be based on datatype KDT: HouseBankAccountKey. LowerBoundaryHouseBankAccountKey may include LowerBoundaryHouseBankAccountKey/CompanyUUID, which is a universally unique identifier for a company to which a house bank account belongs which may be based on datatype GDT: UUID. LowerBoundaryHouseBankAccountKey may include LowerBoundaryHouseBankAccountKey/InternalID, which is an identifier for a house bank account which may be based on datatype GDT: BankAccountInternalID. UpperBoundaryHouseBankAccountKey is a grouping of elements that uniquely identifies a house bank account that is used as an upper interval boundary for a selection, and may be based on datatype KDT: HouseBankAccountKey. UpperBoundaryHouseBankAccountKey can include UpperBoundaryHouseBankAccountKey/CompanyUUID, which is a universally unique identifier for a company to which a house bank account belongs which may be based on datatype GDT: UUID. UpperBoundaryHouseBankAccountKey can include UpperBoundaryHouseBankAccountKey/InternalID, which is an identifier for a house bank account which may be based on datatype GDT: BankAccountInternalID.

The following inbound association relationships may exist: UpperBoundaryHouseBankAccount, from the business object House Bank Account/node House Bank Account, with a cardinality of C:CN; and LowerBoundaryHouseBankAccount, from the business object House Bank Account/node House Bank Account, with a cardinality of C:CN. The following specialization associations for navigation may exist to the node Root: Parent, with a target cardinality of 1; and Root, with a target cardinality of 1. A SelectAll query can be used to select all instances of the node.

Selection by Payment Execution Date represents a date of payment execution by a house bank used for a selection of unrealized direct debit payments to be processed in a run. The elements located directly at the node Selection by Payment Execution Date are defined by the inline structure GLO_REJDD_PP_EXEC_DATE_EL. These elements include: InclusionExclusionCode, IntervalBoundaryTypeCode, LowerBoundaryPaymentExecutionDate, UpperBoundaryPaymentExecutionDate, and BankProcessingDateOffsetlntegerValue. InclusionExclusionCode is a coded representation of a result of a following interval selection that specifies whether the result is included or excluded from a total result, and may be based on datatype GDT: InclusionExclusionCode. IntervalBoundaryTypeCode is a coded representation of an interval boundary type for a selection, and may be based on datatype GDT: MDRO_IntervalBoundaryTypeCode. LowerBoundaryPaymentExecutionDate is a point in time at which a payment may be executed by a house bank and which is used as a lower interval boundary for a selection, and may be based on datatype GDT: Date. UpperBoundaryPaymentExecutionDate may be optional, is a point in time at which a payment may be executed by a house bank and which is used as an upper interval boundary for a selection, and may be based on datatype GDT: Date. BankProcessingDateOffsetlntegerValue is a value that represents a number of days after a payment execution date that can be considered when selecting unrealized receivables, and may be based on datatype GDT: IntegerValue. The following specialization associations for navigation may exist to the node Root: Parent, with a target cardinality of 1; and Root, with a target cardinality of 1. In some implementations, if one boundary is used in a selection condition, the boundary is specified in the LowerBoundaryPaymentExecutionDate. A Select All query can be used to return all instances of a node.

Selection by Currency represents a transaction currency used for a selection of direct debits to be processed. The elements located directly at the node Selection by Currency are defined by the inline structure GLO_REJDD_PP_SEL_BY_CURR_EL. These elements include: InclusionExclusionCode, IntervalBoundaryTypeCode, LowerBoundaryCurrencyCode, and UpperBoundaryCurrencyCode. InclusionExclusionCode is a coded representation of a result of a following interval selection that specifies whether the result is included or excluded from a total result, and may be based on datatype GDT: InclusionExclusionCode. IntervalBoundaryTypeCode is a coded representation of an interval boundary type for a selection, and may be based on datatype GDT: MDRO_IntervalBoundaryTypeCode. LowerBoundaryCurrencyCode is a coded representation of a transaction currency that is used as a lower interval boundary for a selection, and may be based on datatype GDT: CurrencyCode. UpperBoundaryCurrencyCode may be optional, is a coded representation of a transaction currency that is used as an upper interval boundary for a selection, and may be based on datatype GDT: CurrencyCode.

The following inbound association relationships may exist: Lower Boundary Currency, from the business object Currency/node Currency, with a cardinality of C:CN; and Upper Boundary Currency, from the business object Currency/node Currency, with a cardinality of C:CN. The following specialization associations for navigation may exist to the node Root: Parent, with a target cardinality of 1; and Root, with a target cardinality of 1. In some implementations, if one boundary is used in a selection condition, the boundary is specified in the LowerBoundaryCurrencyCode. A SelectAll query can be used to select all instances of the node.

Selection by Business Partner represents a business partner of a bank that is involved in a payment transaction used for a selection of unrealized direct debit payments to be processed in a run. The elements located directly at the node Selection by Business Partner are defined by the inline structure GLO_REJDD_PP_SEL_BY_BP_EL. These elements include: InclusionExclusionCode, IntervalBoundaryTypeCode, LowerBoundaryBusinessPartnerInternalID, LowerBoundaryBusinessPartnerUUID, UpperBoundaryBusinessPartnerInternalID, and UpperBoundaryBusinessPartnerUUID. InclusionExclusionCode is a coded representation of a result of a following interval selection that specifies whether the result is included or excluded from a total result, and may be based on datatype GDT: InclusionExclusionCode. IntervalBoundaryTypeCode is a coded representation of an interval boundary type for a selection, and may be based on datatype GDT: MDRO_IntervalBoundaryTypeCode. LowerBoundaryBusinessPartnerInternalID is an identifier for an involved business partner that is used as a lower interval boundary for a selection, and may be based on datatype GDT: BusinessPartnerInternalID. LowerBoundaryBusinessPartnerUUID is a universally unique identifier for an involved business partner that is used as a lower interval boundary for a selection, and may be based on datatype GDT: UUID. UpperBoundaryBusinessPartnerInternalID may be optional, is an identifier for an involved business partner that is used as an upper interval boundary for a selection, and may be based on datatype GDT: BusinessPartnerInternalID. UpperBoundaryBusinessPartnerUUID is a universally unique identifier for an involved business partner that is used as an upper interval boundary for a selection, and may be based on datatype GDT: UUID. The following inbound association relationships may exist: LowerBoundaryBusinessPartner, from the business object Business Partner/node Business Partner, with a cardinality of C:CN; and UpperBoundaryBusinessPartner, from the business object Business Partner/node Business Partner, with a cardinality of C:CN. The following specialization associations for navigation may exist to the node Root: Parent, with a target cardinality of 1; and Root, with a target cardinality of 1. A SelectAll query can be used to select all instances of the node.

Description Text Node represents a description of a selection criteria of a rejected direct debits post processing initiation run. The elements located directly at the node Description are defined by the inline structure GLO_REJDD_POSTPROC_IR_DESCR_EL. These elements include Description, which is a description of a rejected direct debits post processing initiation run which may be based on datatype GDT: LONG_Description. The following specialization associations for navigation may exist to the node Root: Parent, with a target cardinality of 1; and Root, with a target cardinality of 1. In some implementations, a specific language has one description.

Selection by House Bank represents a house bank account used for a selection of unrealized direct debit payments to be processed in a run. The elements located directly at the node Selection by House Bank are defined by the inline structure GLO_REJDD_PP_SEL_BY_HB_EL. These elements include: InclusionExclusionCode, IntervalBoundaryTypeCode, LowerBoundaryHouseBankInternalID, LowerBoundaryHouseBankUUID, UpperBoundaryHouseBankInternalID, and UpperBoundaryHouseBankUUID. InclusionExclusionCode may be optional, is a coded representation of a result of a following interval selection that specifies whether the result is included or excluded from a total result, and may be based on datatype GDT: InclusionExclusionCode. IntervalBoundaryTypeCode may be optional, is a coded representation of an interval boundary type for a selection, and may be based on datatype GDT: MDRO_IntervalBoundaryTypeCode. LowerBoundaryHouseBankInternalID is an identifier for a house bank that is used as a lower interval boundary for a selection, and may be based on datatype GDT: BusinessPartnerInternalID. LowerBoundaryHouseBankUUID may be optional, is a universally unique identifier for a house bank that is used as a lower interval boundary for a selection, and may be based on datatype GDT: UUID. UpperBoundaryHouseBankInternalID may be optional, is an identifier for a house bank that is used as an upper interval boundary for a selection, and may be based on datatype GDT: BusinessPartnerInternalID. UpperBoundaryHouseBankUUID may be optional, is a universally unique identifier for a house bank that is used as an upper interval boundary for a selection, and may be based on datatype GDT: UUID. The following inbound association relationships may exist: LowerBoundaryHouseBank, from the business object House Bank/node House Bank, with a cardinality of C:CN; and UpperBoundaryHouseBank, from the business object House Bank/node House Bank, with a cardinality of C:CN. The following specialization associations for navigation may exist to the node Root: Parent, with a target cardinality of 1; and Root, with a target cardinality of 1. A SelectAll query can be used to select all instances of the node.

A number of implementations have been described. Nevertheless, it will be understood that various modifications may be made without departing from the spirit and scope of the disclosure. Accordingly, other implementations are within the scope of the following claims.

1. A non-transitory, computer readable medium including program code for providing a message-based interface for exchanging information about business transaction authorization requests, the medium comprising:
program code for receiving via a message-based interface derived from a common business object model, where the common business object model includes business objects having relationships that enable derivation of message-based interfaces and message packages, the message-based interface exposing at least one service as defined in a service registry and from a heterogeneous application executing in an environment of computer systems providing message-based services, a first message for requesting to trigger a process to obtain legal authorization of a business transaction by legal authorities, the first message including a first message package hierarchically organized in memory, the first message package including:
at a first hierarchical level in the first message package, a business transaction authorization internal request message entity; and
at the first hierarchical level in the first message package, a business transaction authorization internal request package including, at a second hierarchical level in the first message package, a business transaction authorization internal request entity, a party package, and an item package, wherein the business transaction authorization internal request entity includes, at a third hierarchical level in the first message package, a base business transaction document identifier and a creation date, wherein the party package includes, at the third hierarchical level in the first message package, a buyer party entity and a seller party entity, and wherein the item package includes, at the third hierarchical level in the first message package, at least one business transaction authorization internal request item entity, and wherein each business transaction authorization internal request item entity includes, at a fourth hierarchical level in the first message package, an identifier and a type code;
program code for processing the first message based on the hierarchical organization of the first message package, where processing the first message includes unpacking the first message package based on the first message package's structure and the first message package's derivation from the common business object model, wherein the particular structure of the first message package is used at least in part to identify the purpose of the first message; and
program code for sending a second message to the heterogeneous application responsive to the first message, where the second message includes a second message package derived from the common business object model to provide consistent semantics with the first message package.

2. The computer readable medium of claim 1, wherein the business transaction authorization internal request entity further includes a cash discount terms entity from a cash discount terms package.

3. The computer readable medium of claim 1, wherein the business transaction authorization internal request entity further includes at least one of the following: a base business transaction document universally unique identifier (UUID), a base business transaction document type code, a processing type code, a creation date time, a cancellation document indicator, a total gross amount, a total net amount, a total tax amount, a total discount amount, and a seller registration country code.

4. A distributed system operating in a landscape of computer systems providing message-based services defined in a service registry, the system comprising:
at least one processor operable to execute computer readable instructions embodied on non-transitory media;
a graphical user interface executable by the at least one processor and comprising computer readable instructions, embedded on non-transitory media, for requesting to trigger a process to obtain legal authorization of a business transaction by legal authorities, the instructions using a request;
a first memory storing a user interface controller executable by the at least one processor for processing the request and involving a message including a first message package derived from a common business object model, where the common business object model includes business objects having relationships that enable derivation of message-based service interfaces and message packages, the first message package hierarchically organized, the hierarchical organization of the first message package including hierarchically organized as:
at a first hierarchical level in the first message package, a business transaction authorization internal request message entity; and
at the first hierarchical level in the first message package, a business transaction authorization internal request package including, at a second hierarchical level in the first message package, a business transaction authorization internal request entity, a party package, and an item package, wherein the business transaction authorization internal request entity includes, at a third hierarchical level in the first message package, a base business transaction document identifier and a creation date, wherein the party package includes, at the third hierarchical level in the first message package, a buyer party entity and a seller party entity, and wherein the item package includes, at the third hierarchical level in the first message package, at least one business transaction authorization internal request item entity, and wherein each business transaction authorization internal request item entity includes, at a fourth hierarchical level in the first message package, an identifier and a type code; and
a second memory, remote from the graphical user interface, storing a plurality of service interfaces executable by the at least one processor and derived from the common business object model to provide consistent semantics with messages derived from the common business object model, wherein one of the service interfaces is operable to process the message via the service interface based on the hierarchical organization of the message package, where processing the message includes unpacking the first message package based on the message package's structure and the message package's derivation from the common business object model, wherein the particular structure of the message package is used at least in part to identify the purpose of the message.

5. The distributed system of claim 4, wherein the first memory is remote from the graphical user interface.

6. The distributed system of claim 4, wherein the first memory is remote from the second memory.

7. A computer readable medium including program code for providing a message-based interface for exchanging information about rejected direct debits post-processing initiation runs, the medium comprising:
program code for receiving via a message-based interface exposing at least one service as defined in a service registry and from a heterogeneous application executing in an environment of computer systems providing message-based services, a first message for querying information about rejected direct debits post-processing initiation runs, including unrealized direct debit receivables, the first message including a message package hierarchically organized as:
a rejected direct debits post-processing initiation run query by elements message entity; and
a rejected direct debits post-processing initiation run package including a rejected direct debits post-processing initiation run entity, wherein the rejected direct debits post-processing initiation run entity includes a company universally unique identifier (UUID), an identifier (ID), system administrative data, and a status; and
program code for sending a second message to the heterogeneous application responsive to the first message.

8. The computer readable medium of claim 7, wherein the rejected direct debits post-processing initiation run entity further includes at least one of the following: at least one execution entity, at least one selection by company entity, at least one selection by house bank account entity, at least one selection by payment execution date entity, at least one selection by currency entity, at least one selection by business partner entity, at least one description entity, and at least one selection by house bank entity.

9. The computer readable medium of claim 7, wherein the rejected direct debits post-processing initiation run entity further includes at least one of the following: a UUID and a mass data run object type code.

10. A distributed system operating in a landscape of computer systems providing message-based services defined in a service registry, the system comprising:
a graphical user interface comprising computer readable instructions, embedded on tangible media, for querying information about rejected direct debits post-processing initiation runs, including unrealized direct debit receivables, the instructions using a request;
a first memory storing a user interface controller for processing the request and involving a message including a message package hierarchically organized as:
a rejected direct debits post-processing initiation run query by elements message entity; and
a rejected direct debits post-processing initiation run package including a rejected direct debits post-processing initiation run entity, wherein the rejected direct debits post-processing initiation run entity includes a company universally unique identifier (UUID), an identifier (ID), system administrative data, and a status; and
a second memory, remote from the graphical user interface, storing a plurality of service interfaces, wherein one of the service interfaces is operable to process the message via the service interface.

11. The distributed system of claim 10, wherein the first memory is remote from the graphical user interface.

12. The distributed system of claim 10, wherein the first memory is remote from the second memory.
